(19) United States
(12) Patent Application Publication
(10) Pub. No.: US 2026/0360249 A1
(43) Pub. Date: Nov. 12, 2026

(54) Secured door ecosystem and a method therefor

(71) Applicant: Aegys, LLC, Lemont, IL (US)

(72) Inventors: Joseph R. Barwick, Lemont, IL (US); Stephen F. Blackler, Maryville, TN (US); Martin F. Carmody, Glen Cove, NY (US); Dominic Peters, Ottawa (CA); Robert Shudra, Ottawa (CA); Aliasgar Morbi, Oceanside, CA (US)

(21) Appl. No.: 19/668,221

(22) Filed: May 5, 2026

Related U.S. Application Data
(63) Continuation-in-part of application No. 19/306,793, filed on Aug. 21, 2025.
(60) Provisional application No. 63/800,761, filed on May 6, 2025.
(60) Provisional application No. 63/800,761, filed on May 6, 2025.

(51) Int. Cl. G08C 17/02; G08B 21/02; G09F 7/18

(52) U.S. Cl. CPC G08C 17/02; G08B 21/02; G09F 7/18; G09F 2007/1856; G09F 2007/1873

(57) ABSTRACT

Caution barriers are useful in preventing entry into certain rooms, such as rooms including an MRI scanner. An apparatus can be configured for use as a barrier. The apparatus comprises a belt including first and second ends, with a belt retractor attached to the first end and a belt clip attached to the second end. The apparatus further includes a receiver, a first sensor component attached to the belt clip, and a second sensor component attached to the receiver. One of the first or second sensor components is configured to make a determination indicating whether the first and second sensor components are in proximity to each other and to output a signal indicating the determination.

### CROSS REFERENCE TO RELATED APPLICATION

This application is a continuation-in-part of U.S. patent application Ser. No. 19/306,793, titled Secured Door Ecosystem and a Method Therefor, and filed Aug. 21, 2025. U.S. patent application Ser. No. 19/306,793 is incorporated herein by reference in its entirety.

This application and U.S. patent application Ser. No. 19/306,793 claim the benefit of U.S. Provisional Patent Application No. 63/800,761, titled Secured Door Ecosystem and/or Method Therefore, and filed May 6, 2025. U.S. Provisional Patent Application No. 63/800,761 is incorporated herein by reference in its entirety.

### BACKGROUND

Many facilities include restricted rooms due to various risks associated with content within the restricted rooms. These facilities may include medical facilities, hospitals, laboratories, among others.

As an example, a Magnetic Resonance Imaging (MRI) room is a restricted room including an MRI scanner. In such room, an extremely strong magnetic field is always present and cannot be turned off. As an example, some MRI scanners are 1.5 Tesla (T) scanners, which equates to 15,000 gauss or 30,000 times the strength of Earth's magnetic field. As another example, some MRI scanners are 3.0 Tesla (T) scanners, which equates to 30,000 gauss or 60,000 times the strength of Earth's magnetic field. For comparison's sake, an electromagnetic scrap magnet used for lifting cars is approximately 1.5 T to 2.0 T. The dangerously high magnetic field within an MRI room is a permanent condition that is always present and cannot be seen, thus it is an invisible danger.

Facility layouts, continuous patient workflow and procedural/operational requirements prevent rigorous access control measures to MRI rooms. Current practices are limited to passive signage on the door and manual operation of a hinged door or the inconsistent and unmonitored use of caution barriers. When the MRI room door is open and the technologist is pre-occupied, anyone or anything can enter and adversely interact with the superconductive high magnetic field. Numerous incidents resulting in injury and even death have occurred due to individuals entering the MRI room either wearing large ferromagnetic items or pushing in large ferromagnetic equipment without any awareness as to the dangerous conditions within the MRI room beyond the open MRI door.

Additionally, only limited governmental requirements for standard MRI safety measures exist worldwide. Some industry associations, such as the American College of Radiology (ACR) in the United States and the Medicines and Healthcare products Regulatory Agency (MHRA) in the United Kingdom offer minimal recommendations. Such recommendations can include using appropriate signage communicating the risks of high magnetic field interaction, keeping the MRI room door closed at all times (except for when passing through the doorway), or using a caution barrier when the door of the MRI room is open. Even so, there is no consistent or uniform practice of access control or risk mitigation within the MRI scanner industry. Further, active monitoring of an MRI room entrance for compliance with industry association recommendations does not currently occur. Furthermore, there exists no measurements or Key Performance Indicators (KPIs) to reflect proper safety protocol implementation, risk mitigation effectiveness, or baseline measurements against other MRI facilities throughout the world.

Finally, no solution currently exists that confirms compliance with access control management, reinforces safety behavior or provides effective notification of the commensurate risk necessary to enact proper risk mitigation measures.

### OVERVIEW

There is a need to constantly and remotely monitor the status of a restricted room door (e.g., an MRI room door) both from a safety and efficiency standpoint. An open, unsecured restricted room door and/or doorway presents a condition of known risk of harm. Monitoring the status of the restricted room door or doorway (open or closed) remotely and in real time is an essential risk mitigation practice. Additionally, the capability to establish timed alerts for predefined conditions and sending those alerts via email and text message to a distribution list of stakeholders ensures the risk is monitored and can be directly acted upon. Key performance indicators quantifying the daily, weekly and monthly door open time totals and averages can be used to establish, measure and maintain site specific safety protocols. Real-time restricted room door status, programmable alerts and key performance data analysis can be managed through a web-based dashboard. Algorithmic analysis and data benchmarking against the comprehensive pool of users allows for optimization of workflow efficiencies and standardization of effective safety protocols. The sensors utilized at the restricted room doorway to transmit the door status/position can include a unique safety harness for attachment to the door and doorframe to prevent the sensing magnet from dislodging and creating a potential safety, projectile effect type, hazard by entering the restricted room and being exposed to the high magnetic field. Additionally, different door position sensors including but not limited to RF ID tags and readers, mechanically actuated sensors, retroreflective and laser sensing technology can be used for accumulating door status information within the example systems.

This description relates to methods and systems for remotely monitoring the status of a door to a restricted room (e.g., an MRI scanner room) and the status of active use and/or non-use of a caution barrier at the restricted room door. The methods and systems provide the ability to send remote notifications and/or on-site warnings (at or in proximity to the restricted room) to an interactive visual display if a hazardous condition (e.g., door open and non-use of caution barrier) exceeds a pre-set time condition or an algorithmically determined acceptable time across all user data sets (e.g., data sets obtained by a server monitoring multiple restricted room doors and caution barriers remotely). This interactive visual display can present dynamic visual animations or warning messages indicating the associated danger within the MRI Room, a dynamic and updateable real time list of prohibited items not allowed in the MRI Room, as well as a visual countdown indicator referencing unsecured MRI door duration prior to which alerts are dynamically transmitted, a unique scoring system for assessing daily safety protocol adherence at the MRI door and a visual calculation of the total daily MRI door unsecured time. Additionally, the methods and systems provide for quantifying data for measurable continuous process improvement or operational staff modification. The use of passive signage to communicate the risk of extremely hazardous conditions is no longer effective in a society inundated with digital media, cellular phones and computer screens. Dynamic warning signage includes motion, sound and updateable content which make them a superior form of communication for life-threating and extremely hazardous conditions.

In a first aspect, a method is provided. The method includes receiving first and second sensor data at a first computing system. The first sensor data is from a first sensor positioned in proximity to a door of a restricted room. The first sensor is configured to output the first sensor data based on a status of the door being closed or open. The second sensor data is from a second sensor positioned in proximity to a caution barrier positioned in proximity to the door. The second sensor is configured to output the second sensor data based on a status of the caution barrier extending across at least a portion of a doorway corresponding to the door. The method further includes determining, at the first computing system based on the data corresponding to the first and second sensor data, a first condition existing at the door. The first condition comprises the door being open and non-use of the caution barrier for at least a threshold amount of time while the door is open. The method also includes outputting, from the first computing system, a notification regarding the first condition to a second computing system.

In a second aspect, a computing system is provided. The computing system includes a processor, and a computer-readable memory comprising program instructions executable by the processor to perform functions. The functions include receiving first and second sensor data at the computing system. The first sensor data is from a first sensor positioned in proximity to a door of a restricted room. The first sensor is configured to output the first sensor data based on a status of the door being closed or open. The second sensor data is from a second sensor positioned in proximity to a caution barrier positioned in proximity to the door. The second sensor is configured to output the second sensor data based on a status of the caution barrier extending across at least a portion of a doorway corresponding to the door. The functions include determining a first condition existing at the door based on the first and second sensor data. The first condition comprises the door being open and non-use of the caution barrier for at least a threshold amount of time while the door is open. The functions also include outputting a first notification regarding the first condition to a second computing system.

In a third aspect, a non-transitory computer-readable memory is provided. The non-transitory computer-readable memory has stored therein instructions executable by one or more processors to cause a computing system to perform functions. The functions include receiving first and second sensor data. The first sensor data is from a first sensor positioned in proximity to a door of a restricted room. The first sensor is configured to output the first sensor data based on a status of the door being closed or open. The second sensor data is from a second sensor positioned in proximity to a caution barrier positioned in proximity to the door. The second sensor is configured to output the second sensor data based on a status of the caution barrier extending across at least a portion of a doorway corresponding to the door. The functions further include determining a first condition existing at the door based on the first and second sensor data. The first condition comprises the door being open and non-use of the caution barrier for at least a threshold amount of time while the door is open. The functions also include outputting a first notification regarding the first condition to a second computing system.

In a fourth aspect, an apparatus configured for use as a barrier is provided. The apparatus includes a belt including a first end and a second end opposite the first end; a belt retractor attached to the first end of the belt; a belt clip attached to the second end of the belt; a receiver; a first sensor component attached to the belt clip; and a second sensor component attached to the receiver. One of the first or second sensor components is configured to make a determination indicating whether the first and second sensor components are in proximity to each other and to output a signal indicating the determination.

In a fifth aspect, a method is provided. The method includes receiving first and second signals at a computing system. The first signal is from a first sensor positioned in proximity to a door of a restricted room. The first sensor is configured to output the first signal based on a status of the door being closed or open. The second signal is from a second sensor positioned in proximity to a caution barrier positioned in proximity to the door. The second sensor is configured to output the second signal based on a status of the caution barrier extending across at least a portion of a doorway corresponding to the door. The method also includes determining, at the computing system based on data carried by the first and second signals, a first condition existing at the door. The first condition comprises the door being open and non-use of the caution barrier for at least a first threshold amount of time while the door is open. Additionally, the method includes outputting a first notification regarding the first condition on a display at the computing system.

In a sixth aspect, a computing system is provided. The computing system includes a processor and a computer-readable memory comprising program instructions executable by the processor to perform functions. The functions include receiving first and second signals at the computing system. The first signal is from a first sensor positioned in proximity to a door of a restricted room. The first sensor is configured to output the first signal based on a status of the door being closed or open. The second signal is from a second sensor positioned in proximity to a caution barrier positioned in proximity to the door. The second sensor is configured to output the second signal based on a status of the caution barrier extending across at least a portion of a doorway corresponding to the door. The functions also include determining, at the computing system based on data carried by the first and second signals, a first condition existing at the door. The first condition comprises the door being open and non-use of the caution barrier for at least a first threshold amount of time while the door is open. Additionally, the functions include outputting a first notification regarding the first condition on a display at the computing system.

In a seventh aspect, a non-transitory computer-readable memory is provided. The non-transitory computer-readable memory has stored therein instructions executable by one or more processors to cause a computing system to perform functions. The functions include receiving first and second signals at the computing system. The first signal is from a first sensor positioned in proximity to a door of a restricted room. The first sensor is configured to output the first signal based on a status of the door being closed or open. The second signal is from a second sensor positioned in proximity to a caution barrier positioned in proximity to the door. The second sensor is configured to output the second signal based on a status of the caution barrier extending across at least a portion of a doorway corresponding to the door. The functions also include determining, at the computing system based on data carried by the first and second signals, a first condition existing at the door. The first condition comprises the door being open and non-use of the caution barrier for at least a first threshold amount of time while the door is open. Additionally, the functions include outputting a first notification regarding the first condition on a display at the computing system.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1, FIG. 2, and FIG. 3 are block diagrams of an operating environment, in accordance with one or more of the example embodiments.

FIG. 4 is a plan view of a restricted room, in accordance with one or more of the example embodiments.

FIG. 5 is an elevation view of a restricted room, in accordance with one or more of the example embodiments.

FIG. 6 and FIG. 7 show aspects in and around a restricted room, in accordance with one or more of the example embodiments.

FIG. 8 shows a door contact sensor, in accordance with one or more of the example embodiments.

FIG. 9 shows a caution barrier and sensor arrangement, in accordance with one or more of the example embodiments.

FIG. 10 shows sensor arrangements, in accordance with one or more of the example embodiments.

FIG. 11 is a block diagram of a server, in accordance with one or more of the example embodiments.

FIG. 12 is a block diagram of a gateway, in accordance with one or more of the example embodiments.

FIG. 13 is a block diagram of a computing system, in accordance with one or more of the example embodiments.

FIG. 14, FIG. 15, FIG. 16, FIG. 17, FIG. 18, FIG. 19, FIG. 20, and FIG. 21 depict aspects of a graphical user interface (GUI) in accordance with one or more example embodiments.

FIG. 22 shows notifications in accordance with one or more example embodiments.

FIG. 23 and FIG. 24 are flowcharts showing functions that can be performed in accordance with one or more example embodiments.

FIG. 25, FIG. 26, FIG. 27, FIG. 28, FIG. 29, FIG. 30, FIG. 31, FIG. 32, FIG. 33, and FIG. 34 depict aspects of a barrier, in accordance with one or more of the example embodiments.

FIG. 35 shows supplemental restraints for restraining a sensor component, in accordance with one or more of the example embodiments.

FIG. 36 and FIG. 37 show example communication flows, in accordance with one or more of the example embodiments.

FIG. 38 shows a GUI in accordance with one or more of the example embodiments.

FIG. 39 and FIG. 40 show a caution barrier and sensor arrangement, in accordance with one or more of the example embodiments.

FIG. 41, FIG. 42, and FIG. 43 depict aspects of a barrier, in accordance with one or more of the example embodiments.

All the figures are schematic, not necessarily to scale, and generally only show parts which are necessary to elucidate example embodiments, wherein other parts may be omitted or merely suggested.

### DETAILED DESCRIPTION

### I. Introduction

This description describes several example embodiments, at least some which pertain to a method and system for monitoring the status of doors and doorways of restricted rooms. Monitoring a door can include monitoring a doorway. Monitoring a doorway can include monitoring a door for being opened or closed, and/or whether a person or object enters or crosses the doorway. The system can include sensors to determine a status of the door being open or closed. The system can also include a caution barrier and sensors to determine whether the caution barrier is deployed, especially when the door is open. The system can determine when the door is open during unexpected time periods and when the door is open for more than a threshold amount of time without the caution barrier being deployed. The system can output alerts to notify individuals of statistics regarding use of the door and caution barrier for a door at a particular restricted room or doors at a particular set of restricted rooms. The alert can visually, audibly and/or haptically prompt individuals in proximity to a door of a restricted room to close the door and/or to deploy the caution barrier to reduce the risk associated with the door being open and/or with the caution barrier not being deployed while the door is open.

The restricted room can be classified as a Zone 3 or Zone 4 room (or area). Those zones along with Zone 1 and Zone 2 have been defined with respect to MRI systems. Zone 1 is a general public area outside of an MRI environment. Zone 2 is an area between Zone 1 and Zone 3 or Zone 4. Zone 3 is a control room for MRI equipment. Zone 4 is a magnet room where MRI scanning occurs.

A method to secure the restricted room doorway without closing the restricted room door is achieved through the use of caution barriers, which are a recommendation of the American College of Radiology. As an example, a caution barrier can include a manual retractable chain, a plastic belt, or an automated gate, such as an automated gate described below. A smart belt including sensors is configured to communicate a status of the belt, either open (e.g., not deployed) or closed (e.g., deployed), to a gateway, a local computer display, and/or a server. The automated gate includes sensors that communicate the status of the gate as either open or closed to a gateway, a local computer display, and/or a server. Alerts, such as voice reminders, email or text messages sent to a distribution list, and/or a site-specific lighted beacon, or interactive visual display, can be conditioned upon several local site conditions or durations of use or non-use of a caution barrier. The use of multiple, remotely monitored sensors either at the restricted room doorway or incorporated within a caution barrier (such as a smart belt or an automated gate) located at the doorway, or patient changing area allows for algorithmic statistical analysis of workflow efficiencies, timestamping of activities and adherence to safety protocols. Customization of a written message on the smart belt or an automated gate can include site specific nomenclature or a warning message for a specific use, such as “DANGER-Strong Magnetic Field-Do Not Enter.”

In this description, the articles “a,” “an,” and “the” are used to introduce elements and/or functions of the example embodiments. The intent of using those articles is that there is one or more of the introduced elements and/or functions.

### II. Example Systems and Environments

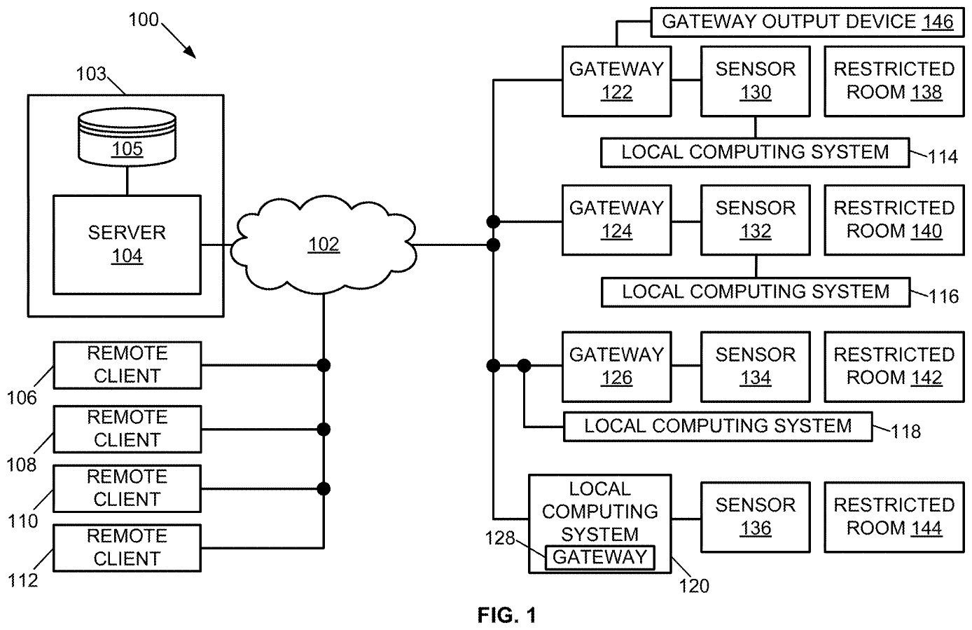

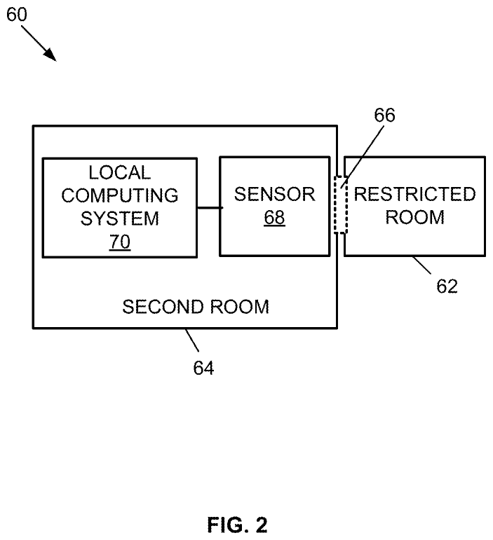

FIG. 1 is a block diagram of an operating environment 100 in accordance with one or more example embodiments. The operating environment 100 (another other operating environments discussed in this description) can be referred to as an “interconnected digital ecosystem” (or more simply, a “digital ecosystem,” an “ecosystem,” or a “system”). The operating environment 100 includes different types of system components. The quantity of each type of system component shown in FIG. 1 is merely an example, as the operating environment 100 can be scaled to accommodate different quantities of interconnected system components.

The operating environment 100 includes a communication network 102 (i.e., one or more communication networks). Other system components of the operating environment 100 can include network interfaces that provide connectivity of the system component to the communication network 102. As an example, a processor or transceiver of the example embodiments can include one or more network interfaces. In other words, any network interface described in this description can be embodied within a processor or a transceiver.

The communication network 102 can include a local communication network for local device-to-device communications. As an example, the local communication network can include one or more local communication network, such as a network for communicating according to a BLUETOOTH® communication standard (i.e., a standard developed by the Bluetooth Special Interest Group (SIG), such as a Bluetooth 2.0 to 5.x communication standard), a WI-FI® communication standard (i.e., an Institute of Electrical and Electronics Engineers (IEEE) 802.11 standard), or a Near Field Communication (NFC) communication standard (e.g., an International Standards Organization (ISO) 18092 communication standard). As another example, the local communication network can include a local area network (LAN).

The communication network 102 can include an Internet-based communication network (e.g., the Internet). As an example, the Internet-based communication network can occur using a WI-FI® access point, a cellular network, a wide area network (WAN), or a network that performs communication using a Transmission Control Protocol/Internet Protocol (TCP/IP).

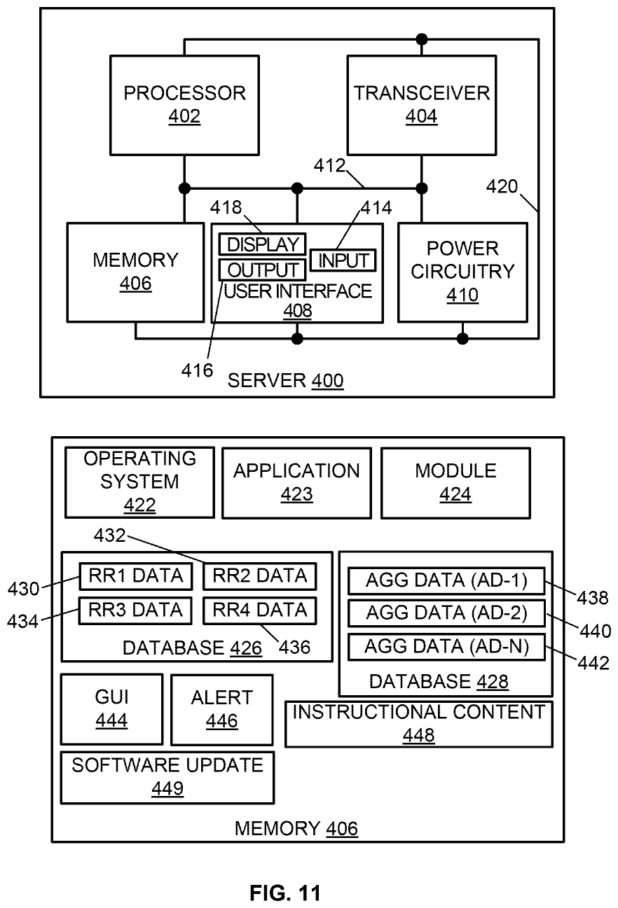

The communication network 102 can include and/or interface to a cloud infrastructure 103 including a server 104 and a database 105. The server 104 and the database 105 can be distributed or integrated into a single computing system. As an example, the database 105 can include any content contained with the memory 406 (shown in FIG. 11) or any other database described herein. Other examples of the data contained in the database 105 are also possible.

The operating environment 100 includes client devices (or more simply “clients”) configured to communicate with the server 104 over the communication network 102. The clients can include a remote client, such as the remote client 106, 108, 110, 112. The remoteness of the remote clients is with respect to the restricted room and sensor providing sensor data to the server for viewing via the remote client.

The system includes a local computing system 114, 116, 118, 120. Two or more of the local computing systems can be arranged in different configurations. Two or more of the local computing systems can be arranged in similar configurations. Example configurations of the local computing systems are described below.

A local computing system, such as the local computing system 114, 116 can be configured to communicate with a sensor, such as the sensor 130, 132, respectively. In one case, the local computing system 114 is configured to receive communications from the sensor 130, but is not configured to transmit communications to the sensor 130 (or any other sensor). In a second case, the local computing system 114 and the sensor 130 can transmit communications to and receive communications from the other. The communications between a local computing system and a sensor can occur over-the-air (i.e., wirelessly) or via wired links.

A local computing system, such as the local computing system 118, 120 can be arranged as a local client served by server 104. A local computing system can be referred to as a “local computer” and/or a “display device.” If operable as a client, a local computing system can be referred to as a “local client.”

A communication transmitted by a sensor (i.e., a sensor communication (e.g., transmitted by the sensor 130)) can be received by a local computing system (e.g., the local computing system 114) and a gateway (e.g., the gateway 122) at the same time or essentially at the same time. The local computing system can process the sensor communication in real time without network delay introduced by the gateway forwarding the sensor communication (or data contained therein) to the server 104, and by the server 104 communicating with the gateway and the gateway subsequently communicating with the local computing system. In other words, direct communication (i.e., a direct sensor communication) between a sensor and a local computing system eliminates a time lag for data transmission through a network). This direct communication allows for more timely door status updates and countdown displays at the local computing system. The direct communication also allows for more timely updates of any other display on the local computing system based on the direct communication, such as a gamified display output at the local computing system. The communication between a sensor and a computing system can comprise an over-the-air (OTA) communication (i.e., a wireless communication). In alternative embodiments, the communication between a sensor and a local computing system can comprise a wired communication (i.e., a hardwired communication)

The operating environment 100 can include and/or portions of the operating environment 100 can be located in proximity to a restricted room, such as the restricted room 138, 140, 142, 144. A restricted room can include equipment that can be dangerous to people in proximity to the restricted room or within the restricted room. As an example, the equipment can include a magnetic resonance imaging (MRI) scanner. As another example, the equipment can include an X-ray machine or an X-ray imaging system. Yet another example, the equipment can include a computed tomography (CT) scanner. As yet another example, the equipment can include nuclear medicine equipment, such as a positron emission tomography (PET) scanner, a single photon emission computed tomography (SPECT) scanner, or a gamma camera. Other examples of the equipment within a restricted room are also possible.

A room with MRI equipment can be referred to as an MRI room. A room with X-ray equipment can be referred to as an X-ray room. A room with CT equipment can be referred to as a CT room. A room with nuclear medicine equipment can be referred to as a nuclear medicine room.

In addition to equipment, a restricted room can include a door to allow ingress and egress of the restricted room. As an example, a door for a restricted room can include a single door or multiple doors. As another example, a door for a restricted room can include a swinging door or a sliding door. Each door can be part of a door frame installed within a wall that forms part of a perimeter of the restricted room and a second room or space (e.g., an adjacent room). The door frame for a swinging door can include a door jamb comprising a hinge jamb to which door hinges are mounted, a strike jamb having a strike plate to which a latch or bolt can engage, and a head jamb extending between upper/top portions of the hinge jamb and the strike jamb.

The operating environment 100 can include a gateway, such as the gateway 122, 124, 126, 128. A gateway can include multiple network interfaces. For example, a gateway of the operating environment 100 can communicate with the server 104 over the communication network 102 using a first network interface and with another device using a second or third network interface. As represented in FIG. 1, the other device can comprise a sensor, such as the sensor 130, 132, 134, 136 (i.e., a sensor component). Another device that communicates with a gateway using a second network interface (or alternatively, a third network interface) can include a local computing system, such as the local computing system 120.

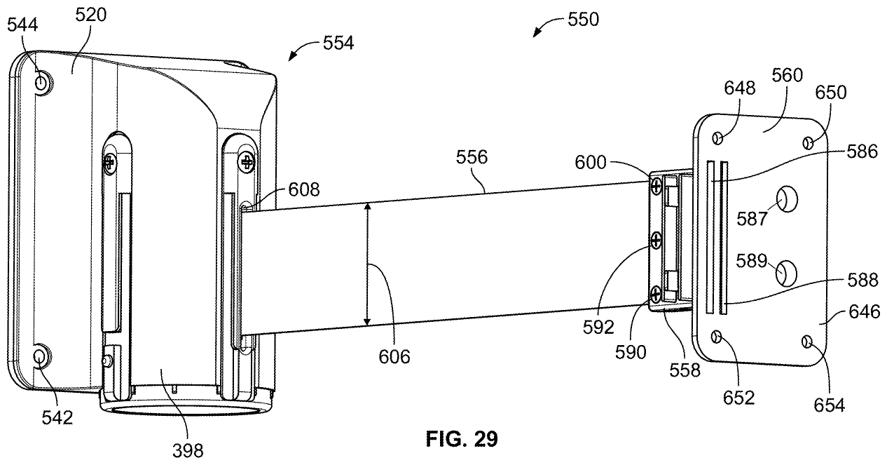

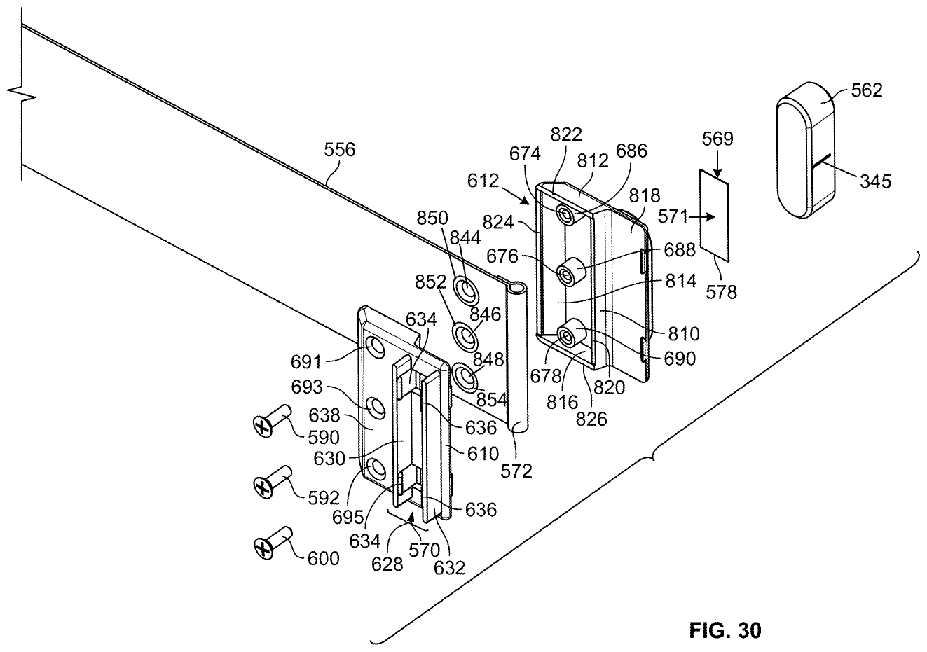

The sensor 130, 132, 134, 136 can include one or more sensors. The sensor 130, 132, 134, 136 can include one or more of the following types of sensors: a door sensor, a doorway passage sensor, a window sensor, a barrier state sensor, a temperature sensor, a ferrous metal detector sensor, a gas sensor, or another type of sensor. For example, the sensor 130 can include a door sensor and a barrier state sensor. As another example, the sensor 130 can include a door sensor, a barrier state sensor, and a doorway passage sensor. A barrier state sensor can be integrated within a smart belt, a tech gate, an apparatus 550 shown in FIG. 25 or with some other barrier (e.g., a caution barrier).

The door sensor can determine when the door is open. An open door can include a door being partially open (e.g., the door has not reached a door stop) or fully open (e.g., the door has reached a door stop). The doorway passage sensor can be used to determine whether someone or some object (e.g., a wheelchair, a hospital bed, or a cart) has passed through a doorway. As an example, the doorway passage sensor can comprise an ultrasonic sensor, an infrared sensor, or a photoelectric sensor.

The gas sensor, for example, can include an oxygen sensor, a helium sensor, a carbon monoxide sensor, or some other type of gas sensor. The gas sensor can be configured to sense the release of helium or a change in oxygen levels near the scan room to indicate a quench of an MRI scanner. A sensor of the example embodiments can be connected to a local manual device used to mechanically quench an MRI scanner (for example, via button presses).

The sensor 130, 132, 134, 136 can include an asset tag sensor. The asset tag sensor can include a radio frequency identifier (RFID) asset tag sensor to detect an asset tag attached to a piece of equipment. The asset tag sensor can communicate using a BLUETOOTH® protocol or some other wireless protocol. The sensor 130, 132, 134, 136 can include a presence sensor to detect a person or object moving in proximity to the sensor for triggering the outputting of an alert regarding presence of the person or object in proximity to the sensor, which can be positioned close to a restricted room. A local computing system, gateway or server can be configured to ignore an output of the presence sensor if a monitored doorway is secured (e.g., by closure of the door or deployment of a caution barrier across the doorway.

A sensor of the example embodiments, such as the sensor 130, 132, 134, 136, can be located outside of the restricted room 138, 140, 142, 144, respectively, within the restricted room 138, 140, 142, 144, respectively, or within a doorway leading to or from the restricted room 138, 140, 142, 144, respectively. Each sensor can transmit a unique sensor identifier that identifies the type of sensor and/or a particular one of the type of sensor. The unique sensor identifier allows a receiver of the signal transmitted by the sensor to know how to interpret other data contained within the signal.

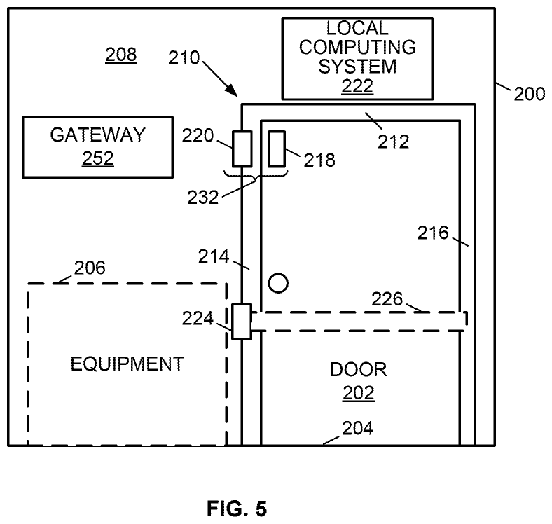

The sensor 130, 132, 134, 136 can include one or more sensor components. The examples discussed herein regarding the sensor component 218, 220 (shown in FIG. 5) and the sensor component 562, 564 (shown in FIG. 25) are applicable to the sensor 130, 132, 134, 136. As another example, a sensor can include a switch dedicated for use as a panic button, such as a panic button in or near a restricted room.

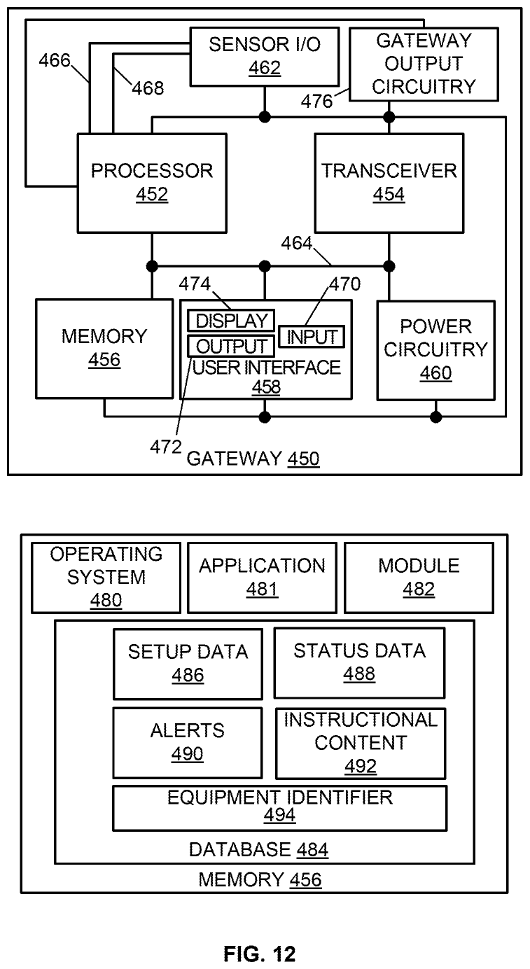

A gateway, such as the gateway 122, 124, 126, 128, and/or the local computing system can connect to and/or communicate with one or more sensors. A connection between a gateway or the local computing system and a sensor can comprise a wired connection, a wireless connection, or combination of a wired and wireless connection. Accordingly, a sensor and/or gateway or local computing system can communicate with the other using a wired and/or wireless communication. Further details of a gateway are described with respect to a gateway 450 shown in FIG. 12.

In accordance with at least some embodiments, a local computing system interfaces to the communication network 102 directly. For example, the local computing system 118, 120 (arranged as a local client) can interface directly to the communication network 102 directly. In accordance with at least some other embodiments, a local computing system interfaces to the communication network 102 indirectly, by way of a gateway (i.e., a gateway that connects to a sensor of the operating environment 100). For example, the local computing system 120 can interface to the communication network 102 indirectly, by way of the gateway 128. FIG. 1 represents that a sensor, such as the sensor 134, can be operatively connected directly to the gateway 126, and that a sensor, such as the sensor 136, can be operatively connected directly to the gateway 128 and the local computing system 120. Those operative connections can be unidirectional (i.e., from the sensor to the gateway and/or the local computing system) or bi-directional.

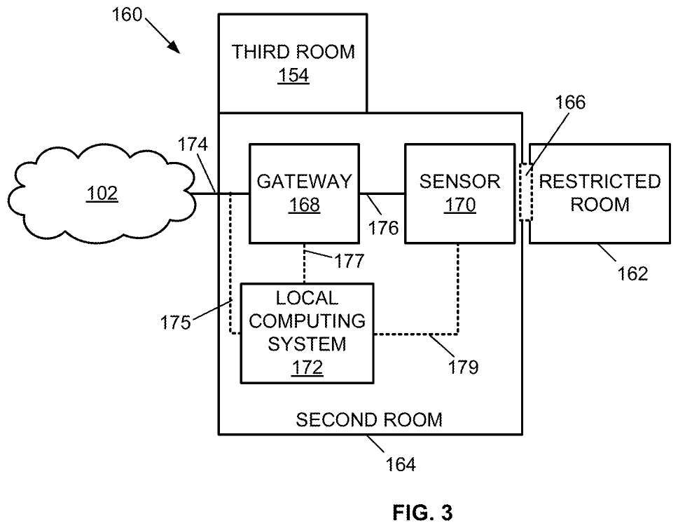

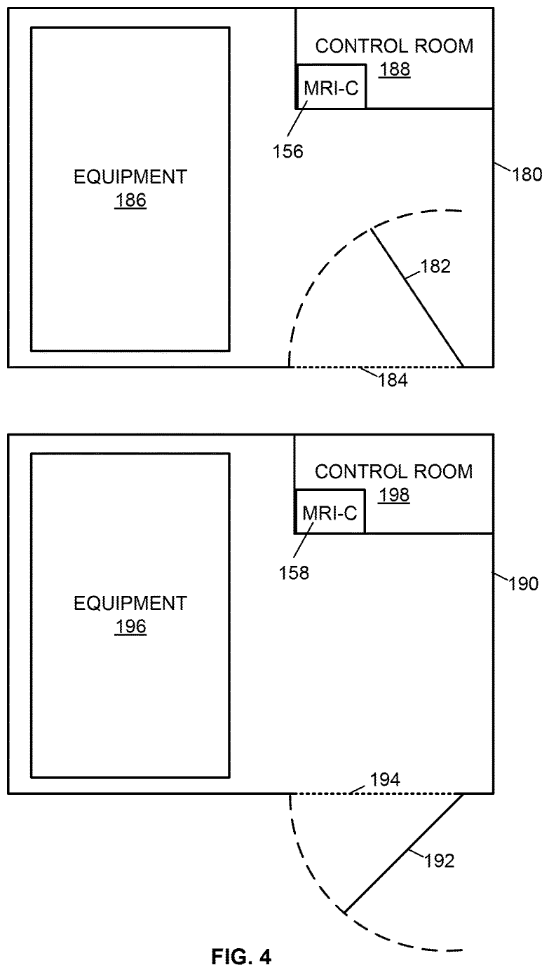

FIG. 1 represents that a local computing system and a gateway can be separated from one another or integrated with one another. For example, the local computing system 114, 116, 118 are separated from the gateway 122, 124, 126, respectively. As another example, the local computing system 120 and the gateway 128 are integrated together. In accordance with that example, the local computing system 120 can include the gateway 128, or the gateway 128 can include the local computing system 120. A local computing system, such as any local computing system described herein, can be located within a Zone 1, Zone 2, Zone 3, or Zone 4 area. A local computing system can be located on an MRI console, such as the MRI console 156, 158 shown in FIG. 4. A local computing system can be in a patient waiting area, such as a third room 154 shown in FIG. 3.

The operating environment 100 can include a gateway output device 146. FIG. 1 shows the gateway output device 146 connected to the gateway 122, but the gateway output device 146 can be connected to any gateway described in this description. For simplicity, FIG. 1 shows only one gateway output device, but more than one gateway output device can be connected to a single gateway, and more than one or more gateway can be connected to a gateway output device. In at least some embodiments, a gateway output device and gateway operatively connect to one another using one or more wired conductors and/or via a wireless communication link. As an example, the gateway output device 146 can include a display device.

As another example, the gateway output device 146 can include an Andon light kit for outputting alerts with respect to a door of a restricted room and/or a caution barrier at the door. The Andon light kit can include an illuminated, multicolor beacon, locally adjacent to a restricted room doorway, to provide a visual reminder to secure the restricted room doorway when the door is open for longer than a pre-defined duration. These lights can be dynamically programmed to communicate different messages. Additionally, a voice communication system can be incorporated with the beacon to accompany the visual reminders with programmable voice reminders. The conditions to activate lights and programmable voice messages are managed through a web-based dashboard and allows for site specific warning considerations based upon specific activity or site layout.

Next, FIG. 2 is a block diagram of an operating environment 60 including a restricted room 62, a second room 64, a doorway 66, a sensor 68 (i.e., one or more sensors or sensor components), and a local computing system 70. The restricted room 62 can be arranged like any restricted room described in this description or in some other arrangement. The second room 64 can be classified as a Zone 2 area or as some other classified zone. Alternatively, the second room 64 is not classified. The doorway 66 can provide access to the restricted room 62 from the second room 64 and vice versa. The sensor 68 can be in the restricted room 62, the second room 64, the doorway 66 or partly in two or more of those rooms or doorway. The sensor 68 can sense aspects such as a door status, a barrier status, a temperature, a gas level, or some other aspect described herein. Similar to the sensor 130, 132, 134, 136, the sensor 68 can include one or more of the following types of sensors: a door sensor, a doorway passage sensor, a window sensor, a barrier state sensor, a temperature sensor, a ferrous metal detector sensor, a gas sensor, or another type of sensor. The examples discussed herein regarding the sensor component 218, 220 (shown in FIG. 5) and the sensor component 562, 564 (shown in FIG. 25) are applicable to the sensor 68.

In accordance with at least some embodiments, the sensor 68 is configured to transmit communications to the local computing system 70, but is not configured to receive communications from the local computing system 70. Accordingly, the local computing system 70 can be configured to not transmit communications directed to the sensor 68. The sensor 68 in these embodiments can transmit data representing what is sensed by the sensor 68 to the local computing system 70. The local computing system 70 can receive the data and determine aspects (e.g., conditions, ratios, states, alerts, or notifications) to output on a display of the local computing system 70 based on the received data.

In accordance with at least some other embodiments, the sensor 68 and the local computing system are configured to transmit communications to one another. As an example, the local computing system 70 can be configured to transmit a communication to the sensor 68, such as a communication with a configuration parameter to change how the sensor 68 operates. As another example, the sensor 68 in these other embodiments can transmit data representing what is sensed by the sensor 68 to the local computing system 70.

In either of the example embodiments mentioned above, the sensor 68 can be configured to transmit a communication to the local computing system 70, such as a communication including data indicating what is sensed by the sensor 68 or a change in status of what is sensed by the sensor 68. As another example, the sensor 68 can transmit a communication to the local computing system 70 indicating the sensor 68 is operational (e.g., a heartbeat message or a keep-alive signal).

In accordance with at least some embodiments, the sensor 68 and the local computing system 70 are connected by a wired or cable connection. In accordance with at least some other embodiments, the sensor 68 and the local computing system 70 are connected wirelessly (i.e., over-the-air).

In accordance with at least some embodiments, the local computing system 70 can communicate to a remote device, such as a wireless access point, cellular base station, or a wired network but the local computing system 70 executes application(s) that do not require performing such communication offboard the local computing system 70. Alternatively, the local computing system 70 cannot communicate to any remote device.

Next, FIG. 3 is a block diagram of an operating environment 160 including components contained in or based on components of the operating environment 100. As shown in FIG. 3, the operating environment 160 includes the communication network 102, a restricted room 162, a second room 164, a third room 154, a doorway 166, a gateway 168, a sensor 170 (i.e., a sensor component), and a local computing system 172. The restricted room 138, 140, 142, 144 (shown in FIG. 1) can be arranged like the restricted room 162. The second room 164 can be classified as a Zone 2 area. The third room 154 can be classified as a Zone 1 area.

The sensor 170 can be configured or positioned in an arrangement like the sensor 130, 132, 134, 136. The examples discussed herein regarding the sensor component 218, 220 (shown in FIG. 5) and the sensor component 562, 564 (shown in FIG. 25) are applicable to the sensor 170. The sensor 170 can be in the restricted room 162, the second room 164, the doorway 166 or partly in two or more of those rooms or doorway. The sensor 170 can sense aspects such as a door status, a barrier status, a temperature, a gas level or some other aspect described herein. Similar to the sensor 130, 132, 134, 136, the sensor 170 can include one or more of the following types of sensors: a door sensor, a doorway passage sensor, a window sensor, a barrier state sensor, a temperature sensor, a ferrous metal detector sensor, a gas sensor, or another type of sensor.

The operating environment 160 can include communication links to connect devices therein together to allow for those devices to perform communications. Any of the communication links can be part of the communication network 102. The communication links can be wireless or wired communication links. As shown in FIG. 3, a communication link 174 is between the communication network 102 and the gateway 168, a communication link 175 is between the communication network 102 and the local computing system 172, a communication link 176 is between the gateway 168 and the sensor 170, a communication link 177 is between the gateway 168 and the local computing system 172, and a communication link 179 is between the sensor 170 and the local computing system 172.

The communication link 175, 177, 179 are represented as dashed lines in FIG. 3 to indicate that the communication link can be optional. For example, the local computing system 172 may communicate only with the sensor 170 such that only the communication link 179 is used and the communication link 175, 177 are not used. As another example, the local computing system 172 may communicate only with the gateway 168 such that only the communication link 177 is used and the communication link 175, 179 are not used. As yet another example, the local computing system 172 may communicate only with (i.e., via) the communication network 102 such that only the communication link 175 is used and the communication link 177, 179 are not used.

Next, FIG. 4 shows plan views of a restricted room 180, 190 and a control room 188, 198. The restricted room 162 shown in FIG. 3 can be arranged like the restricted room 180, 190. The restricted room 180 or the restricted room 190 can be used within the operating environment 160 in place of the restricted room 162. The restricted room 138, 140, 142, 144 can be arranged like the restricted room 180 or the restricted room 190. The control room 188 can be contained within, adjacent to, or in proximity to the restricted room 180. The control room 188 includes an MRI console 156 (i.e., MRI-C). The control room 198 can be contained within, adjacent to, or in proximity to the restricted room 190. The control room 198 includes an MRI console 158 (i.e., MRI-C). A local computing system, as described herein, can be located at the MRI console 156, 158.

The restricted room 180 includes a door 182, a doorway 184, and equipment 186. The door 182 comprises a swing-in door. The restricted room 190 includes a door 192, a doorway 194, and equipment 196. The door 192 comprises a swing-out door. The equipment 186, 196 can comprise any equipment described in this description. Any aspect shown within the restricted room 180, 190 can be contained within any other restricted room described in this description.

Next, FIG. 5 shows an elevation view of a restricted room 200 and aspects surrounding and/or in proximity to the restricted room 200. The restricted room 138, 140, 142, 144 shown in FIG. 1, the restricted room 162 shown in FIG. 3, and/or the restricted room 180, 190 shown in FIG. 4 can be arranged like the restricted room 200. The restricted room 200 can be used within the operating environment 100 in place of a restricted room in that operating environment. The restricted room 200 can be used within the operating environment 160 in place of the restricted room 162. The restricted room 200 can be used within the operating environment 60 in place of the restricted room 62, and in some cases, without the gateway 252.

The restricted room 200 includes a door 202, a threshold 204, equipment 206, a wall 208, and a door jamb 210. The door jamb 210 includes a head jamb 212, a strike jamb 214, and a hinge jamb 216. As an example, the door 202 can be a swing-in door, a swing-out door, or a sliding door (e.g., a pocket door).

FIG. 5 shows aspects attached to the door 202, the wall 208, and/or the door jamb 210. For example, a door contact sensor 232 comprising a sensor component 218 is attached to the door 202, and a sensor component 220 is attached to the wall 208 and/or the door jamb 210. In accordance with at least some embodiments, the sensor component 218, 220 can comprise the following: a reed switch and magnet, a Hall Effect switch and magnet, a radio frequency identifier (RFID) tag and RFID reader, or an optical sensor emitter and optical sensor receiver. Other examples of the sensor component 218, 220 are possible. For at least some embodiments of the door contact sensor 232 comprising multiple mountable components, either of the listed example components can be mounted to the door 202 with the other component being mounted to the door jamb 210 or wall 208. A sensor component can be referred to as a “sensor assembly” or more simply, a “sensor.”

As another example, the door contact sensor 232 can comprise only a single mountable component, such as a proximity sensor, a contact sensor, or a mechanical sensor (such as a mechanical sensor with a lever or button). In any event, the door contact sensor 232 can be configured to minimize any adverse impact on operation of the door 202.

FIG. 5 shows other aspects attached to the door 202, the wall 208, and/or the door jamb 210. For example, a local computing system 222 can be attached to the wall 208. Yet another example, a caution barrier 224 can be attached to wall 208 and/or the door jamb 210. FIG. 5 shows a path 226 of at least a portion of the caution barrier 224 extending across at least a portion of the doorway between the portions of the door jamb 210. The path 226 of the caution barrier 224 can form a shape other than a rectangular shape. As still yet another example, a handle 234 is attached to the door 202. Although the caution barrier 224 is shown to be disposed (i.e., positioned) at the wall 208 and/or the strike jamb 214, other examples are possible. For instance, the caution barrier 224 or a portion thereof can be at the hinge jamb 216 and/or a portion of the wall 208 in proximity to the hinge jamb 216. In some embodiments, portions of the caution barrier can be at both the strike jamb 214 and the hinge jamb 216 and/or portions of the wall 208 in proximity to those jambs.

Although the local computing system 222 is represented as being attached to the wall 208, the local computing system 222 doesn't have to be attached to the wall 208. For example, the local computing system 222 can comprise a portable computing system that can be located on a desk, a counter, a cart or at some other location in proximity to the restricted room 200. Similarly, although the gateway 252 is represented as being attached to the wall 208, the gateway 252 doesn't have to be attached to the wall 208. For example, the gateway 252 can be located on a desk, a counter, a cart, a ceiling or at some other location in proximity to the restricted room 200.

In accordance with at least some embodiments, a caution barrier includes and/or is arranged as a room access control system. For simplicity, the room access control system described above can be referred to as an “automated gate,” a “TechGate,” or a “Tech Gate.”

As an example, the automated gate can include a base assembly attachable to a wall or door jamb adjacent to a door opening to a room. The room access control system can also include an arm having a first end pivotally mounted with respect to the base assembly at a stationary pivot point relative to the base for rotation about a pivot axis. The arm has a second end and is positionable in a first undeployed position where the arm is generally vertical and the second end of the arm points downwardly. The arm is pivotable from the first undeployed position, upwardly to a second, generally horizontal deployed position, where the arm extends at least partially across the door opening. A fan assembly is attached to the arm and includes a plurality of fan blades. Each of the fan blades has a first end that is pivotally mounted to the arm. Each of the fan blades has a second end that is attached to, and movable with respect to, an adjacent fan blade. When the arm is in the first undeployed position, each of the plurality of fan blades is in a generally vertical position beneath the arm. When the arm is in the second, generally horizontal deployed position, the plurality of fan blades extend beneath the arm in a fanned out pattern with the second end of a first fan blade of the plurality of fan blades attached to the arm, and a last fan blade of the plurality of fan blades positioned in a generally vertical position. Other aspects regarding the example room access control system are described in U.S. Pat. No. 12,104,430 entitled “Room Access Control System with Barrier Arm having Downwardly Extending Fan Assembly.” U.S. Pat. No. 12,104,430 is incorporated herein by reference.

In addition to the aspects described in that patent, the automated gate can include a magnet (i.e., a reference magnet) and a switch. As an example, the magnet can be positioned on the arm of the automated gate and the switch can be mounted at a location of the door jamb 210 such that the switch is in a first position when the arm is deployed across the doorway, and in a second position when the arm is not deployed. The first position can be “open” and the second position can be “closed,” or vice versa. In accordance with at least some embodiments, the magnet is contained within a housing at or proximate one end of the arm 244. The housing prevents dislodgment of the magnet from within the housing, the arm 244, or the automated gate 230 (i.e., the automated gate). The magnet and switch can be contained within a sensor.

An internal area extending between the threshold 204 and the head jamb 212 and between the strike jamb 214 and the hinge jamb 216 can be referred to as a “doorway.”

A sensor can be positioned in proximity to a door of a restricted room. The sensor in proximity to the door can include a door contact sensor configured to output a first signal when the door is closed and a second signal when the door is opened and remains open. The sensor can have a first sensor component mounted on the door and a second sensor component mounted on the door jamb or wall adjacent to the door jamb. The sensor in proximity to the door can include a single sensor component, such as a switch with switch contacts in a first position state (e.g., open switch contacts) when the door is closed, and in a second position stated (e.g., closed switch contacts) when the door is open. The sensor in proximity to the door can include a first sensor component and second sensor component in which one of the first and second sensor components can detect the other when the door is closed, but cannot detect the other when the door is open.

A sensor can be positioned in proximity to a caution barrier positioned in proximity to the door. The sensor in proximity to the caution barrier can include first and second sensor components in which one of the first and second sensor components can detect the other when the caution barrier is deployed, but cannot detect the other when the caution barrier is not deployed. The sensor in proximity to the caution barrier can include first and second sensor components in which the first and second sensor components contact one another when the caution barrier is deployed, but do not contact one another when the caution barrier is not deployed.

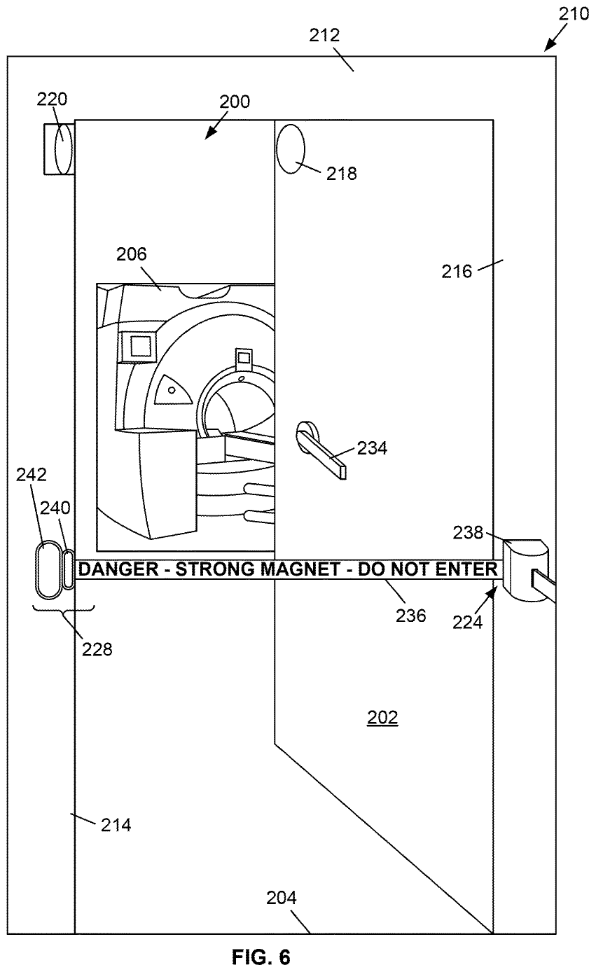

Next, FIG. 6 shows further aspects in and around the restricted room 200 shown in FIG. 5, in accordance with one or more example embodiments. For example, FIG. 6 shows the door 202 as a swing-in door in an open position, and the equipment 206 can include an MRI scanner. FIG. 6 also shows the threshold 204, the door jamb 210, the head jamb 212, the strike jamb 214, the hinge jamb 216, the door contact sensor 232, and the sensor component 218, 220.

Additionally, FIG. 6 shows a particular example of the caution barrier 224. In that regard, the caution barrier 224 can comprise a retractable belt 236 extendible across the doorway from the strike jamb 214 to the hinge jamb 216 or vice versa, a belt retractor 238, and a belt deployment sensor 228 (or more simply, a “sensor”). Similar to the door contact sensor 232, the belt deployment sensor 228 can comprise a sensor component 240, 242. The examples corresponding to the sensor component 218, 220 and the sensor component 562, 564 are applicable to the sensor component 240, 242. In accordance with at least some embodiments, a magnet (i.e., a reference magnet) is contained within a housing at or proximate one end of the retractable belt 236. The housing prevents dislodgment of the magnet from within the housing or the retractable belt 236. In accordance with those or other embodiments, the magnet can be sewn into a fabric that forms the retractable belt 236 to prevent dislodgment of the magnet from within the housing or the retractable belt 236. A belt with one or more sensor components can be referred to as a “smart belt.” The caution barrier 224 can be arranged like the barrier 550 shown in FIG. 25.

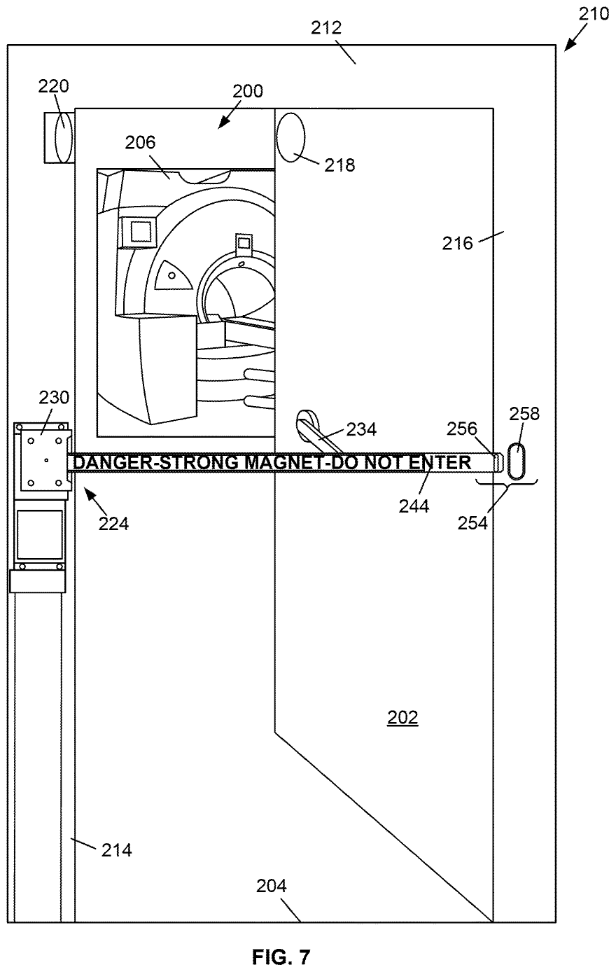

Next, FIG. 7 shows further aspects in and around the restricted room 200 shown in FIG. 5, in accordance with one or more example embodiments. For example, FIG. 7 shows the door 202 as a swing-in door in an open position, and the equipment 206 can comprise an MRI scanner. FIG. 7 also shows the threshold 204, the door jamb 210, the head jamb 212, the strike jamb 214, the hinge jamb 216, and the sensor component 218, 220.

Additionally, FIG. 7 shows a particular example of the caution barrier 224. In that regard, the caution barrier 224 can comprise an automated gate 230 (e.g., a room access control system or TechGate). As shown, the automated gate 230 is extendible across the doorway from the strike jamb 214 to the hinge jamb 216 or vice versa. The automated gate 230 can be arranged as the room access control system described above and can include a sensor component and/or logic to detect when an arm 244 is deployed. The automated gate 230 can include a gate deployment sensor 254 (or more simply “deployment sensor” or “sensor”). Similar to the door contact sensor 232, the gate deployment sensor 254 can comprise a sensor component 256, 258. The examples corresponding to the sensor component 218, 220 are applicable to the sensor component 256, 258.

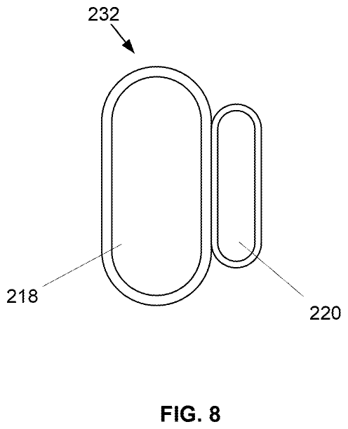

Next, FIG. 8 shows an example implementation of the door contact sensor 232 shown in FIG. 5, FIG. 6, and FIG. 7. As described with respect to one or more of those figures, the door contact sensor 232 includes a sensor component 218, 220. As described, a sensor component, such as the sensor component 218, 220 can comprise a magnet. For embodiments in which the sensor component is used in proximity to a restricted room including an MRI scanner, the sensor component can be tethered to its mounting location, located within a cage that does not permit the sensor component to pass through the cage, or can include a housing comprising sufficient non-ferrous mass such that gravity overcomes any attractive forces of the MRI scanner and the magnet of the sensor component should the sensor component become dislodged from its mounting location.

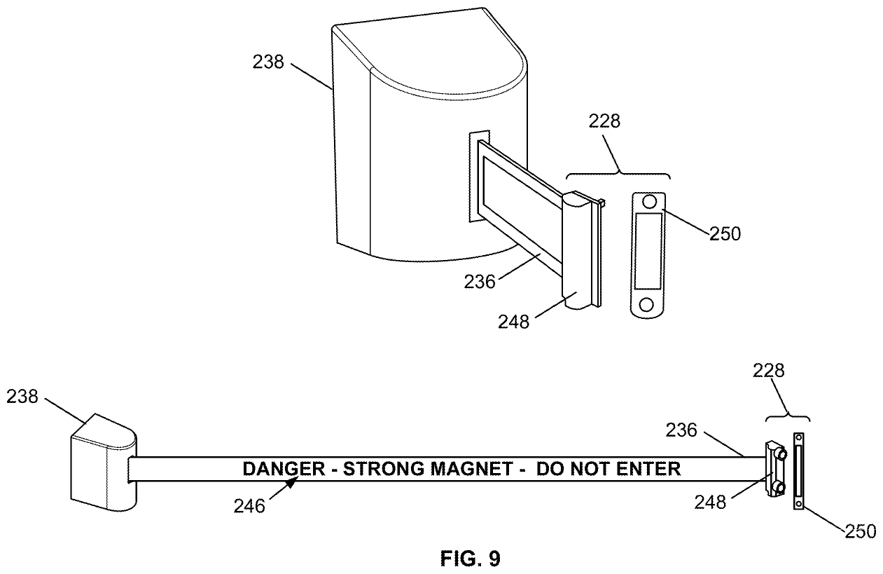

Next, FIG. 9 shows an example implementation of the caution barrier 224 shown in FIG. 5 and FIG. 6. As described with respect to one or more of those figures, the caution barrier 224 includes the belt deployment sensor 228, the retractable belt 236, and the belt retractor 238. The retractable belt 236 can include a textual and/or graphical warning 246 that is visible when the retractable belt is extended out of the belt retractor 238. The belt deployment sensor 228 include a sensor component 248, 250. The examples corresponding to the sensor component 218, 220 are applicable to the sensor component 248, 250. Additionally, the sensor component 248, 250 can attach to one another while the caution barrier 224 is deployed. For embodiments in which the belt deployment sensor 228 uses a magnet for sensing deployment of the caution barrier 224, the belt deployment sensor 228 can include a mechanical latch to attach the sensor component 218 to the sensor component 220. For embodiments in which the belt deployment sensor 228 uses mechanical components to sense deployment of the caution barrier 224, the belt deployment sensor 228 can include magnets to attach the sensor component 218 to the sensor component 220. Other examples are possible.

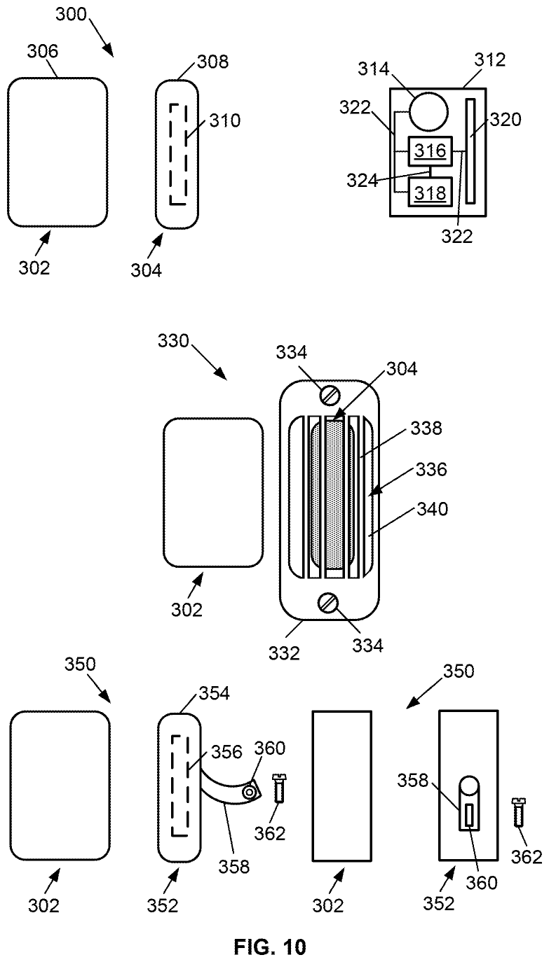

Next, FIG. 10 shows sensor arrangements, in accordance with the example embodiments. In particular, FIG. 10 shows a sensor arrangement 300 comprising a sensor 302 and a magnet assembly 304. The sensor 302 includes a sensor housing 306 or more simply a “housing.” The magnet assembly 304 includes a magnet housing 308 or more simply a “housing,” and a magnet 310. The sensor 68, 130, 132, 134, 136, 170, 228, 254 and/or the door contact sensor 232 can be arranged like the sensor 302 or any portion of the sensor 302.

The sensor 302 can include a circuit board 312, a battery 314, a processor 316, a transceiver 318, a switch 320 (e.g., a reed switch), electrical circuitry 322 (for connecting the battery, the processor 316, the transceiver 318, and the switch 320), and a data bus 324 for operatively connecting the processor 316 and the transceiver 318. Other sensors described in this description can include all or some of the components of the sensor 302.

As an example, the transceiver 318 can be configured to transmit and/or receive radio communications in accordance with one or more wireless communication standards or protocols built on top of the IEEE 802.15.4 physical/MAC layers, such as the ZIGBEE® protocol or the WIREPAS® protocol, or some other wireless communication standard or protocol, such as a BLUETOOTH® standard. In this regard, the transceiver 318 can be configured to use a particular wireless channel, such as a channel for communicating using the WIREPAS® protocol, and subsequently reconfigured to use a different wireless channel, such as a channel for communicating using a BLUETOOTH® standard. The sensor 302 can receive a configuration parameter from the gateway 450 that causes the sensor 302 to reconfigure its channel use.

As another example, the transceiver 318 can be configured to transmit and/or receive communication over an electrical circuit using a protocol or standard such as the USB specification, or some other wired communication protocol or standard.

FIG. 10 also shows a sensor arrangement 330 including the sensor 302, the magnet assembly 304, and a shield 332. The shield 332 can be removably attached to a restricted room door using a fastener 334 (e.g., one or more fasteners, such as a screw). In accordance with at least some embodiments, the shield 332 includes a grate 336 having one or more strips 338 and one or more spaces 340. The spaces 340 are configured to be small enough such that if the magnet assembly 304 becomes unattached to a door, the magnet assembly 304 will not pass through the grate 336. In accordance with at least some other embodiments, the shield 332 includes through-holes for placement of the fastener 334, but does not include the grate 336.

FIG. 10 further shows front and side views of a sensor arrangement 350 including the sensor 302 and a magnet assembly 352. The magnet assembly 352 includes a magnet housing 354 or more simply a “housing,” a magnet 356, a tether strap 358, a tether strap ring 360, and a fastener 362. The fastener 362 can removably attach the magnet assembly 352 to a restricted room door. The tether strap 358 can hold the magnet housing 354 and the magnet 356 in proximity to the restricted room door in case a supplemental adhesive fails to keep the magnet housing 354 and the magnet 356 affixed to the door.

### III. Example Computing Systems and Devices

### A. Server

FIG. 11 is a block diagram of a server 400 in accordance with the example embodiments. The server 400 includes a processor 402, a transceiver 404, a memory 406, a user interface 408, power circuitry 410, and a data bus 412. The data bus 412 operatively connects two or more of the processor 402, the transceiver 404, the memory 406, the user interface 408, or the power circuitry 410 to each other. The server 400, or any other server, described this description can include and/or be arranged as an industrial-strength computing system or device (e.g., an industrial-strength server). The server 104 (shown in FIG. 1) can be arranged like the server 400 and/or can include all or some of the components of the server 400.

### 1. Processor

A processor, such as the processor 402 or any other processor discussed in this description, can include one or more processors. Any processor discussed in this description can thus be referred to as “at least one processor” or “one or more processors.” Furthermore, any processor discussed in this description can include a general-purpose processor (e.g., an INTEL® single-core microprocessor or an INTEL® multicore microprocessor), and/or a special purpose processor (e.g., a digital signal processor, a graphics processor, an embedded processor, or an application specific integrated circuit (ASIC) processor). A general-purpose processor, a special purpose processor, and/or an embedded processor can perform analog signal processing and/or digital signal processing. Any processor discussed in this description can include or be operatively connected to a memory controller that controls a flow of data going to and from a memory, such as the memory 406, over a data bus, such as the data bus 412. Any processor discussed in this description can be arranged as a system-on-chip that is configured for video processing. The system-on-chip processor can include a central processing unit, a graphical processing unit, an image signal controller, and a memory controller

Any processor discussed in this description can be configured to execute computer-readable program instructions (CRPI) (or more simply “program instructions”). Any CRPI discussed in this description can, for example, include assembler instructions, machine instructions, machine dependent instructions, microcode, firmware instructions, state-setting data, and/or either source code or object code written in one or any combination of two or more programming languages. As an example, a programming language can include an object-oriented programming language such as Java, Python, or C++, or a procedural programming language, such as the “C” programming language. Any processor discussed in this description can be configured to execute hard-coded functionality in addition to or as an alternative to software-coded functionality (e.g., via CRPI). A set of CRPI can be grouped as a module, such as a module callable from an executable application. In at least some embodiments of the server 400 the processor 402 can be programmed to perform any function(s) described in this description as being performed by the server 104, 400.

### 2. Transceiver

A transceiver, such as the transceiver 404 or any other transceiver discussed in this description, can include one or more transceivers. Each transceiver includes one or more transmitters configured to transmit data onto a network (e.g., a communication link) and/or a data bus within the device including the transceiver. Each transceiver includes one or more receivers configured to receive data or a communication carried over a network (e.g., a communication link) and/or a data bus within the device including the transceiver. Unless stated differently, any data described as being transmitted to a device or system is considered to be received by that device or system. Similarly, unless stated differently, any data described as being received from a device or system is considered to be transmitted by that device or system directly or indirectly to the receiving device or system.

For some embodiments, a transceiver can include a transmitter and a receiver in a single semiconductor chip. In at least some of those embodiments, the semiconductor chip can include a processor. For some embodiments, a transceiver can be configured to receive data from a remote device (e.g., a sensor) but is not capable or configured to transmit data offboard the device containing the transceiver. For some embodiments, a transceiver can be configured to transmit data to a remote device (e.g., a local computing system) but is not capable or configured to receive data from a device offboard the device containing the transceiver.

In at least some of the example embodiments, a transmitter, such as a transmitter within any transceiver described in this description, transmits radio signals carrying data, and a receiver, such as a receiver within any transceiver described in this description, receives radio signals carrying data. A transceiver with a radio transmitter and radio receiver can include one or more antennas and can be referred to as a “radio transceiver,” an “RF transceiver,” or a “wireless transceiver.” “RF” represents “radio frequency.”

A radio signal transmitted or received by a radio transceiver can be arranged in accordance with one or more wireless communication standards or protocols such as an IEEE® standard, such as (i) an IEEE® 802.11 standard for wireless local area networks (wireless LAN) (which is sometimes referred to as a WI-FI® standard) (e.g., 802.11a, 802.11b, 802.11g, or 802.11n), (ii) an IEEE® 802.15 standard (e.g., 802.15.1, 802.15.3, 802.15.4, or 802.15.5) for wireless personal area networks (WPANs), (iii) a BLUETOOTH® standard (another WPAN standard), such as the BLUETOOTH® 5.0 or 6.0 standard developed by the Bluetooth Special Interest Group (SIG) of Kirkland, Washington, (iv) a cellular wireless communication standard such as a long term evolution (LTE) standard, (v) a code division multiple access (CDMA) standard, (vi) an integrated digital enhanced network (IDEN) standard, (vii) a global system for mobile communications (GSM) standard, (viii) a general packet radio service (GPRS) standard, (ix) a universal mobile telecommunications system (UMTS) standard, (x) an enhanced data rates for GSM evolution (EDGE) standard, (xi) a multichannel multipoint distribution service (MMDS) standard, (xii) an International Telecommunication Union (ITU) standard, such as the ITU-T G.9959 standard referred to as the Z-Wave standard, (xiii) a 6LoWPAN standard, (xiv) a Thread networking protocol, (xv) an International Organization for Standardization (ISO/International Electrotechnical Commission (IEC) standard such as the ISO/IEC 18000-3 standard for Near Field Communication (NFC), (xvi) the Sigfox communication standard, (xvii) the Neul communication standard, (xviii) the LoRaWAN communication standard, or a 5G new radio (5G NR) communication standard by the 3^{rd} Generation Partnership Project (3GPP) standards organization, such as the 5G NR, phase 1 or 5G NR, phase 2 communication standard. Other examples of the wireless communication standards or protocols are possible.

A radio signal transmitted or received by a radio transceiver can be arranged in accordance with one or more wireless communication standards or protocols built on top of the IEEE 802.15.4 physical/MAC layers, such as the ZIGBEE® protocol or the WIREPAS® protocol, which are example protocols for a low-power wireless network.

In at least some of the embodiments, a transceiver, transmitter, or receiver can operate as a decentralized wireless mesh transceiver, transmitter, or receiver for low power Internet over Things (IoT) (i.e., a low-power wireless network). As an example, such transceiver, transmitter, or receiver can operate in the 2.4 GHz band. As another example, such transceiver, transmitter, or receiver can operate according to the WIREPAS® protocol.

In at least some of the embodiments, a transmitter, such as a transmitter within any transceiver described in this description, can be configured to transmit a signal (e.g., one or more signals or one or more electrical waves) carrying or representing data onto an electrical circuit (e.g., one or more electrical circuits). Similarly, a receiver, such as a receiver within any transceiver described in this description, can be configured to receive via an electrical circuit a signal carrying or representing data over the electrical circuit. The electrical circuit can connect to a sensor, such as a door sensor or a caution barrier sensor. The signal carried over an electrical circuit can be arranged in accordance with a wired communication standard such as a Transmission Control Protocol/Internet Protocol (TCP/IP), an IEEE® 802.3 Ethernet communication standard for a LAN, a data over cable service interface specification (DOCSIS standard), such as DOCSIS 3.1, a universal serial bus (USB) specification, a vehicle data message (VDM) protocol, or some other wired communication standard or protocol. Examples of a VDM protocol are listed in Section VI of this description. An electrical circuit can include a wire, a printed circuit on a circuit board, and/or a network cable (e.g., a single wire, a twisted pair of wires, a fiber optic cable, a coaxial cable, a wiring harness, a power line, a printed circuit, a CAT5 cable, and/or CAT6 cable). The wire can be referred to as a “conductor”. Transmission of data over the conductor can occur electrically and/or optically.

In at least some embodiments, a transceiver includes a modem, a network interface card, a local area network (LAN) on motherboard (LOM), and/or a chip mountable on a circuit board. As an example, the chip can include a CC3100 Wi-Fi® network processor available from Texas Instruments, Dallas, Texas, a CC256MODx Bluetooth® Host Controller Interface (HCI) module available from Texas instruments, or a different chip for communicating via Wi-Fi®, Bluetooth® or another communication protocol.

A network node that is within and/or coupled to a non-vehicle network and/or that communicates via a non-vehicle network or a multi-purpose network using a packet-switched technology can be locally configured for a next ‘hop’ in the network (e.g., a device or address where to send data to, and where to expect data from). As an example, a device (e.g., a transceiver) configured for communicating using an IEEE® 802.11 standard can be configured with a network name, a network security type, and a password. Some devices auto-negotiate this information through a discovery mechanism (e.g., a cellular phone technology).

A transceiver can be arranged to transmit a request and/or receive a response using a transfer protocol, such a hypertext transfer protocol (i.e., HTTP), an HTTP over a secure socket link (SSL) or transport layer security (TLS) (i.e., HTTPS), a file transfer protocol (i.e., FTP), or a simple mail transfer protocol (SMTP). A transceiver can be arranged to transmit an SMS message using a short message peer-to-peer protocol or using some other protocol.

The data transmitted by a transceiver can include a destination identifier or address of a computing device to which the data is to be transmitted. For example, the data or communication transmitted by the transceiver 404 can include a source identifier or address of the server 400. The source identifier or address can be used to send a response and/or a request to the server 400. The transceiver 404 can transmit and received data over the Internet.

### 3. Memory

A memory, such as the memory 406 or any other memory discussed in this description, can include one or more memories. Any memory discussed in this description can thus be referred to as “at least one memory” or “one or more memories.” A memory can include a non-transitory memory, a transitory memory, or both a non-transitory memory and a transitory memory. A non-transitory memory, or a portion thereof, can be located within or as part of a processor (e.g., within a single integrated circuit chip). A non-transitory memory, or a portion thereof, can be separate and distinct from a processor.

A non-transitory memory can include a volatile or non-volatile storage component, such as an optical, magnetic, organic or other memory or disc storage component. Additionally, or alternatively, a non-transitory memory can include or be configured as a random-access memory (RAM), a read-only memory (ROM), a programmable read-only memory (PROM), an erasable programmable read-only memory (EPROM), a flash memory, an electrically erasable programmable read-only memory (EEPROM), or a compact disk read-only memory (CD-ROM). The RAM can include static RAM or dynamic RAM. A non-transitory memory can be configured as a removable storage device, a non-removable storage device, or a combination thereof. A removable storage and/or a non-removable storage device can, but need not necessarily, include a magnetic disk device such as a flexible disk drive or a hard-disk drive (HDD), an optical disk drive such as a compact disc (CD) drive and/or a digital versatile disk (DVD) drive, a solid-state drive (SSD), or a tape drive.

A transitory memory can include, for example, CRPI provided over a communication network, such as the data bus 412 and/or the communication network 102 shown in FIG. 1.

A “memory” can be referred to by other terms such as a “computer-readable memory,” a “computer-readable medium,” a “computer-readable storage medium,” a “data storage device,” a “memory device,” “computer-readable media,” a “computer-readable database,” “at least one computer-readable medium,” or “one or more computer-readable mediums.” Any of those alternative terms can be preceded by the prefix “transitory” if the memory is transitory or “non-transitory” if the memory is non-transitory. For a memory including multiple memories, two or more of the multiple memories can be the same type of memory or different types of memories. A portion of a memory can be designated as one or more frame buffers, such as a frame buffer for storing pixel values before being provided to a display. The pixel values can include pixel values for displaying a GUI, such as any GUI discussed in this description, on a display.

### 4. User Interface

A user interface, such as the user interface 408 or any other user interface discussed in this description, can include one or more user interfaces. A user interface described in this description can include an input device (i.e., one or more input devices), an output device (i.e., one or more output devices), and a display (i.e., one or more displays). In FIG. 1, those aspects are shown as an input device 414, an output device 416, and a display 418, respectively.

As an example, the input device of a user interface described in this description can include a keyboard or keypad including one or more keys configured to be pressed or otherwise manipulated by the user and/or a microphone configured for receiving sound waves produced when a user is speaking.

As an example, the output device of a user interface described in this description can include an audio output device, such as one or more speakers configured to convert electrical signals to audible sounds. The audio output device can include wired headphones and/or wireless headphones. The wired headphones can connect to an audio plug operatively connectable to an audio jack. The wireless headphones can include in-ear headphones, such as the AIRPODS PRO® in-ear headphones by Apple Inc.

As another example, the output device of a user interface described in this description can include a haptic feedback device, such as an eccentric rotating mass motor, a linear resonant actuator, a piezoelectric actuator, and/or a forced impact (accelerated ram) device. The haptic feedback device can be configured as a wearable haptic feedback device. As an example, the wearable haptic feedback device can include an article of clothing, a wristwatch, a glove, or eyewear, such as safety glasses or goggles.

As an example, the display of a user interface described in this description can include a plasma display, a light emitting diode (LED) display, a cathode ray tube display, an organic light-emitting diode (OLED) display (such as an active-matrix OLED or a passive-matrix OLED), or a liquid crystal display (LCD) (such as include a backlit, color LCD). Other examples of the display technology usable in the example embodiments are also possible.

In accordance with at least some embodiments, a display can be covered by and/or arranged with a touch screen to form a touch screen display. As an example, a touch screen display can be arranged as a capacitive touch screen display (e.g., a projective capacitive (PCAP) touch screen display), a resistive touch screen display, or a display covered by a touch screen of another touch screen technology. A display that is usable with one or more of the example embodiments can be made using a display technology, such as PCAP technology, to allow a user to make selections via the display while the user is wearing rubber gloves or the like within a medical facility or elsewhere.

A display, with or without a touch screen, can be arranged as an industrial-strength display. An industrial-strength display can include protection against dust and water as compared to any protection a display of a typical smartphone provides. An industrial-strength display can include impact protection with a rating, defined by the International Electrotechnical Commission (IEDC) standard IEC 62262, within the range of IK08 to IK10 or another range. An industrial-strength display and/or the electrical circuitry used for operating the display can include protection against electrical surges and electro-static discharges (ESD). Other characteristics can be used to define an industrial-strength display usable with one or more of the example embodiments. A computing system or device including an industrial-strength display can, itself, be an industrial-strength computing system or device. An industrial-strength computing system or device can also be arranged with impact and electrical protection as discussed with respect to a display.

As another example, the display of a user interface described in this description can include and/or be embodied within a wearable device, such as a pair of glasses or goggles, a head-mountable display, or a wrist display, such as a wristwatch (e.g., a smartwatch). A touchscreen display can function as the input and output devices of the user interface.

The display of a user interface described in this description can be configured to display a still image, a video, a text file (such as a text file with a PDF file extension or an XML file extension), a hypertext markup language file, a web page (such as a web page including a search bar and a cursor), and/or a graphical user interface (GUI). The display can be configured to display a horizontal scroll bar and/or a vertical scroll bar. The horizontal scroll bar and the vertical scroll bar can be used to cause the display to display content not currently shown on the display. A web page displayable on the display can include any content shown in or described with respect to any GUI described in this description. The display can receive a pixel stream including data stored in a frame buffer before being streamed to the display.

### 5. Power Circuitry

Power circuitry, such as the power circuitry 410 or any other power circuitry discussed in this description, can be arranged as described in this paragraph. The power circuitry can include a power supply and/or a connection to a power supply. As an example, the connection to a power supply can include a power distribution cord and plug that connect to an Alternating Current (AC) power receptacle (i.e., a wall outlet). The power circuitry can include an energy storage device (e.g., a battery). The power supply can include the energy storage device. The power circuitry can include a voltage regulator, a voltage converter (such as an AC to direct current (DC) converter or a DC to AC converter), and/or a step-up or step-down voltage transformer. The power circuitry can include circuit protection, such as a fuse. The power circuitry can include a power distribution circuit (i.e., one or more power distribution circuits). For example, the server 400 includes a power distribution circuit 420.

### 6. Memory Content

FIG. 11 also shows content that can be stored within the memory 406. For example, the memory 406 can include an operating system 422, an application 423, a module 424, a database 426, 428, a GUI 444, an alert 446, instructional content 448, and a software update 449. The database 426 and the database 428, in combination, can form a single database. The database 426, 428 can each comprise one or more databases. The operating system 422 and/or the application 423 can include a clock for time stamping data, such as data received from a gateway, a client, or a local computing system.

The operating system 422 can comprise one or more operating systems executable on the server 400 (which can include one or more server computing systems). As an example, the operating system 422 can include an operating system, such as a Linux-based operating system, a Windows server operating system, or a Unix-based operating system. Other examples of the operating system 422 are possible.

The application 423 can include one or more applications. The module 424 can include one or more modules. The application 423 can include a module of the module 424. A module of the module 424 can be separate from and called by the application 423. The application 423 and/or the module 424 are executable by the processor 402 to perform tasks (e.g., the functions described in this description as being performed by a server, such as the server 104, 400).

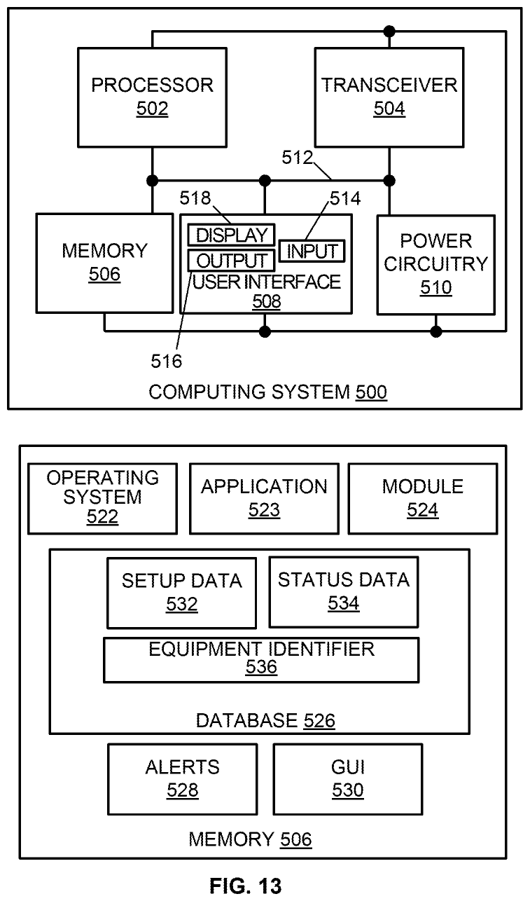

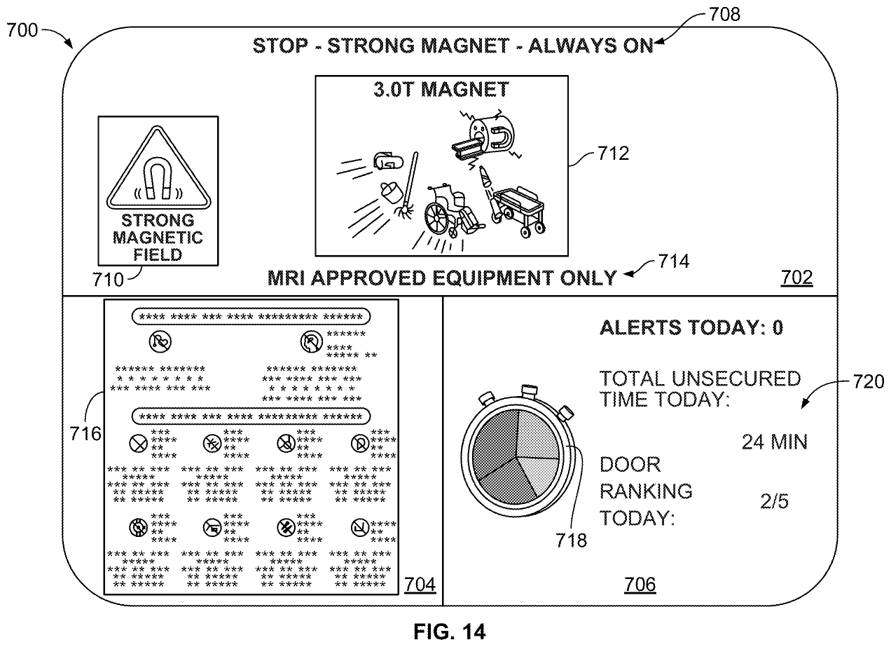

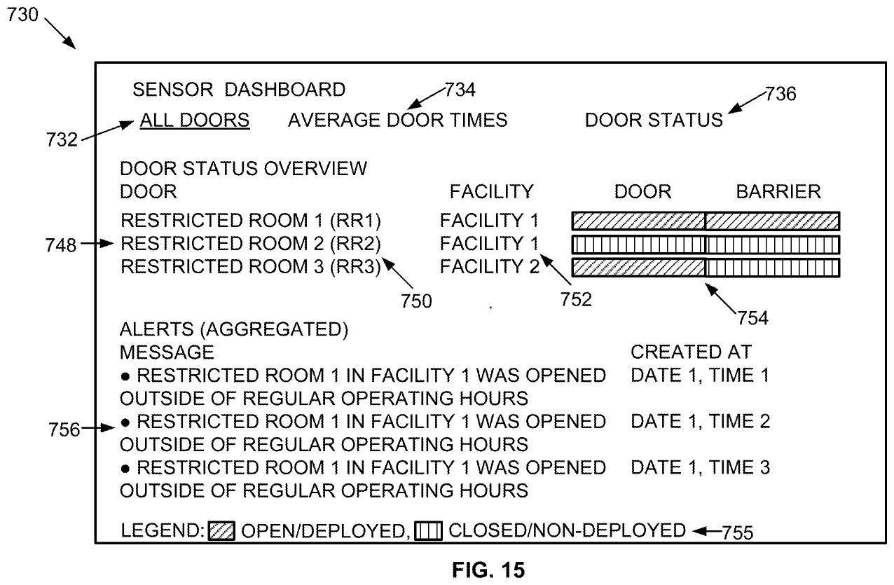

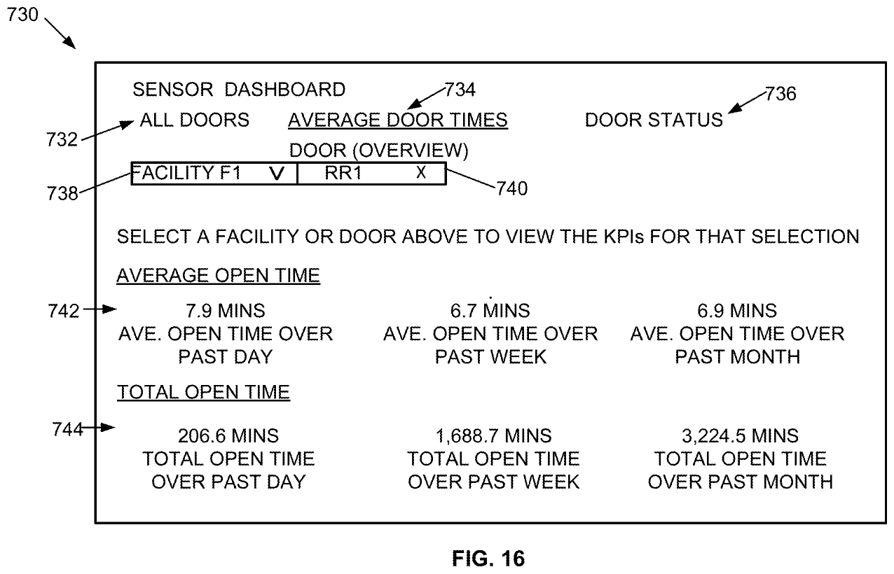

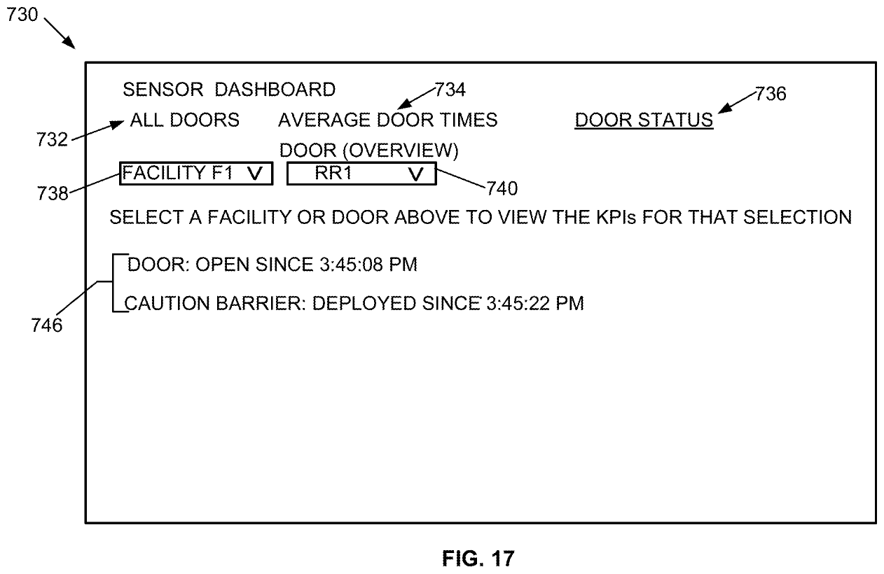

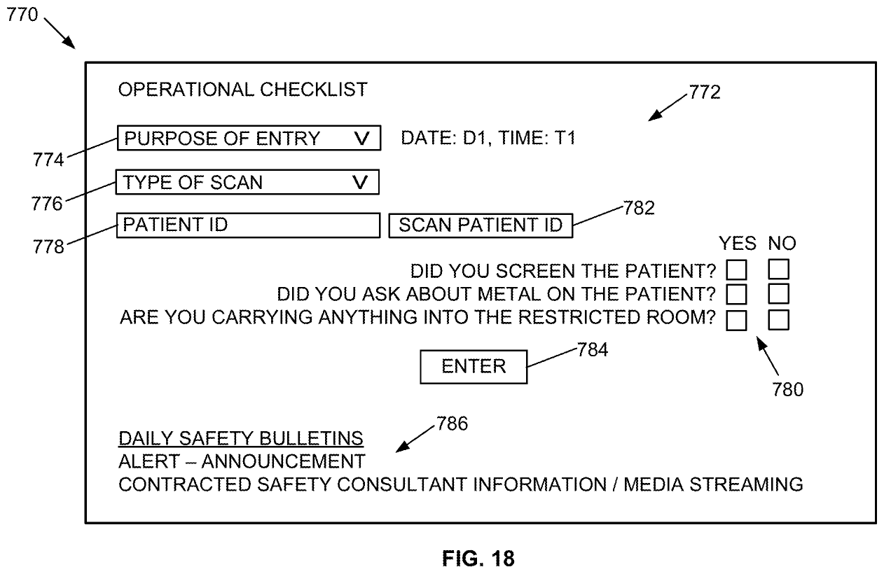

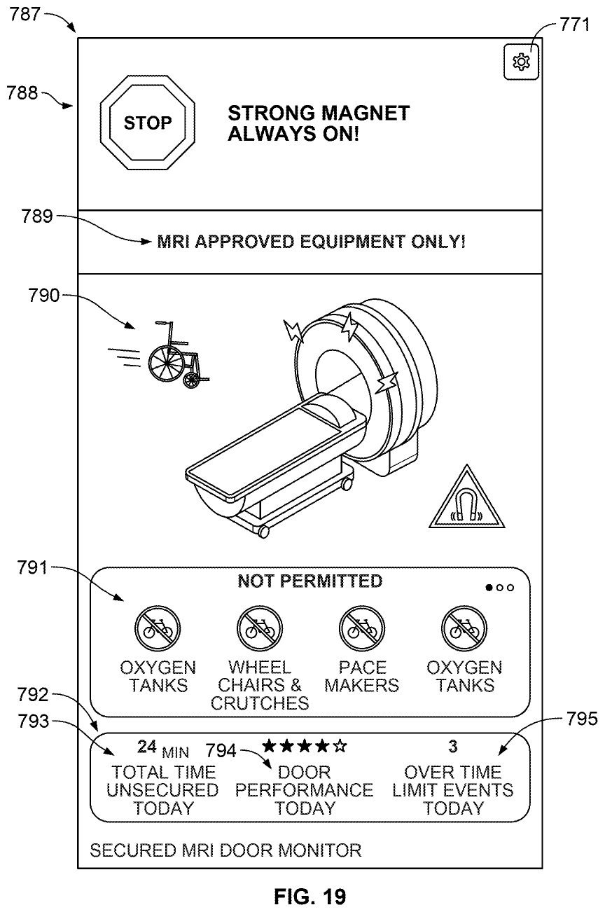

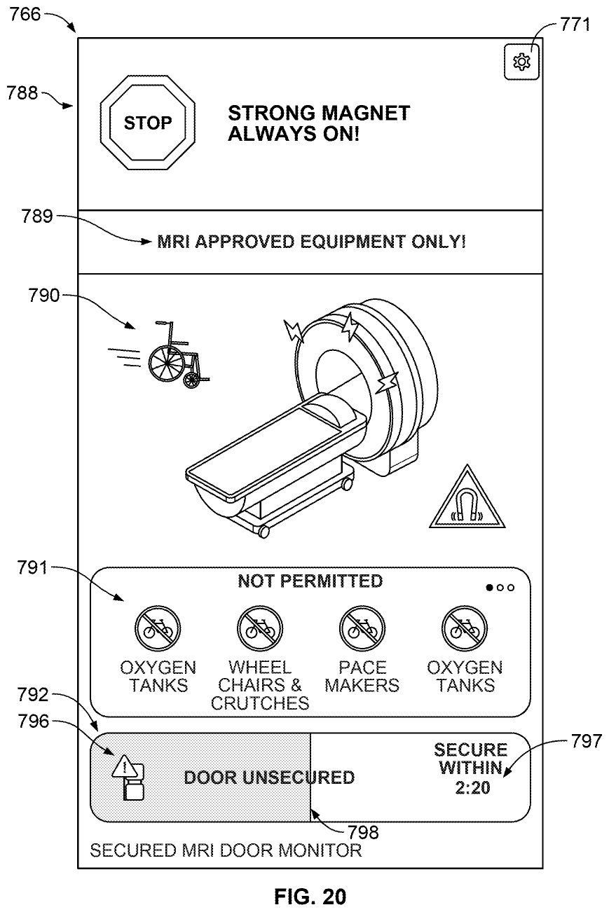

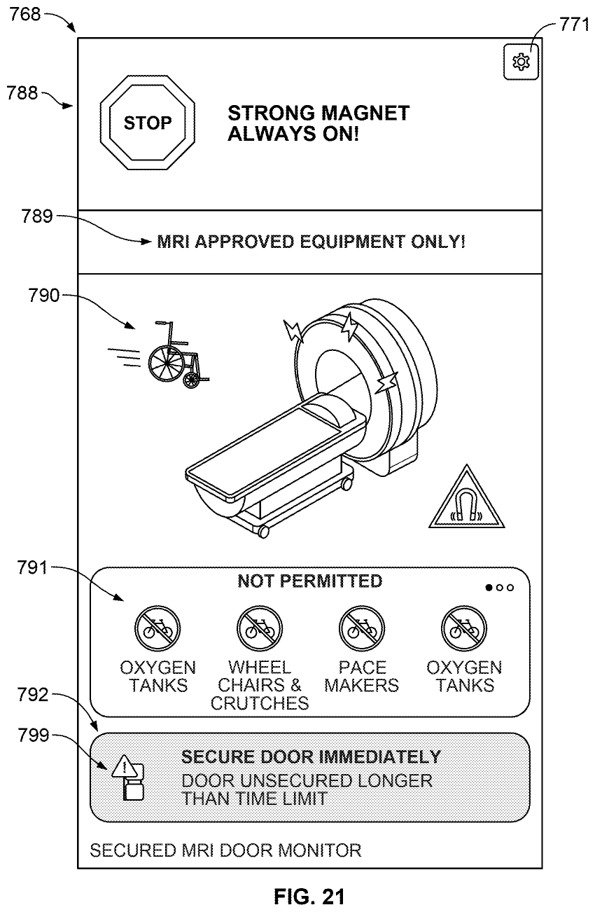

As an example, the application 423 can include a Web application, such as the Internet Information Services (IIS) available from MICROSOFT® (i.e., the Microsoft Corporation of Redmond, Washington). As another example, the application 423 can include a database management system (DBMS) program, such as MySQL available from ORACLE® (i.e., the Oracle International Corporation of Redwood City, California). The processor 402 can execute the DBMS program to read data within a database and/or to write data into a database. Yet another example, the application 423 can be executable to configure a gateway (e.g., the gateway 450 shown in FIG. 12), sensors and/or caution barriers connected to the gateway, or a client (e.g., the computing system 500 shown in FIG. 13). The application 423 can serve a webpage to a client to allow a user to select configuration parameters to configure the gateway or the client. Other examples of the application 423 are possible. As an example, configuration of a sensor, a caution barrier, or a local computing system can occur indirectly in that the server 400 transmits a configuration parameter or instruction to a gateway and the gateway forwards the configuration parameter or instruction to the sensor, caution barrier or local computing system. In some cases, the gateway forwards the configuration parameter or instruction to a first of the sensor, caution barrier or local computing system, which then forwards the configuration parameter or instruction to a second of the sensor, caution barrier or local computing system.

An application and/or module of the application 423 can be executable to programmatically analyze sets of data the server receives from one or more gateways individually and based on an aggregation of data from multiple gateways. Statistical data can be generated based on the analysis. As an example, the statistical data can include an operational baseline indicating an average unsecured door time. The operational baseline can dynamically change in real-time. The operational baseline can be used as an operational standard of care for determining whether to output an alert regarding a door of a restricted room being open and unsecured. The sets of data received by the server can be sensor data the gateway sends to the server via multiple communications.

Algorithmic data analysis of anomalous door open durations, frequency and non-use of remotely monitored caution barriers, such as a retractable belt or an automated gate can be cross correlated with staffing schedules to identify problematic safety or efficiency workflow practices or staff. The utilization of presence and transit sensors that transmit data to the gateway 450 and/or the server 400 can algorithmically correlate safe workflow of staff as they enter or leave the MRI room. The further benefit of these sensors versus video recordings of the doorway is that privacy and HIPPA regulations are abided by. Key performance indicators and benchmark statistical results from a national network of users can assist in creating effective and efficient operational protocols and directly reduce unsafe practices.

The database 426 can include data regarding multiple restricted rooms, as well as a door and caution barrier corresponding to each restricted room. As an example, the database 426 can include restricted room data 430, 432, 434, 436 regarding first, second, third, and fourth restricted rooms, respectively. Those rooms can be referred to as RR1, RR2, RR3, and RR4, respectively. As an example, the restricted room data 430 can comprise configuration parameters corresponding to a gateway, sensor, and caution barrier located at RR1. Likewise, the restricted room data 432, 434, 436 can comprise configuration parameters corresponding to a gateway, sensor, and caution barrier located at RR2, RR3, and RR4, respectively. Those configuration parameters can include standard or custom times for triggering an alert, among other parameters, and unique identifiers of the gateway, sensor, and caution barrier. In accordance with at least some embodiments, an alert trigger time can include an average time determined programmatically by the processor 402.

As another example, the restricted room data 430 can comprise configuration parameters corresponding to one or more clients enrolled to receive alerts and status data regarding the gateway, the sensor, and the caution barrier located at RR1. Likewise, the restricted room data 432, 434, 436 can comprise configuration parameters corresponding to one or more clients enrolled to receive alerts and status data regarding the gateway, the sensor, and the caution barrier located at RR2, RR3, and RR4, respectively. Those configuration parameters can include e-mail addresses for users associated with a particular restricted room, and a mobile telephone number associated with a client associated with a particular restricted room. The examples corresponding to other status data described in this description, such as the status data 488, 534 are applicable to the status data that can be contained within the restricted room data 430, 432, 434, 436.

As yet another example, the restricted room data 430, 432, 434, 436 can include KPIs for populating a GUI showing statistics and status data regarding RR1, RR2, RR3, and RR4, respectively.

As yet another example, the restricted room data 430, 432, 434, 436 can include equipment identifiers for tagged equipment in a facility at which a restricted room is located, and data indicating whether the tagged equipment is approved or disapproved for movement into the restricted room. In other words, the restricted room data 430, 432, 434, 436 can include or be arranged as a registry of known department items identified as allowed or not allowed within the restricted room. That registry can be referred to as an “equipment registry.” The server 400 can output an alert to a remote client from the alert 446 indicating whether a piece of equipment corresponding to the equipment identifier is approved or not approved for entry into a restricted room.

The restricted room data within the database 426 can include data received from a gateway that is connected to and/or received sensor signals from sensors located in proximity to a door of a restricted room corresponding to the restricted room data. For example, the data received from the gateway can include status data determined by the gateway and/or indicated by sensor signals received at the gateway (and forwarded to the server).

A sensor signal comprises a signal that carries sensor data. A sensor signal can be referred to more simply, as a “signal.” Sensor data can be carried using one or more sensor signals. Therefore, a sensor signal can include one or more sensor signals. The sensor data can include data that indicates a value or values determined (e.g., sensed) by the sensor. A sensor signal can be a continuous signal carrying one or more values determined by a sensor. A continuous sensor signal can carry other data between carrying different values determined by a sensor or values determined at different times. A continuous sensor signal can carry no data between carrying different values determined by a sensor or values determined at different times. Alternatively, a sensor signal can be intermittent, such as a sensor signal transmitted when a sensor determines a change in a sensed condition. Other examples of content in a sensor signal are possible.

A sensor signal can carry and/or sensor data can include a sensor identifier to distinguish the sensor that transmitted the sensor signal and/or sensor data from other sensors. A sensor signal can carry and/or sensor data can include a heartbeat signal indicating the sensor operating as expected. A sensor signal can carry and/or sensor data can include diagnostic data indicating the sensor is malfunctioning or is exhibiting a condition of the sensor that is to be communicated off-board the sensor. As an example, the condition can be a low-battery voltage condition. A sensor signal can carry and/or sensor data can include data the sensor receives from another sensor or device, such as another sensor or device within a mesh network including the sensor and the other sensor or device. The data the sensor receives can include sensor data determined by another sensor. Other examples of sensor data are possible. The foregoing aspects regarding a sensor signal and sensor data can pertain to any sensor signal and/or sensor data discussed in this description.

The restricted room data within the database 426 can include data that represents a log of any and/or all notifications output by the server with respect to a restricted room corresponding to the restricted room data. A message log 756 shown in FIG. 15 provides an example of notifications that can be stored in restricted room data 430 for Restricted Room 1 (i.e., RR1). The restricted room data within the database 426 can include data entered via an interactive display (e.g., GUI), such as the GUI 770 shown in FIG. 18.

The database 428 can include aggregated data based on data corresponding to one or more restricted rooms. As shown in FIG. 11, the database 428 can include aggregated data 438 (i.e., AD-1), aggregated data 440 (i.e., AD-2), and aggregated data 442 (i.e., AD-N). The “N” within AD-N represent a variable integer greater than or equal to 2 and is meant to indicate the database 428 can include multiple sets of aggregated data besides those shown in FIG. 11.

As an example, the aggregated data 438 can include an aggregation of data from multiple gateways for a first enterprise, and the aggregated data 440 can include an aggregation of data from multiple gateways for a second enterprise. For instance, the first enterprise can include the gateways corresponding to RR1 and RR2, and the second enterprise can include the gateways corresponding to RR3 and RR4. In that regard, the aggregated data 438 can include statistics and status data corresponding to the restricted rooms of the first enterprise, and the aggregated data 440 can include statistics and status data corresponding to the restricted rooms of the second enterprise. The server 400 can be configured to transmit data and GUIs corresponding to the aggregated data 438 to one or more clients registered with respect to the first enterprise. Likewise, the server 400 can be configured to transmit data and GUIs corresponding to the aggregated data 440 to one or more clients registered with respect to the second enterprise.

The aggregated data 442 can include an aggregation of data from one or more gateways for multiple enterprises, such as the first and second enterprises. In that regard, the aggregated data 442 can include statistics and status data corresponding the restricted rooms of the first and second enterprises. The server 400 can be configured to transmit data and GUIs (or data for populating within GUIs) corresponding to the aggregated data 442 to one or more clients registered with respect to an enterprise that operates a gateway that contributes data for aggregating into the aggregated data 442.

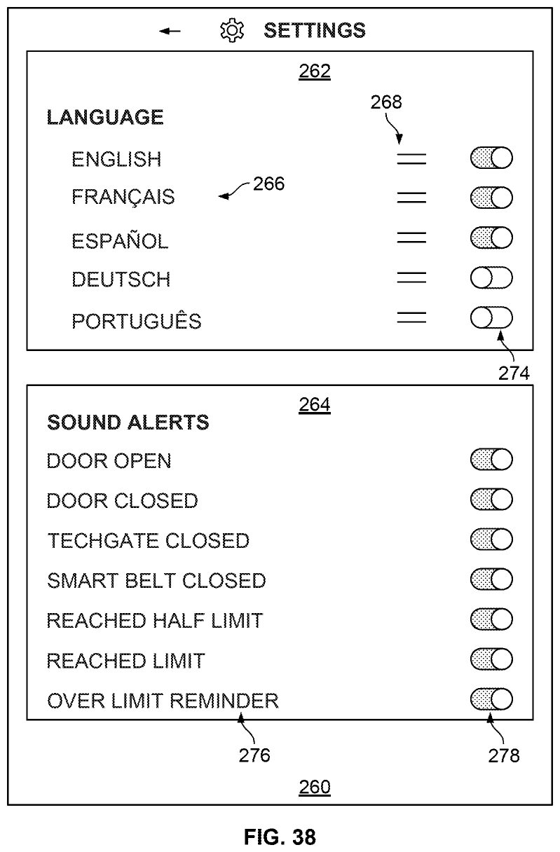

The GUI 444 can include one or more GUIs. The GUI 444 can include data to populate within a GUI of the GUI 444. As an example, the GUI 444 can include a GUI that forms a web-based dashboard displayable at a client, such as the computing system 500 shown in FIG. 13. As another example, the GUI 444 can include any GUI shown in FIG. 14 to FIG. 21 and FIG. 38 or otherwise described in this description. For example, the GUI 444 can include the GUI 700 shown in FIG. 14, the GUI 730 shown in FIG. 15 to FIG. 17, the GUI 770 shown in FIG. 18, the GUI 787 shown in FIG. 19, the GUI 766 shown in FIG. 20, the GUI 768 shown in FIG. 21, and/or the GUI 260 shown in FIG. 38. In that regard, one or more or all the GUI 260, 700, 730, 766, 768, 770, 787 can be separate views of the GUI 444. The processor 402 can serve a GUI to a client in response to a request, such as an HTTP request. The processor 402 can server data to populate in a GUI via an Application Programming Interface (API) at the server 400 or via a WebSocket established between the server 400 and a client.

The alert 446 can comprise one or more alerts. For example, the alerts 446 can include one or more textual, graphical, haptic, and/or audible alerts. An alert of the alerts 446 can indicate a door is open too long, a door is open during the wrong (i.e., unexpected) time frame, a door is open and a belt is unsecured too long, a door is open and an automated gate is unsecured too long, or a door is left unsecured (either open or without a caution barrier engaged for a threshold amount of time). The alerts 446 can comprise textual alerts sent to someone's cell phone (via a text message) and/or an e-mail message. The alerts 446 can comprise alerts provided at or in proximity to a restricted room via an interactive display site display (e.g., a computing system with an industrial-strength touchscreen display). FIG. 14 to FIG. 21 show examples of alerts that can be output in accordance with the example embodiments. Other examples of the alert 446 are possible. Each alert can correspond to one or more alert conditions (e.g., door and/or caution barrier status). The processor 402 can determine an alert condition is present and output a corresponding alert for transmission to a client configured to output the alert.

An alert of the alerts 446 can include an emergency notification. As example, an emergency notification can include a quench procedure notification, an adverse event notification, or a security event notification. An adverse event notification can indicate an event such as detection of a threshold temperature, detection of a threshold level of gas, detection of a ferrous metal object, detection of a door to restricted room being open for a threshold amount of time without a barrier deployed across its doorway, or some other type of event or condition.

The instructional content 448 includes content configured to be transmitted to a local computing system and output via a user-interface component, such as a display. The instructional content 448 can include a computer-readable file, such as a video file, an animation file, or an audio file configured to be output via the user interface component. A computer-readable file of the instructional content 448 can be streamed to the local computing system and output via the user-interface component in real time. Alternatively, the instructional content 448 can be downloaded to the local computing system in its entirety for future outputting to the user interface component.

The instructional content 448 can include content about one or more of the following aspects: (i) a safety overview, such as a safety overview discussing implants, clothing, or ferrous items, (ii) what to expect content, such as what to expect content for a patient or parent, or (iii) directed behavior content, such as movement control as the quality of an MRI generated image is compromised when the patient physically moves during the procedure or contrast application as when the patient is injected with a contrast agent to allow certain anatomical features to be imaged in greater detail. The instructional content 448 for one or more aspects can include multi-lingual versions. The instructional content 448 can include a checklist of safety task completion to check safety tasks pertaining to patient pre-screening, implants, ferrous metal detection pre-screening, clothing changes, footwear, or transfer equipment type. The instructional content 448 can include frequently asked questions and answers for patients and technologists. The instructional content 448 can include implant information and/or procedure information. The instructional content 448 can include educational content such as key opinion leader engagement, daily practice articles, ask-a-pro content, and video conferences. The instructional content 448 can include motivational and/or directional content. The instructional content 448 can include notices about adverse events, such as real-time event alerts from third party sources (e.g., in-network events or reports from CAIRE, LLC). The instructional content 448 can include recall information, such as recall regarding implants. The instructional content 448 can include a patient educational video, a visitor educational video and/or a digital patient or visitor MRI safety screening form. Other examples of the instructional content 448 are also possible.

The software update 449 can include one or more software updates to be transmitted to a gateway, a local computing system or a sensor. The server 400 can push the software update 449 to the appropriate device if the appropriate device is connected to the communication network 102. Alternatively, the server 400 can push the software update 449 to an intermediate device (e.g., a gateway) connected to the communication network 102, and the intermediate device can push the software update to a device not connected directly to the communication network 102. In some embodiments, a sensor and/or a local computing system is not connected directly to the communication network 102.

### B. Gateway

Next, FIG. 12 is a block diagram of a gateway 450 in accordance with the example embodiments. The gateway 450 can include a processor 452, a transceiver 454, a memory 456, a user interface 458, power circuitry 460, a sensor input/output (I/O) 462, gateway output circuitry 476, and/or a data bus 464. The data bus 464 operatively connects two or more of the processor 452, the transceiver 454, the memory 456, the user interface 458, or the power circuitry 460 to each other. The description of a processor, in general, discussed above with respect to the processor 402 is applicable to the processor 452.

The description of a transceiver, in general, discussed above with respect to the transceiver 404 is applicable to the transceiver 454. In that regard, the transceiver 454 can, for example, include a first transceiver configured to communicate using a BLUETOOTH® standard, and a second transceiver configured to communicate using a cellular network communication standard, such as an LTE or 5G NR communication standard. As another example, the first transceiver can be configured as a decentralized wireless mesh transceiver for low power IoT and/or as a radio transceiver arranged in accordance with one or more wireless communication standards or protocols built on top of the IEEE 802.15.4 physical/MAC layers, such as the ZIGBEE® protocol or the WIREPAS® protocol. Other examples of the quantity and types of transceivers embodied within the transceiver 454 are also possible. The transceiver 454 can transmit and receive data over the Internet. The transceiver 454 can transmit and receive data over a local communication link, such as the communication link 175, 177, 179 shown in FIG. 3.

The transceiver 454 can be configured to receive data transmitted thereto from a server (such as the server 400), a client (such as the computing system 500), a caution barrier (such as one or more caution barrier arranged like the caution barrier 224), and/or a sensor, such as the sensor 130, 132, 134, 136, 170, 218, 220, 240, 242, 562, 564. As an example, the data transmitted to the transceiver 454 can include a GUI and/or data to populate the GUI. The data transmitted to the transceiver 454 can include a notification, status data, an alert or other information regarding a door of a restricted room and a caution barrier located in proximity to the door. The data transmitted to the transceiver 454 can include sensor data transmitted by a sensor. Furthermore, the transceiver 454 can be configured to transmit data to a server (such as the server 400), a client (such as the computing system 500), a caution barrier (such as one or more caution barrier arranged like the caution barrier 224), and/or a sensor (such as any sensor described herein). As an example, the data transmitted by the transceiver 454 can include data for outputting a GUI on the computing system 500 or status data based on outputs of a caution barrier or client. As another example, the data transmitted by the transceiver 454 can include a configuration parameter for configuring a sensor or a local computing system.

The description of a memory, in general, discussed above with respect to the memory 406 is applicable to the memory 456. The description about power circuitry, in general, discussed above with respect to the power circuitry 410 is applicable to the power circuitry 460. The gateway 450, or any other gateway, described this description can include and/or be arranged as an industrial-strength computing system or device (e.g., an industrial-strength gateway).

The user interface 458 includes an input device 470, an output device 472, and a display 474. The description of an input device, in general, discussed above with respect to the input device 414 is applicable to the input device 470. The description of an output device, in general, discussed above with respect to the output device 416 is applicable to the output device 472. The description of a display, in general, discussed above with respect to the display 418 is applicable to the display 474.

Any gateway described in this description can be arranged like the gateway 450. For example, one or more of the gateway 122, 124, 126, 128, 168, 252 can be arranged like the gateway 450.

The sensor I/O 462 can be used with embodiments in which one or more sensors is hardwired to the gateway 450. As an example, one or more door sensors and/or one or more caution barrier sensors can be hardwired to the gateway. The hard wiring of a sensor and the gateway 450 can include an electrical power circuit, an electrical ground circuit, and a sensor output circuit that carries a signal generated by the sensor based on components within the sensor. As an example, the signal generated by the sensor can comprise a signal that indicates whether a door to a restricted room is open or closed. As another example, the signal generated by the sensor can comprise a signal that indicates whether a caution barrier is deployed. In accordance with at least some embodiments, the sensor I/O 462 includes an analog-to-digital converter to convert an analog signal received from the sensor to a digital signal provided to the processor 452.

The sensor I/O 462 and the processor 452 can operatively connect to each other using a circuit 466 that connects to an input pin of the processor 452 and a circuit 468 that connects to an output pin of the processor 452. The circuit 466 can comprise one or more circuits, each circuit connected to a respective input pin of the processor 452 and a respective sensor. The circuit 468 can comprise one or more circuits, each circuit connected to a respective output pin of the processor 452 and a respective sensor.

The gateway output circuitry 476 can include one or more electrical circuits connected to the processor 452. The processor 452 can control a gateway output device, such as the gateway output device 146, connected to the gateway output circuitry 476. As an example, the gateway output circuitry 476 can include power circuits (i.e., power and ground) and one or more control circuits for carrying a signal to control the gateway output device.

As an example, a gateway can include or be arranged like a Vesta mobile gateway available from Velavu Inc. located in Ottawa, Ontario, Canada.

FIG. 12 also shows content that can be stored within the memory 456. For example, the memory 456 can include an operating system 480, an application 481, a module 482, and a database 484. The operating system 480 and/or the application 481 can include a clock for time stamping data.

The operating system 480 can include a Real-Time Operating System (RTOS), such as FreeRTOS™ available from Amazon.com, Inc. of Seattle, Washington. Other examples of the operating system 480 are possible.

The application 481 can include one or more applications. The module 482 can include one or more modules. The application 481 can include a module of the module 482. A module of the module 482 can be separate from and called by the application 481. The application 481 and/or the module 482 are executable by the processor 502 to perform tasks (e.g., the functions described in this description as being performed by a gateway, such as the gateway 122, 124, 126, 128, 168, 252, 450). The application 481 can be updated based on a software update pushed or otherwise provided to the gateway 450. Other examples of the application 481 are possible.

This paragraph describes functions (i.e., executable function of the gateway 450) that can be performed by executing the application 481 and/or the module 482. An executable function of the gateway 450 can include receiving signal data transmitted from one or more sensors, and storing the received signal data within the status data 488 before transmitting the signal data to the server 400 and/or a local computing system, such as the local computing system 114, 116, 118, 120, 172, 222. An executable function of the gateway 450 can include pairing the gateway 450 with a wireless sensor, such as door contact sensor, a sensor within an automated gate, or a sensor within a retractable belt. An executable function of the gateway 450 can include monitoring for loss of communication from a sensor, a local computing system, and/or the server 400 and outputting a diagnostic alert, such as an alert to the server and/or an alert via the output device 416. An executable function of the gateway 450 can include receiving data from the server 400 for configuring the gateway to communicate with the server 400.

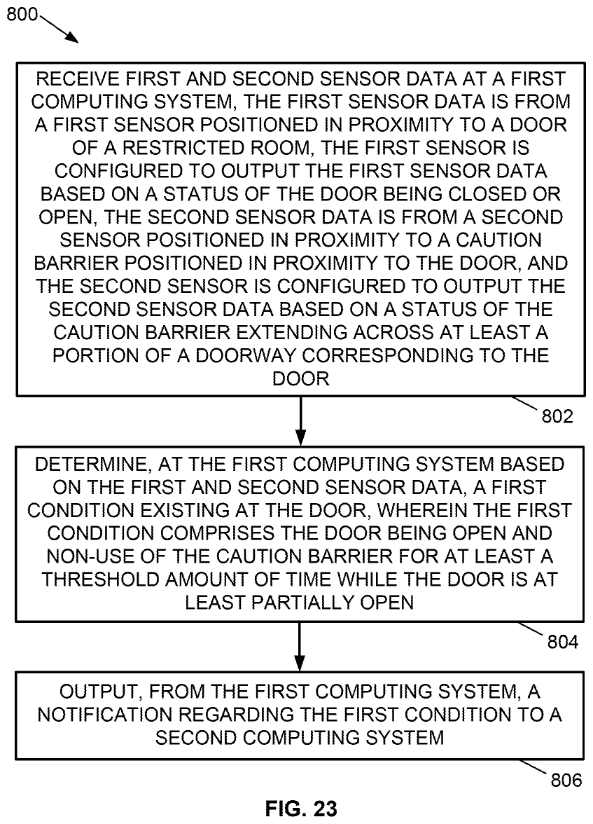

This paragraph describes additional functions that can be performed by executing the application 481 and/or the module 482. An executable function of the gateway 450 can include performing any function within the set 800 of functions shown in FIG. 23 or any function described as an additional function with respect to the set 800 of functions. In this regard, the first computing system can include the gateway 450 and the second computing system can be a local computing system or the gateway output device 146.

The database 484 can comprise data written into the memory 456 for the gateway 450 (e.g., the operating system 480 and/or the application 481 to perform the aforementioned functions). The database 484 can comprise data written into the memory 456 based on functions performed by the gateway 450.

As an example, the database 484 can include setup data 486. The setup data 486 can include pairing information for one or more devices wirelessly connected to the gateway 450, such as a wireless sensor or a wireless client. The setup data 486 can include unique identifiers for each sensor connected to the gateway 450 wirelessly or connected to particular inputs of the sensor I/O 462 so that the gateway can determine which received sensor data corresponds to a connected sensor. The setup data 486 can include address information for communicating with a server, such as the server 400. The setup data 486 can include one or more time thresholds for comparison to an amount of time a door has been open or an amount of time a door has been open without a caution barrier deployed. The setup data 486 can include time data indicating expected time interval when the door of a restricted room is to be opened (e.g., 6:00 AM to 10:00 PM) and/or a time interval when the door of a restricted room is not expected to be opened (e.g., 10:00 PM to 6:00 AM).

As another example, the database 484 can include status data 488. The status data 488 can include status data (i.e., state data) based on a status (i.e., a state) of a doorway and a caution barrier determined by the processor 452 based on signals from a sensor or the lack of a signal from a sensor. Table A shows example status data that can be contained in the memory 456. In accordance with at least some embodiments, a no signal state for the doorway and/or the caution barrier can result in the gateway 450 or a server outputting a notification indicating the no signal state. A client can present the notification on a display. The status data “deployed” can be referred to as “secured” or some other term, and the status data “not deployed” can be referred to as “unsecured” or some other term. The status data 484 can include any sensor data received by the gateway 450 from any sensor. The processor 452 can overwrite (e.g., delete status data) after the status data has been transmitted to the server 104, 400 and/or after the status data has been stored at the gateway 450 more than a threshold amount of time. A status of “No Signal” can be determined if a sensor is configured to send a signal periodically (e.g., as a heartbeat signal) and a computing system configured to monitor for receipt of the period signal does not receive the signal by an expected time. A status of “No Signal” can be determined if a sensor transmits a signal with data indicating the sensor is malfunctioning.

TABLE A

| Doorway | Caution Barrier |
|---|---|
| Open | Deployed |
| Open | Not Deployed |
| Open | No Signal |
| Closed | Deployed |
| Closed | Not Deployed |
| Closed | No Signal |
| No Signal | Deployed |
| No Signal | Not Deployed |
| No Signal | No Signal |

Additionally, the data based on sensor signals can include a time stamp when the signal was received from a wireless sensor. Alternatively, the data based on sensor signal can include a time stamp when a sensor signal received at the gateway 450 on a wire conductor was sampled at the gateway 450. The time stamp permits the processor 452 to determine other status data such as, a door has been open too long, a door is open at an unexpected time. Table B shows example status data that can be contained in the memory 456. As an example, lines 1, 2, 5, 6, 9, 10 include sensor data received in response to a state of the sensor changing, and lines 3, 4, 7, 8 include sensor data sent as heartbeat data to advise the gateway 450 the sensor is operational. In this example, the heartbeat signals are sent every 15 minutes, but could be sent more frequently or less frequently.

TABLE B

| Sensor | Sensor Data | Time and Date | Line |
|---|---|---|---|
| Door | Closed | 09:01:04, Mar. 18, 2025 | 1 |
| Barrier | Not Deployed | 09:01:05, Mar. 18, 2025 | 2 |
| Door | Closed | 09:30:00, Mar. 18, 2025 | 3 |
| Barrier | Not Deployed | 09:30:00, Mar. 18, 2025 | 4 |
| Door | Open | 09:46:17, Mar. 18, 2025 | 5 |
| Barrier | Deployed | 09:49:12, Mar. 18, 2025 | 6 |
| Door | Open | 10:00:00, Mar. 18, 2025 | 7 |
| Barrier | Deployed | 10:00:00, Mar. 18, 2025 | 8 |
| Barrier | Not Deployed | 10:02:48, Mar. 18, 2025 | 9 |
| Door | Closed | 10:02:57, Mar. 18, 2025 | 10 |

Yet another example, the database 484 can include alerts 490. The processor 452 can transmit an alert to a local computing system, such as the computing system 500 shown in FIG. 13. The processor 452 can use the transceiver 454 to transmit the alert. As an example, the alerts 490 can include a textual, graphical, and/or audible alert. For example, an alert of the alerts 490 can indicate a door is open too long, a door is open during the wrong (i.e., unexpected) time frame, a door is open and a belt is unsecured too long, a door is open and an automated gate is unsecured too long, or at the door alert with interactive display activation. As another example, an alert of the alerts 490 can indicate whether a tagged piece of equipment is approved for entry into a restricted room. Other examples of an alert are possible.

The database 484 can include instructional content 492. The examples regarding the instructional content 448 are applicable to the instructional content 492. Other examples of the instructional content 492 are also possible.

The database 484 can include equipment identifier 494 (i.e., one or more equipment identifiers). The equipment identifier 494 can indicate whether a piece of equipment corresponding to the equipment identifier is approved or not approved for entry into a restricted room. The processor 452 can receive equipment identifiers from tagged equipment, and compare the received equipment identifier to the equipment identifier 494 to determine whether the tagged equipment is approved or not approved for entry into a nearby restricted room. The processor 452 can output an alert from the alerts 490 if the tagged equipment is not approved for entry in the restricted room. Additionally, the processor 452 can output an alert from the alerts 490 if the tagged equipment is approved for entry in the restricted room to notify a person handling the tagged equipment the tagged equipment has been checked against an equipment registry.

### C. Computing System

FIG. 13 is a block diagram of a computing system 500 in accordance with the example embodiments. Other computing systems described in this description can be arranged like the computing system 500 or like at least a portion of the computing system 500. For example, a remote client, such as the remote client 106, 108, 110, 112 or a local computing system, such as the local computing system 114, 116, 118, 120, 172, 222 can be arranged like the computing system 500 or at least a portion of the computing system 500. As another example, the local computing system 70 shown in FIG. 2 can be arranged like the computing system 500 or like at least a portion of the computing system 500. The computing system 500 can be referred to as a “remote client,” a “client,” a “local computing system,” or a “local computer.”

The computing system 500 can include a processor 502, a transceiver 504, a memory 506, a user interface 508, power circuitry 510, and/or a data bus 512. The data bus 512 operatively connects two or more of the processor 502, the transceiver 504, the memory 506, the user interface 508, or the power circuitry 510 to each other. The description of a processor, in general, discussed above with respect to the processor 402 is applicable to the processor 502. The description of a memory, in general, discussed above with respect to the memory 406 is applicable to the memory 506. The description about power circuitry, in general, discussed above with respect to the power circuitry 410 is applicable to the power circuitry 510. The computing system 500 can include and/or be arranged as an industrial-strength computing system or device (e.g., an industrial-strength computing system).

The description of a transceiver, in general, discussed above with respect to the transceiver 404 is applicable to the transceiver 504. In that regard, the transceiver 504 can, for example, include a first transceiver configured to communicate using a BLUETOOTH® standard, and a second transceiver configured to communicate using a cellular network communication standard, such as an LTE or 5G NR communication standard. As another example, the first transceiver can be configured as a decentralized wireless mesh transceiver for low power IoT and/or as a radio transceiver arranged in accordance with one or more wireless communication standards or protocols built on top of the IEEE 802.15.4 physical/MAC layers, such as the ZIGBEE® protocol or the WIREPAS® protocol. Other examples of the quantity and types of transceivers embodied within the transceiver 504 are also possible.

For an embodiment in which the computing system 500 operates as the local computing system 70 shown in FIG. 2, the transceiver 504 is configured to receive data (i.e., sensor data) from the sensor 68. In this and other embodiments, the computing system 500 is configured to store the sensor data in the memory 506, determine alerts based on the sensor data, and display the alerts on the display 518. The transceiver 504 can receive sensor data from more than one sensor, such as a door sensor and a barrier sensor, determine alerts and conditions based on the sensor data, and display the alerts on the display 518. The transceiver 504 can receive other data from the sensor 68, such as data (e.g., server data) the gateway 450 receives from the server 400 and then forwards to the sensor 68. As an example, the server data can include a configuration parameter for configuring the computing system 500 to operate differently. As an example, the server data can include a time threshold to compare to sensor data from a door sensor and data from a barrier sensor. As an example, the server data can include a language identifier (e.g., English or Spanish).

For an embodiment in which the computing system 500 operates as the local computing system 172 shown in FIG. 3, the transceiver 504 is configured to receive data transmitted thereto from a server, such as the server 400, from a gateway, such as the gateway 450, and/or a sensor. The sensor can comprise multiple sensors, such as a door sensor and a barrier sensor. As an example, the data transmitted to the transceiver 504 can include a GUI and/or data to populate the GUI. The data transmitted to the transceiver 504 can include a notification, status data, an alert or other information regarding a door of a restricted room and a caution barrier located in proximity to the door. Furthermore, the transceiver 504 can be configured to transmit data to a server, such as the server 400, and/or to a gateway, such as the gateway 450. As an example, the data transmitted by the transceiver 504 can include data to request a GUI and/or data to populate the GUI. The transceiver 504 can transmit and received data over the Internet.

The user interface 508 includes an input device 514, an output device 516, and a display 518. The description of an input device, in general, discussed above with respect to the input device 414 is applicable to the input device 514. The description of an output device, in general, discussed above with respect to the output device 416 is applicable to the output device 516. The description of a display, in general, discussed above with respect to the display 418 is applicable to the display 518. Additionally, the input device 514 can include an RFID receiver/reader to read RFID tags, such as an RFID tag on a patient wristband. Additionally, the input device 514 can include a camera to capture images, such as an image of a two-dimensional matrix code (e.g., a quick response (QR) code).

Any client or local computing system described in this description can be arranged like the computing system 500. For example, one or more of the remote client 106, 108, 110, 112 and/or one or more of the local computing system 114, 116, 118, 120, 172, 222 can be arranged like the computing system 500. Any client or local computing system described in this description can include and/or be arranged as a tablet computing device (such as an IPAD® tablet computer available from the Apple Inc. in Cupertino, California) or a touch pad computing device (such as a Healthcare Rugged Tablet Model M101P-ME available from Winmate USA in Smyrna, Georgia). Any local computing system or gateway output device described in this description can include and/or be arranged as a dynamic sign (such as a display device operatively connected to a gateway).

FIG. 13 also shows content that can be stored within the memory 506. For example, the memory 506 can include an operating system 522, an application 523, a module 524, a database 526, alerts 528 (i.e., notifications), and a GUI 530. The operating system 522 and/or the application 523 can include a clock for time stamping data. The database 526 can include the alerts 528 and/or the GUI 530.

The operating system 522 can include a smart phone operating system, such as an iPhone Operating System (iOS) available from Apple Inc. of Cupertino, California, or an Android operating system available from Google, LLC of Mountain View, California. Alternatively, the operating system 522 can include a desktop or laptop computer operating system, such as a Microsoft Windows operating system available from the Microsoft Corporation. Other examples of the operating system 522 are possible.

The application 523 can include one or more applications. The module 524 can include one or more modules. The application 523 can include a module of the module 524. A module of the module 524 can be separate from and called by the application 523. The application 523 and/or the module 524 are executable by the processor 502 to perform tasks (e.g., the functions described in this description as being performed by a computing system, such as the remote client 106, 108, 110, 112, or the local computing system 70, 114, 116, 118, 120, 172, 222). As an example, the application 523 can include a browser application for displaying a GUI, such as the GUI 530. The application 523 can be updated based on a software update pushed or otherwise provided to the computing system 500. The application 523 can be updated based on a software update pushed or otherwise provided to the computing system 500. Other examples of the application 523 are possible.

This paragraph describes functions (i.e., executable function of the computing system 500) that can be performed by executing the application 523 and/or the module 524. An executable function of the computing system 500 can include receiving signal data transmitted from one or more sensors, and storing the received signal data within the status data 534. An executable function of the computing system 500 can include pairing with a sensor (e.g., a wireless sensor), such as a door contact sensor, a sensor within an automated gate, or a sensor within a retractable belt (e.g., a sensor at the belt clip 558 or the wall receiver 560). An executable function of the computing system 500 can include monitoring for loss of communication from a sensor and outputting an alert via the output device 516. An executable function of the computing system 500 can include receiving data from the gateway 450 for configuring the computing system 500 to communicate with the gateway 450.

This paragraph describes additional functions that can be performed by executing the application 523 and/or the module 524. An executable function of the computing system 500 can include receiving signals sent by sensors having a decentralized wireless mesh transceiver for low power IoT. An executable function of the computing system 500 can include determining data carried by signals sent by sensors having a decentralized wireless mesh transceiver for low power IoT and storing the data in the memory 506 (e.g., within the status data 534). An executable function of the computing system 500 can include generating and storing a time-stamp within the status data 534 and corresponding to a sensor datum received from a sensor. An executable function of the computing system 500 can include determining a condition based on the stored sensor data (e.g., the status data 534). The alert condition can include a condition, such as a condition listed in Table C below.

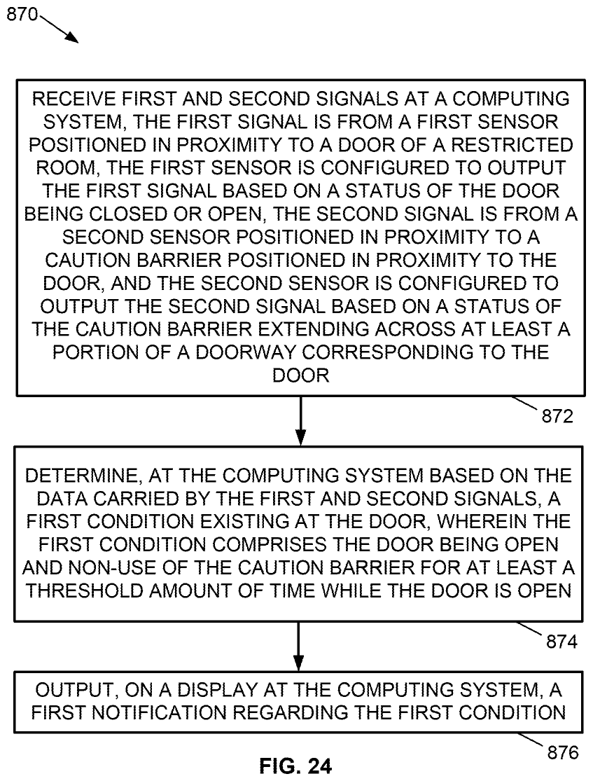

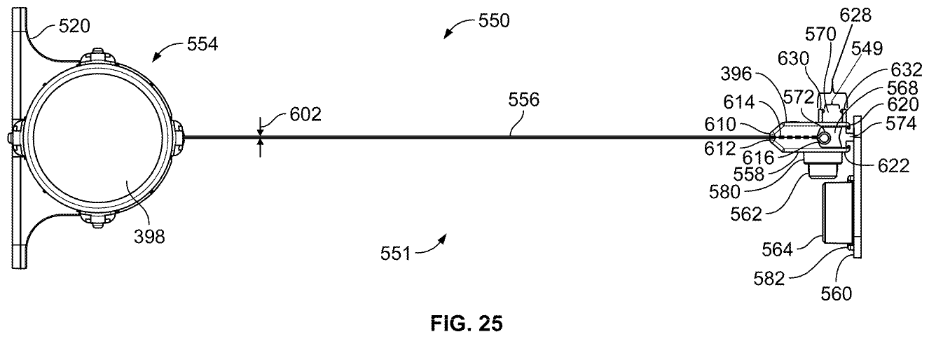

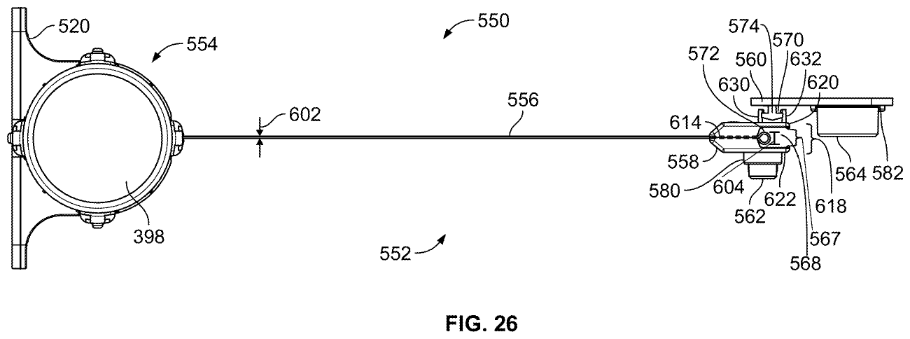

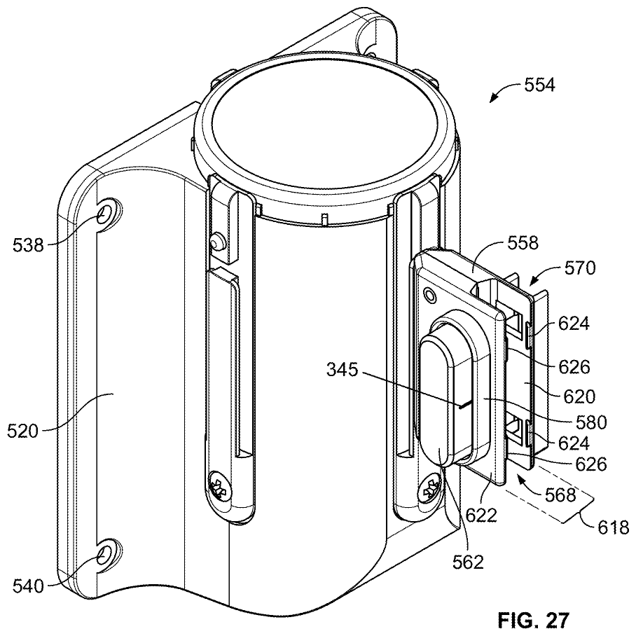

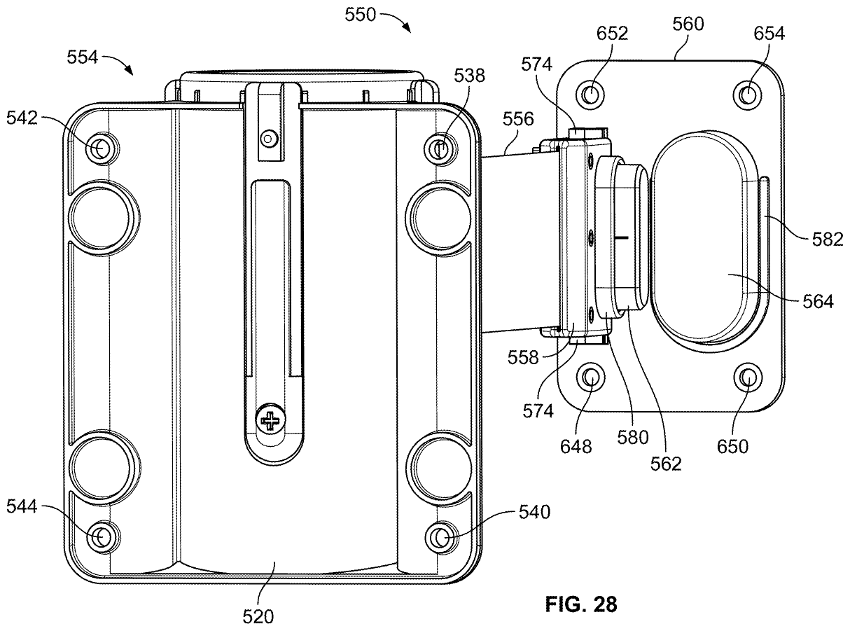

This paragraph describes even more functions that can be performed by executing the application 523 and/or the module 524. An executable function of the computing system 500 can include outputting a notification on the display 518. Outputting the notification can include outputting the notification within a GUI output on the display 518, such as the GUI 700 shown in FIG. 14, the GUI 787 shown in FIG. 19, the GUI 766 shown in FIG. 20, or the GUI 768 shown in FIG. 21. An executable function of the computing system 500 can include counting a number of conditions occurring during a particular time period, determining how long a condition has occurred, and comparing a length of time of a condition to a threshold to determine whether a different condition exists. An executable function of the computing system 500 can include determining a door to a restricted room was opened during at an unexpected time (e.g., on a day of the week or a time of the day when personnel authorized to work in the restricted room are not on duty), and outputting a notification regarding the unexpected door opening. An executable function of the computing system 500 can include performing any function within the set 870 of functions shown in FIG. 24 or any function described as an additional function with respect to the set 870 of functions.

The database 526 can include data written into the memory 506 for the computing system 500 (e.g., the operating system 522 and/or the application 523 to perform the functions performed by the computing system 500). The database 526 can include data written into the memory 506 based on functions performed by the computing system 500.

As an example, the database 526 can include setup data 532. The setup data 532 can include pairing information for one or more devices wirelessly connected to the computing system 500, such as a gateway or a sensor. The setup data 532 can include address information for communicating with a server, such as the server 400. The setup data 532 can include a preferred language selected by a user of the computing system 500.

The setup data 532 can include unique identifiers of different sensors. For example, the setup data 532 can include a first sensor identifier corresponding to a door sensor and a second sensor identifier corresponding to a barrier sensor. The processor 502 can use the first sensor identifier to determine that a signal including the first sensor identifier is from the door sensor, and use the second sensor identifier to determine that a signal including the second sensor identifier is from the barrier sensor.

As another example, the database 526 can include status data 534. The status data 534 can include sensor data received from a sensor, counter data from a counter, time stamps, and/or calculated data (e.g., a ratio or star rating determined by the processor 502). The status data 534 can be output on the display 518 via the application 523 and/or the GUI 530. As an example, the status data 534 can include countdown clock data (e.g., digital clock data) showing a door open time remaining before an alert is activated (e.g., the gateway 450 transmits an alert to the server 400). As another example, status data 534 can include an alert transmitted by the server 400 to the computing system 500 based on the countdown clock data expiring (e.g., reaching 0.0 seconds). As another example, the status data 534 can include status data regarding a door and caution barrier at one or more restricted rooms. Yet another example, the status data 534 can include any data of a GUI shown in FIG. 14 to FIG. 21 and/or the GUI 530.

As yet another example, the database 526 can include an equipment identifier 536 (i.e., one or more equipment identifiers). The equipment identifier 536 can indicate whether a piece of equipment corresponding to the equipment identifier is approved or not approved for entry into a restricted room. The processor 502 can receive an equipment identifier from tagged equipment, and compare the received equipment identifier to the equipment identifier 536 to determine whether the tagged equipment is approved for entry into a nearby restricted room. The processor 502 can output an alert from the alerts 528 if the tagged equipment is not approved for entry in the restricted room. Additionally, the processor 502 can output an alert from the alerts 528 if the tagged equipment is approved for entry in the restricted room to notify a person handling the tagged equipment the tagged equipment has been checked against an equipment registry.

The memory 506 can also include alerts 528. The alerts 528 can comprise textual alerts, graphical alerts, audio alerts and/or video alerts the output device 516 can output audibly and/or visually. The processor 502 can receive an instruction from the server 400 and/or the gateway 450 to output a particular audio alert to the output device 516. The audio alert can correspond to a particular status (i.e., condition) determined by the server 400 and/or the gateway 450. As an example, an alert can indicate a door status, a status of a countdown counter, or an alert indicating a piece of tagged equipment is in proximity to a sensor mounted in proximity to a restricted room. The output device 516 outputs an audible version of the audio alert. The processor 502 can be configured to output textual and audio alerts based on a preferred language indicated by the setup data 532. As another example, an alert of the alerts 528 can indicate whether a tagged piece of equipment is approved for entry into a restricted room. Other examples of an alert are possible.

For a condition in which a door (e.g., the door 202) is open and a caution barrier is not deployed, the processor 502 can output an audio alert, such as “secure entranceway, close the door or engage the caution barrier.” The processor 502 can repeat outputting that alert while the condition exists. As an example, the processor 502 can output that alert every 60 second or at some other interval of time.

For a condition in which the door, such as the door 202 is closed, the processor 502 can output an audio alert, such as “entranceway secured, door closed.” If the restricted room 200 includes an MRI scanner, the audio alert could indicate “MRI entranceway secured, door closed.” For a condition in which the door, such as the door 202 is closed, the processor 502 can output an audio alert, such as “entranceway secured, door closed.” If the room 200 includes an MRI scanner, the audio alert could indicate “MRI entranceway secured, door closed.”

For a condition in which the door, such as the door 202 is closed, the processor 502 can output an audio alert, such as “entranceway secured, door closed.” If the restricted room 200 includes an MRI scanner, the audio alert could indicate “MRI entranceway secured, door closed.”

For a condition in which a caution barrier including a belt is deployed, the processor 502 can output an audio alert, such as “entranceway secured, smart belt engaged.” If the restricted room 200 includes an MRI scanner, the audio alert could indicate “MRI entranceway secured, smart belt engaged.” As indicated by those examples, a caution barrier including a belt and/or the belt of such caution barrier can be referred to as a “smart belt.”

For a condition in which a caution barrier arranged as room access control system (i.e., an automated gate is deployed, the processor 502 can output an audio alert, such as “entranceway secured, TechGate engaged.” If the restricted room 200 includes an MRI scanner, the audio alert could indicate “MRI entranceway secured, TechGate engaged.”

For a condition in which the door, such as the door 202 is open and no caution barrier is deployed for a threshold amount of time, the processor 502 can output an audio alert, such as “unsecured entranceway alert transmitted.” If the restricted room 200 includes an MRI scanner, the audio alert could indicate “unsecured MRI entranceway alert transmitted.” Outputting those alerts can coincide with or occur shortly after transmitting the alert as indicated by the audio alert.

For a condition in which the door, such as the door 202, goes from being closed to being open and the restricted room 200 includes an MRI scanner, the processor 502 can output an audio alert, such as “caution, extremely strong magnetic field within the room.” For conditions in which other potentially dangerous conditions exist based on equipment within the room, the processor 502 can output an audio alert warning of the existence of such equipment.

The memory 506 can also include a GUI 530 (e.g., one or more GUIs). The GUI 530 can be output on the display 518 via the application 523. The GUI 530 can include the GUI 700 shown in FIG. 14, the GUI 730 shown in FIG. 15 to FIG. 17, the GUI 770 shown in FIG. 18, the GUI 787 shown in FIG. 19, the GUI 766 shown in FIG. 20, the GUI 768 shown in FIG. 21, and/or the GUI 260 shown in FIG. 38. In that regard, one or more or all the GUI 260, 700, 730, 766, 768, 770, 787 can be separate views of the GUI 530. The GUI 530 can include data received from the server 400 and/or the gateway 450. The processor 502 can be configured to render a GUI, including rasterizing and compositing elements of the GUI to generate pixel values to store in a frame buffer before being used to show the GUI on a display. The processor 502 can be configured to populate such data into the GUI 530 when output on the display 518.

The GUI 530 can include one or more GUIs that form a web-based dashboard configured to display data on the display 418 as well as to allow data entry, such as electronic patient pre-screening forms, electronic patient history safety checks, ferromagnetic item screening and detection as part of the patient screening process, MRI safe and MRI unsafe asset tracking and physical location monitoring and active MRI imaging procedures/sequences. The data entry can occur via drop-down menus, text fields, RFID readers, cameras, and/or user-selectable controls displayed with the GUI or embodied with the input device 514 (e.g., a button or switch).

Some other examples of content displayable on a GUI shown on the display 518 include a digital countdown close showing a door open time remaining before alerts are activated. The GUI 530 can include visual hazard warnings, such as “High Magnetic Field,” “No Metal Allowed,” or “Do Not Enter.” A GUI can include a visual status of a door (e.g., “Door Open-Unsecured”) and/or a caution barrier (e.g., “Caution Barrier not in use-Unsecured”). A GUI can include statistics based on aggregating data from multiple gateways, such as an average open-door time computed for data from gateways monitoring doors of restricted rooms across a particular enterprise or across a particular geographic area (e.g., a particular state or country). Other examples of content displayable on a GUI shown on the display 518 are also possible.

### D. Apparatus Configured for Use as a Barrier

Next, FIG. 25 to FIG. 34 depict a barrier 550 (i.e., an apparatus configured for use as a barrier). As an example, the barrier 550 can be installed at a doorway of a restricted room. For instance, the barrier 550 can be installed at a doorway of the restricted room 200 in place of the caution barrier 224 shown in FIG. 5, FIG. 6, and FIG. 7. In this regard, the barrier 550 can be configured for use as a caution barrier.

FIG. 25 is a first top view 551 of the barrier 550. The barrier 550 includes a belt retractor 554, a belt 556, a belt clip 558, and a wall receiver 560. The belt clip 558 can be arranged as a clip assembly having a clip half 610 (i.e., a first clip half or first clip) and a clip half 612 (i.e., a second clip half or second clip). Alternatively, the belt clip 558 can be arranged as a unitary, one-piece clip. An advantage of using a unitary belt clip over a multi-piece belt clip is that the belt 556 can be attached without placing holes into the belt and without the need to attach the first and second clip halves using fasteners. An advantage of using a multi-piece belt clip with fasteners is that a force applied to the belt 556 can be distributed to portions of the first and second clip halves via the fasteners as compared to just a slot wall 616 of the belt clip 558. The belt clip 558 can include a slot 614 in which a portion of the belt 556 is disposed.

For embodiments in which the belt clip 558 is arranged as a clip assembly including the clip half 610 and the clip half 612, the belt clip 558 can include any aspect described as being a part of and/or an aspect of the clip half 610, and/or can include any aspect described as being a part of and/or an aspect of the clip half 612.

The belt 556 can be referred to a “webbing.” The belt 556 is made of a material, such as polyester, nylon, or polypropylene. Other examples of the material are possible. The belt 556 has a thickness 602 and a length. The thickness 602 can be uniform across an entire length of the belt 556. A portion of belt 556 can be formed with a loop 572.

The belt clip 558 can include one or more pairs of arms. Each pair of arms can form a slot in which a latch 574 of the wall receiver 560 can be disposed for attaching the belt clip 558 to the wall receiver 560. The use of multiple pairs of arms allows for multiple orientations for use with different wall configurations while maintaining a proximity range for the sensor components on belt clip 558 and the wall receiver 560.

As an example, the belt clip 558 can include a pair of arms 618 (identified in FIG. 26) arranged at a distal end of the belt clip 558 relative to the belt retractor 554. The pair of arms 618 includes an arm 620 (i.e., a first arm) and an arm 622 (i.e., a second arm). The pair of arms 618 forms a slot 568. In other words, a slot 568 exists between the arm 620 and the arm 622.

As another example, the belt clip 558 can include a pair of arms 628 extending from and transverse to a surface 396 of the clip half 610. The pair of arms 628 includes an arm 630 (i.e., a first arm) and an arm 632 (i.e., a second arm). The pair of arms 628 forms a slot 570. In other words, a slot 570 exists between the arm 630 and the arm 632. The arm 630 includes a flange 634 identified in FIG. 32 and the arm 632 includes a flange 636. The flange 634 and the flange 636 form (i.e., provide for) a flange-to-flange gap 549. The flange-to-flange gap 549 can be decreased by increasing a width of the flange 634 and/or a width of the flange 636. The flange-to-flange gap 549 can be increased by decreasing a width of the flange 634 and/or a width of the flange 636. As shown in FIG. 32, the arm 630 can include multiple instances of both the flange 634 and the flange 636.

The belt clip 558 and the clip half 612 include a flange 580 (i.e., a sensor flange) and a sensor component 562. The wall receiver 560 includes a flange 582 (i.e., a sensor flange) and a sensor component 564. The examples corresponding to the sensor component 218, 220 are applicable to the sensor component 562, 564.

The belt retractor 554 includes a flange 520 for supporting the belt retractor 554 against a support object. For example, the support object can include a wall or other structural element at or near a restricted room. The belt retractor 554 includes a housing 398 to protect and support belt retraction components within the belt retractor. As an example, the belt retraction components can include a spool with a shaft, one or more springs, a gear set, a pawl, among other components. As another example, the belt retraction components can comprise one or more of the components within a wall unit available from Tensator Inc. of Bay Shore, New York, such as a wall unit referred to as 897 Standard, 899 Max, or 897 Plus.

FIG. 26 is a second top view 552 of the barrier 550. In this view, the belt clip 558 is attached to the wall receiver 560 using the pair of arms 628 instead of the pair of arms 618 as shown in FIG. 25. In other words, FIG. 26 shows the latch 574 within the slot 570 positioned between the arm 630 and the arm 632. In that regard, ends of the latch 574 can contact pair of arms 618 to keep the latch 574 from moving within the slot 570 until a further force is applied to the belt clip 558.

The loop 572 can have a width 604 that is greater than the thickness 602. The loop 572 can have a circular cross-section or a cross-section with a different shape. The loop 572 can be wider than the slot 614. The loop 572 can be formed by folding a portion of the belt 556 onto another portion of the belt 556 and attaching the two portions of the belt together. As an example, the two portions of the belt 556 can be attached to each other via stitching, snaps, or by crimping a band contacting each of the two portions of the belt 556.

The flange 624 of the clip-half 610 shown in FIG. 32 and the flange 626 of the clip-half 612 shown in FIG. 33, both of pair of arms 618 form (i.e., provide for) a flange-to-flange gap 567. The flange-to-flange gap 567 can be decreased by increasing a width of the flange 624 and/or a width of the flange 626. The flange-to-flange gap 567 can be increased by decreasing a width of the flange 624 and/or a width of the flange 626. As shown in FIG. 32, the arm 620 can include multiple instances of the flange 624. Similar, as shown in FIG. 33, the arm 622 can include multiple instances of the flange 626.

Since the pair of arms 618 and the pair of arms 628 can be used with the latch 574 to attach belt clip 558 to the wall receiver 560, a width of the slot 568 and a width of the slot 570 can have identical dimensions (or substantially identical dimensions (e.g., ±0.25 inches or ±6.35 millimeters). Similarly, a dimension of the flange-to-flange gap 549 and a dimension of the flange-to-flange gap 567 can be identical (or substantially identical (e.g., ±0.25 inches or ±6.35 millimeters).

FIG. 27 is a perspective view of the belt retractor 554 and the belt clip 558. The belt 556 is retracted within the belt retractor 554. While the belt 556 is retracted within the belt retractor 554, the belt clip 558 can contact the belt retractor 554. A width of the belt clip 558 prevents the belt clip from entering the belt retractor 554. The belt retractor 554 can include a through-hole 538, 540 with the flange 520. The through-hole 538, 540 is arranged to receive a respective fastener for attaching the belt retractor 554 to a wall or other structural element at or near a restricted room. FIG. 27 shows additional views of pair of arms 618 (i.e., the arm 620, the arm 622), the slot 568, the slot 570, the flange 624, the flange 626, and an orientation tab 345.

The flange 624 can comprise a single, continuous flange or multiple non-continuous flanges (as shown in FIG. 27). Likewise, the flange 626 can comprise a single, continuous flange or multiple non-continuous flanges (as shown in FIG. 27). The flange 624 extends inward towards the arm 622. The flange 626 extends inwards towards the arm 620. The pair of arms 618 forms a slot 568.

FIG. 28 is a perspective view of the barrier 550 that shows portions of the belt retractor 554, the belt 556, and the belt clip 558, and the wall receiver 560. As shown in FIG. 28, the flange 520 includes the through-hole 538, 540 and a through-hole 542, 544. Similarly, the wall receiver 560 includes a through-hole 648, 650, 652, 654. FIG. 28 shows additional views of the flange 580, 582, the sensor component 562, 564, the belt clip 558, and the latch 574.

FIG. 29 is another perspective view of the barrier 550. FIG. 29 shows a height 606 of the belt 556 and a slot 608 within the belt retractor 554. The height 606 of the belt 556 can be uniform across an entire length of the belt 556. Portions of the belt 556 can pass through the slot 608 as the belt 556 is retracted and while the belt 556 is pulled so that the belt clip 558 extends away from the belt retractor 554. FIG. 29 shows additional views of the through-hole 542, 544 and the flange 520, as well as a fastener 590, 592, 600 installed into the belt clip 558. The loop 572 (shown in FIG. 25) can be wider than the slot 608.

FIG. 29 also shows further details of the wall receiver 560, such as a back surface 646 (i.e., a back side), a shut-off 586, 588, a through-hole 648, 650, 652, 654 for receiving a respective fastener for attaching the wall receiver 560 to a wall, and a though-hole 587, 589. The wall receiver 560 can include a number of through-holes less than or greater than four through-holes. The though-hole 587, 589 can be configured for placement of a respective fastener (e.g., a screw) for attaching the sensor component 564 to the wall receiver 560.

The back surface 646 can be flat so that a greater portion of the back surface 646 contacts a flat wall when the wall receiver 560 is attached to the flat wall. Alternatively, the back surface 646 can be non-flat to accommodate attachment of the wall receiver 560 to a non-flat wall. As an example, a flange can extend away from and transverse to the back surface 646, and the flange can be positioned within a slot or hole within a wall to keep the wall receiver 565 from shifting when bumped. The shut-off 586, 588 can result from an injection molding tool (e.g., B plate) used to form the latch 574 in cooperation with another injection molding tool (e.g., an A plate).

FIG. 30 is a perspective view of the belt 556, the clip half 610, and the clip half 612. The clip half 610 includes an outer surface 638 and the pair of arms 628 extending from and transverse to the outer surface 638. The pair of arms 628 includes an arm 630 (i.e., a first arm) and an arm 632 (i.e., a second arm). The arm 630 includes a flange 634 and the arm 632 includes a flange 636. The flange 634 can comprise a single, continuous flange or multiple non-continuous flanges (as shown in FIG. 30). Likewise, the flange 636 can comprise a single, continuous flange or multiple non-continuous flanges (as shown in FIG. 30). The flange 634 extends inward towards the arm 632. The flange 636 extends inwards towards the arm 630. The pair of arms 628 form the slot 570. The clip half 610 includes a through-hole 691, 693, 695 for receiving a fastener 590, 592, 600. The flange 634 and the flange 636 can operate as a snap and thus can be referred to as a “snap.”

The belt 556 can include a through-hole 844, 846, 848 arranged for alignment with the through-hole 691, 693, 695, respectively, and for the fastener 590, 592, 600, respectively, to pass through. In accordance with at least some embodiments, the belt 556 can include a ring 850, 852, 854, such as a metal or composite ring, surrounding the through-hole 844, 846, 848, respectively. The ring 850, 852, 854 can reduce or prevent wear on the belt 556 from the fastener 590, 592, 600.

The clip half 612 can include a boss 686, 688, 690 and a threaded insert 674, 676, 678 positioned within the boss 686, 688, 690, respectively. As an example, the threaded insert 674, 676, 678 can comprise a brass threaded insert. The fastener 590, 592, 600 and the threaded insert 674, 676, 678 can keep the clip half 610 and the clip half 612 attached to one another. The fastener 590, 592, 600 can be removed from the threaded insert 674, 676, 678 to allow the clip half 610 and the clip half 612 to be separated from one another. The fastener 590, 592, 600 can comprise a M3×10 raised csk posidrive fastener or some other type of threader fastener that can be positioned into the threaded insert 674, 676, 678. The threaded insert 674, 676, 678 can be positioned to be in alignment with the through-hole 844, 846, 848.

A fastener 578 can be used to attach (i.e., retain) the sensor component 562 to the belt clip 558 and the clip half 612. A fastener can be selected based on whether the sensor component includes a battery that needs to be replaced occasionally. If the sensor component includes a battery, a fastener that allows for secure attachment, but easy to clean or remove at the time the battery is replaced if necessary. If the sensor component does not include a battery, a fastener that provides for relatively more secure attachment can be used. As an example, the fastener 578 can comprise an adhesive, such as a piece of double-sided adhesive tape, such as a 0.375-inch-wide piece of foam tape having adhesive on two sides of the foam tape. The double-sided adhesive tape can include a base 569, and a first adhesive layer 571 and a second adhesive layer 573 (shown in FIG. 31), both on opposing sides of the base 569. As another example, the fastener 578 can comprise a glue, a putty, an epoxy, a cement, or some other adhesive. Yet another example, the fastener 578 can comprise a hook and loop fastener, such as a VELCRO® Brand hook and loop fastener. Other examples of the fastener 578 are also possible.

The clip half 612 includes a wall 810, 812, 814, 816 extending away from and transverse to an inner surface 818 of clip half 612. A surface 820, 822, 824, 826 of the wall 810, 812, 814, 816, respectively can be a surface that contacts the belt 556 to keep the belt 556 from sliding out of the belt clip 558. A surface of a wall can be referred to as a wall edge.

FIG. 31 is another perspective view of the belt 556, the clip half 610, and the clip half 612. FIG. 31 shows a further view of the flange 580. The flange 580 extends away from and transverse to a surface 640 of the belt clip 558. The flange 580 can be continuous to surround at least a portion of a sensor component 562. For example, the flange 580 can be arranged to have an oval shape with straight sides. As another example, the flange 580 can be arranged to have a U-shape. In accordance with at least some embodiments, a cross-section of the flange 580 can have a shape similar to a shape of a cross-section of the sensor component 562. The flange 580 includes an inner surface 642 and an outer surface 644. A portion of the sensor component 562 can contact the inner surface 642 when attached to the clip half 612 via the fastener 578. The sensor component 562 can include a cover of sensing components (e.g., a magnet or a switch). The cover can envelope the sensing components to prevent the sensing components of the sensor component 562 from being knocked or pulled off the clip half 612.

The clip half 610 can include a boss 680, 682, 684 having a through-hole 691, 693, 695, respectively. The fastener 590, 592, 600 can be inserted into the boss 680, 682, 684, though the belt 556, and into the threaded insert 674, 676, 678 within a through-hole 668, 670, 672 in the clip half 612.

The clip half 612 can include and/or have a sensor component 562 attached thereto. The sensor component 562 can contact at least a portion of the inner surface 642 so that the flange 580 provides a force to support the sensor component 562.

The clip half 610 includes a wall 758, 760, 762, 764 extending away from and transverse to an inner surface 830 of clip half 610. A surface 832, 834, 836, 838 of the wall 758, 760, 762, 764, respectively can be a surface that contacts the belt 556 to keep the belt 556 from sliding out of the belt clip 558.

FIG. 32 shows various views of the clip half 610 including a top view 290, a front view 291, a bottom view 292, a left side view 293, a right-side view 294, and a back view 295. The clip half 610 includes the pair of arms 628 (i.e., the arm 630 and the arm 632) extending from the outer surface 638.

FIG. 32 shows additional views of the slot 570, the flange 624 of the arm 620. FIG. 32 also shows a wall portion 617 that forms a portion of the slot wall 616. FIG. 32 also shows the boss 680, 682, 684, and the through-hole 691, 693, 695. Further, FIG. 32 shows a shut-off 596, 598 within the clip half 610. The shut-off 596, 598 can result from an injection molding tool (e.g., B plate) used to form the flange 634, 636 in cooperation with another injection molding tool (e.g., an A plate).

As shown in the back view 295, the clip half 610 includes a wall 890, 894, 898 having a wall edge 892, 896, 900, respectively. The flange 624 (two of which are shown in FIG. 32) includes a width 886 (i.e., a width of the flange 624), and a length 902 (i.e., a length of the flange 624). The width 886 can be selected based on a width 390 of a tip under-surface 384 of the latch 574 shown in FIG. 34. A wall edge can be referred to a surface of a wall.

As shown in the top view 290, the flange 624 extends away from the arm 620 and towards a plane 904 including the wall edge 892. A distance 888 from the plane 904 to a distal end 906 of the flange 624 (i.e., an end of the flange 624) is part of the flange-to-flange gap 567 shown in FIG. 26. Keeping other dimensions of the clip half 610 fixed but increasing the width 886 of the flange 624 decreases the distance 888, which can lead to a shorter flange-to-flange gap 567.

The top view 290 and/or the front view 291 also show a width 882 of the flange 634 and a width 884 of the flange 636, and a flange-to-flange gap 880 extending between a distal end 629 of the flange 634 and a distal end 631 of the flange 636. The width 882, 884 can be selected based on a width 390, 392 of the tip under-surface 384, 385 shown in FIG. 34.

FIG. 33 shows various views of the clip half 612 including a top view 280, a front view 281, a bottom view 282, a left side view 283, a right-side view 284, and a back view 285. The clip half 612 includes the flange 580 and the inner surface 642 and the outer surface 644 of the flange 580. The flange 580 can be referred to as a belt clip flange. FIG. 33 shows additional views of the flange 626 of the arm 622. Two instances of the flange 626 are shown. The flange 626 has a width 605 and a length 613.

FIG. 33 also shows a wall portion 619 that forms a portion of the slot wall 616. The wall portion 619 is part of the wall 810 shown in FIG. 30. The wall 810 has a surface 820. FIG. 33 also shows the boss 686, 688, 690, and the through-hole 692, 694, 696, the wall 812, 814, 816, the surface 820, 822, 824, 826.

As shown in the top view 280, the flange 626 extends away from the arm 622 and towards a plane 601 including the surface 822. A distance 603 from the plane 601 to a distal end 615 of the flange 626 (i.e., an end of the flange 626) is part of the flange-to-flange gap 567 shown in FIG. 26. Keeping other dimensions of the clip half 612 fixed but increasing the width 605 of the flange 626 decreases the distance 603, which can lead to a shorter flange-to-flange gap 567.

FIG. 34 shows various views of the wall receiver 560 including a top view 270, a front view 271, a side view 272, and perspective view 273. Those views show the latch 574, the flange 582, the sensor component 564, a fastener 576, and the through-hole 648, 650, 652, 654. Additionally, FIG. 34 shows a top surface 658 (i.e., a top), a side surface 660, 662 (e.g., a left and right side), a bottom surface 664 (i.e., a bottom), and a front surface 656 (i.e., a front). The wall receiver 560 can be made from a plastic material via a molding process such as injection molding, compression molding or blow molding. Other examples of the material or process used to make the wall receiver 560 are also possible.

The flange 582 extends away from and transverse to the front surface 656. The flange 582 can be continuous to surround (e.g., envelope) at least a portion of a sensor component 564. For example, the flange 582 can be arranged to have an oval shape with straight sides. As another example, the flange 582 can be arranged to have a U-shape. A bottom portion of the U-shape is closer to the bottom surface 664 than to the top surface 658. A top portion of the flange 582 can be open to allow the sensor component 564 to be slid upward and removed from the wall receiver 560. Removal of the sensor component 564 allows for replacing a battery within the sensor component 564. After the battery replacement, the sensor component 564 can be slid back onto the wall receiver 560 within the flange 582. The flange 582 includes an inner surface 584 and an outer surface 585. A portion of the sensor component 564 can contact the inner surface 584 when attached to the wall receiver 560. Enveloping of the sensor component 564 can prevent the sensor component 564 from being knocked or pulled off the wall receiver 560.

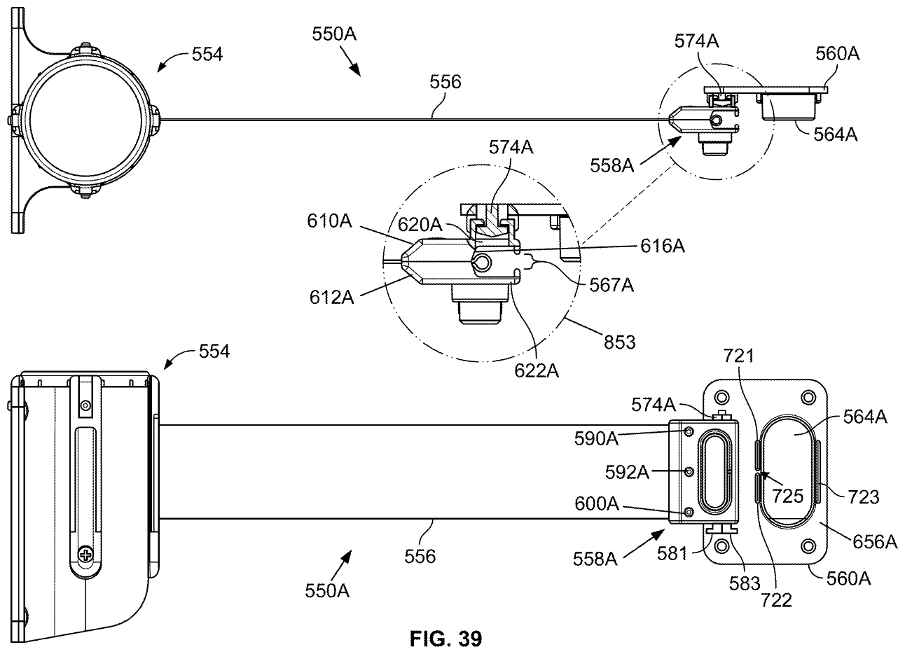

In accordance with some embodiments, a sensor component (e.g., the sensor component 564 or a sensor component 564A shown in FIG. 39) can include an orientation tab 347 for orientating the sensor component to a receiver (e.g., the wall receiver 560 or a wall receiver 560A shown in FIG. 39).

The fastener 576 can be used to attach (i.e., retain) the sensor component 564 to the wall receiver 560. The example fasteners described herein with respect to the fastener 578 are applicable to the fastener 576. Other examples of the fastener 576 are also possible.

The latch 574 includes a stem 380, a latch tip 382, a tip under-surface 384, 385, and a tip edge 386, 388. A width of the stem 380 can be selected based on various factors, such as the material used to make the wall receiver 560, forces expected to be applied by and to the tip under-surface 384, 385, and/or a width of the slot 570 of the belt clip 568. A width 390 of the tip under-surface 384 (i.e., a distance from the stem 380 to the tip edge 388), and a width 392 of the tip under-surface 385 (i.e., a distance from the stem 380 to the tip edge 386) can be selected based on various factors, such as the factors listed above, as well as a flange-to-flange gap 880 and a width 882, 884 of the flange 634, 636, respectively.

A distal end of the latch 574 relative to the front surface 656 can be formed (e.g., molded) to be angled (i.e., have side angles 840, 842). Forming the wall receiver 560 with the side angles 840, 842 can assist when separating the plates of an injection molding tool. The latch 574 on the wall receiver 560 could be arranged like the latch 574A having flanges 581, 583 as shown in FIG. 39.

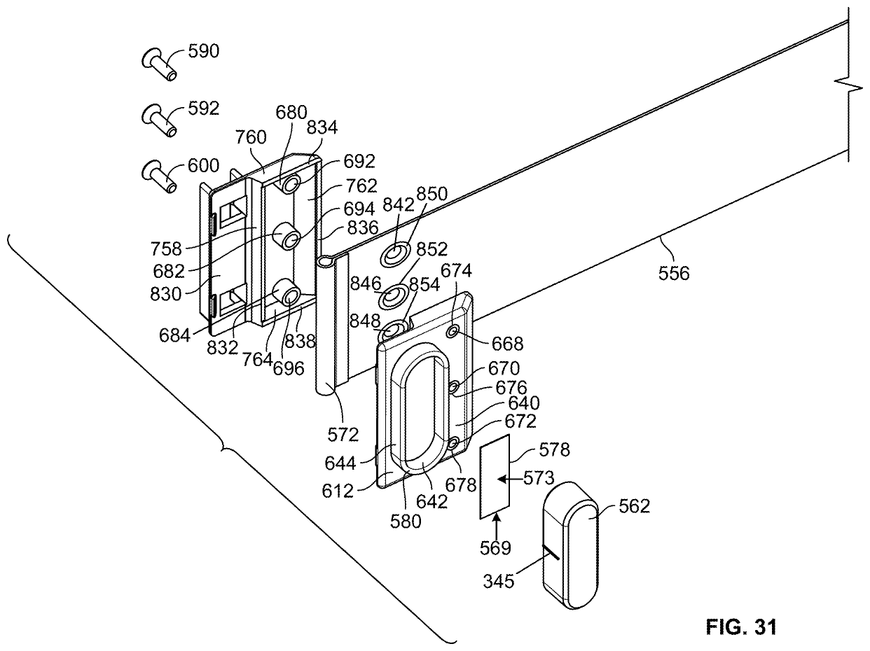

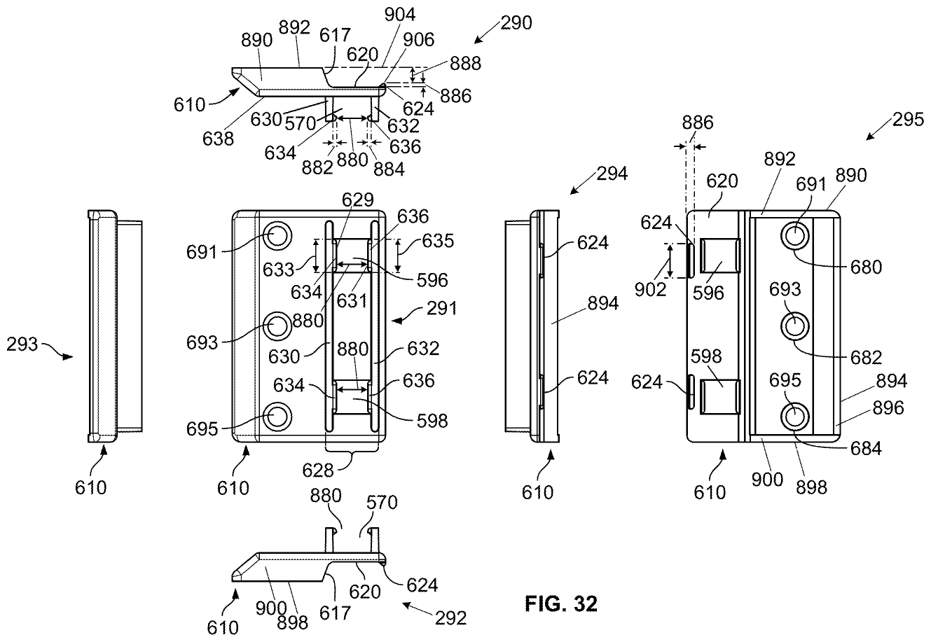

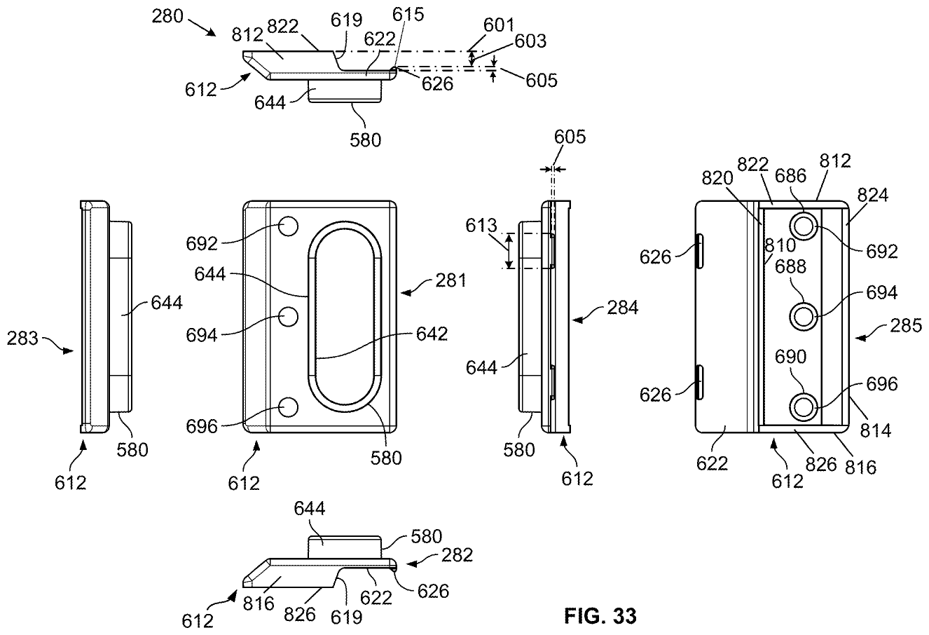

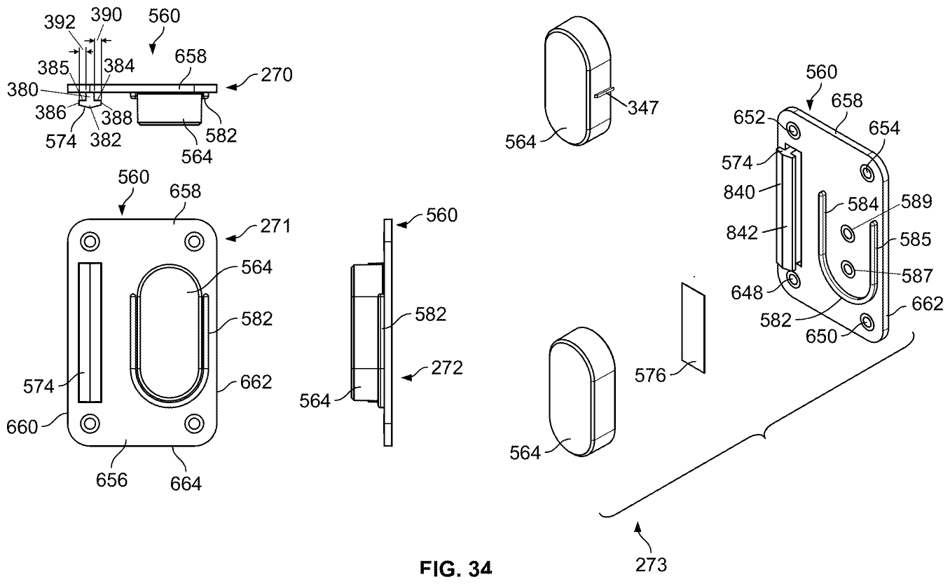

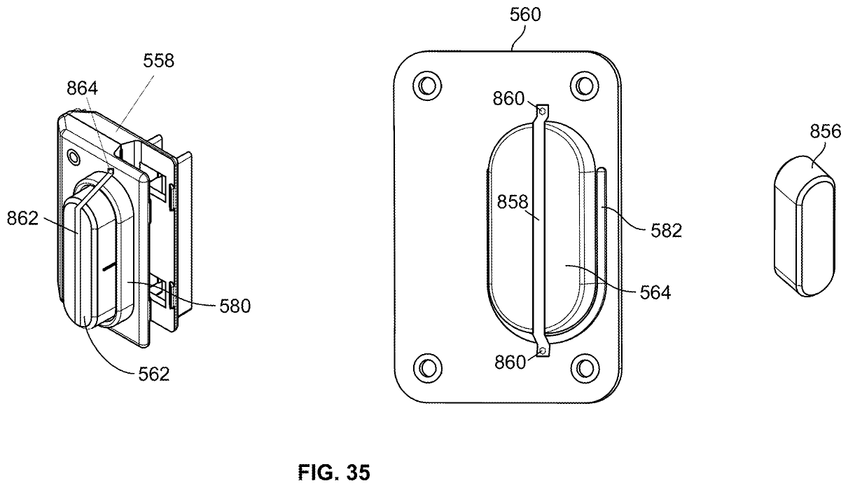

FIG. 35 shows examples of straps that can be used on the wall receiver 560 and belt clip 558 to restrain a sensor component thereto. As an example, a strap 858 can be positioned over the sensor component 564 and attached to the wall receiver 560 using a fastener 860, such as a screw or bolt. Some of the components of the wall receiver 560 are not shown in FIG. 35. As another example, a strap 862 can be positioned over the sensor component 562 and attached to the belt clip 558 using a fastener 864, such as a screw or bolt.

FIG. 35 shows supplemental restraints for restraining a sensor component, in accordance with one or more of the example embodiments. The supplemental restraints can include a strap, such as a strap 862 to restrain the sensor component 562 to the belt clip 558. The strap 862 can be removably attached to the belt clip 558 using fasteners, such as a fastener 864 near a top end of the belt clip 558 and a like fastener near a bottom end of the belt clip 558. In an alternative arrangement, the strap 862 can extend transversely across the sensor component 562 instead of longitudinally as shown.

As another example, the supplemental restraint can comprise a strap 858 to restrain the sensor component 564 to the wall receiver 560 (shown without the latch 574 and without the belt clip 558 attached thereto). The strap 858 can be removably attached to the wall receiver 560 using fasteners, such as a fastener 860. In an alternative arrangement, the strap 858 can extend transversely across the sensor component 564 instead of longitudinally as shown.

As another example, the supplemental restraint can comprise a cover, such as a snap-on cover 856 arranged to be snapped onto a flange. For example, the snap-on cover 856 can be snapped onto the flange 580 to further reduce the likelihood of the sensor component 562 being knocked off the belt clip 558. As another example, the snap-on cover 856 can be snapped onto the flange 582 to further reduce the likelihood of the sensor component 564 being knocked off the wall receiver 560.

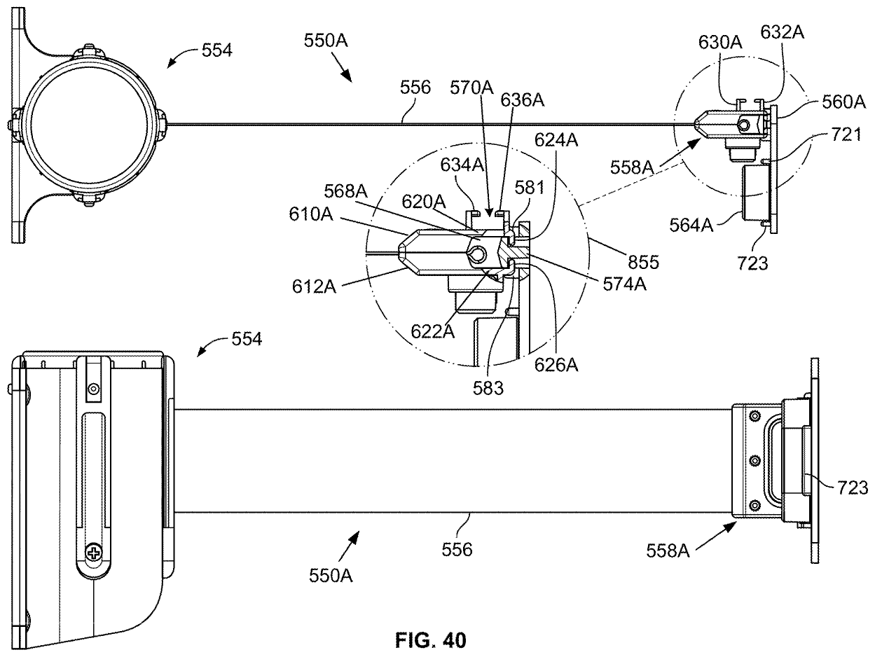

Any embodiment described herein as using and/or including the barrier 550 can alternatively use and/or include a barrier 550A shown in FIG. 39 and FIG. 40 instead of the barrier 550. The barrier 550A includes components described with respect to reference numbers having a suffix “A.” The barrier 550 includes corresponding components using the same reference number without any suffix. The barrier 550 and the barrier 550a also include identical components having identical reference numbers. The components of the barrier 550 and the barrier 550A having a common numerical refence number or numerical portion of a reference number operate in a similar manner.

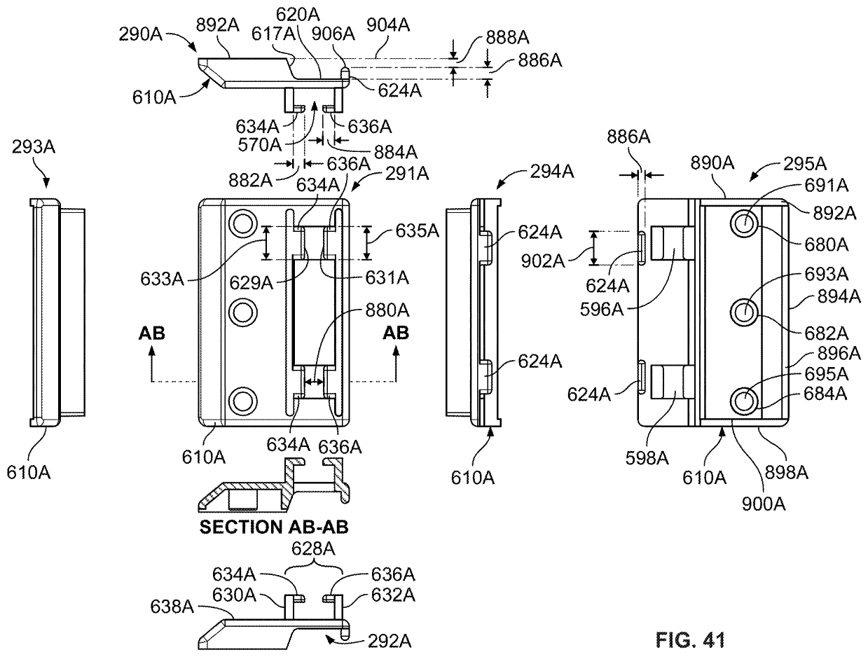

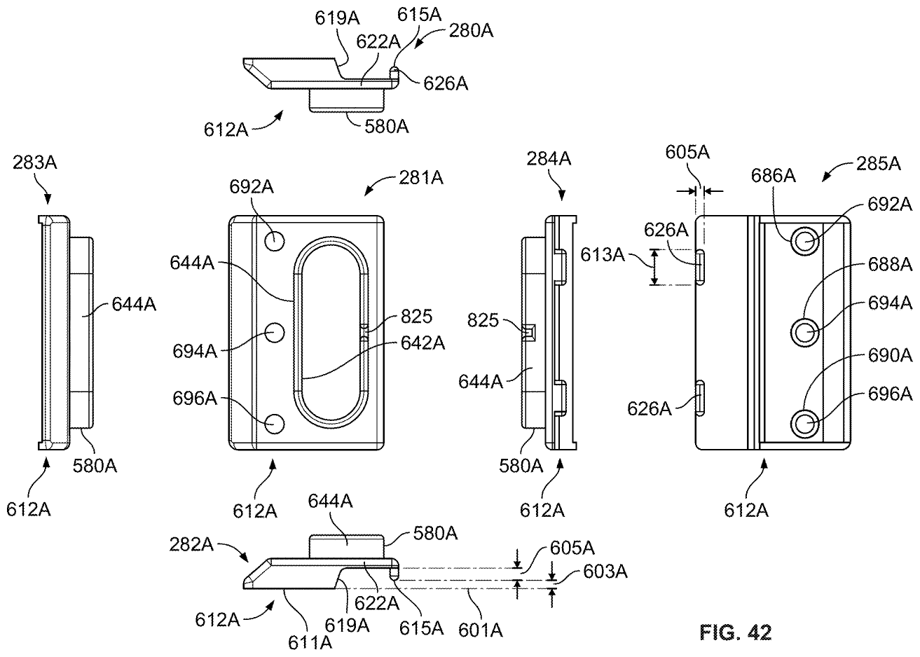

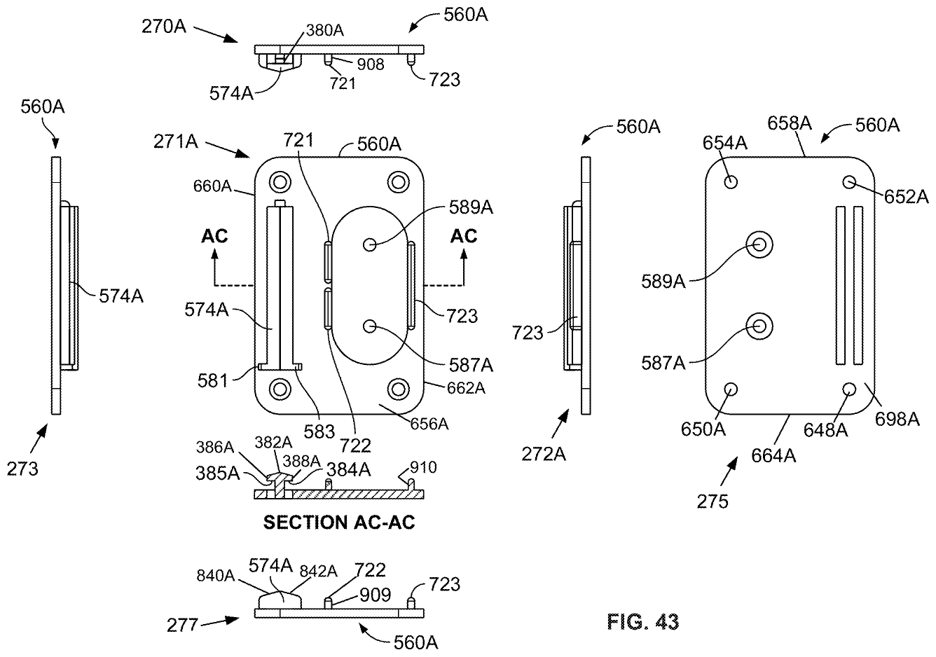

The barrier 550A includes the belt retractor 554 and the belt 556, both discussed above. The barrier 550A also includes a belt clip 558A and a wall receiver 560A. The belt clip 558A can be arranged as a clip assembly having a clip half 610A (i.e., a first clip half or first clip) shown in FIG. 41 and a clip half 612A (i.e., a second clip half or second clip) shown in FIG. 42. Alternatively, the belt clip 558A can be arranged as a unitary, one-piece clip. The clip half 610A includes an arm 620A. The clip half 612A includes an arm 622A.

FIG. 39 shows the belt clip 558A connected to the wall receiver 560A. A latch 574A of the wall receiver 560A is positioned within a slot 570A shown in FIG. 40 and FIG. 41. A sensor component 564A is connected to the wall receiver 560A. FIG. 39 shows a cut-through detail 853 showing engagement of the belt clip 558A and the latch 574A.

The latch 574A includes a flange 581 and a flange 583, shown also in FIG. 43. The flanges 581, 583 can act as stops to prevent the belt clip 558A moving past the flanges 581, 583 after the belt clip 558A has come into contact with the flanges 581, 583. Accordingly, with the barrier 550A positioned as shown in FIG. 39 and the wall receiver 560A mounted to a wall, removal of the belt clip 558A from the wall receiver 560A occurs by moving the belt clip 558A upward, and attachment of the belt clip 558A to the wall receiver 560A occurs by positioning the belt clip 558A at a top of the flange 574A and then sliding the belt clip 558A downward towards the flanges 581, 583.

The wall receiver 560A has a flange arrangement different than the wall receiver 560. In particular, the wall receiver 560A includes a flange 721, 722, 723. The flanges 721, 722, 723 extend away from a front surface 656A. A notch 725 (e.g., a slot or recess) is positioned between the flange 721 and the flange 723. The notch 725 could be used for orienting the sensor component 564A for embodiments in which the sensor component 564A has an orientation tab (e.g., the orientation tab 347 shown in FIG. 34). The flanges 721, 722 are positioned on a first side of the sensor component 564A (when attached) and the flange 723 is positioned on a second side of the sensor component 564A (when attached). The flanges 721, 722 can comprise a single flange with the notch 725. Each of the flange 721, 722, 723 can be referred to a wall receiver flange.

A fastener 590A, 592A, 600A can be used to fixedly attach the clip half 610A and the clip half 612A to each other. The fastener 590A, 592A, 600A can comprise a screw or another type of fastener.

FIG. 40 also shows the barrier 550A in which the belt clip 558A is connected to the wall receiver 560A except that the latch 574A is positioned within a slot 568A within the belt clip 558A. The clip half 610A includes an arm 620A having a flange 624A. The clip half 612A includes an arm 622A having a flange 626A. FIG. 40 shows a cut-through detail 855 showing engagement of the belt clip 558A and the latch 574A within the slot 568A. The flanges 581, 583 of the latch 574A can keep flanges 624A, 626A of the belt clip 558A from moving past the flanges 581, 583. Portions of belt clip 558A not described in this description can be identical to like-portions of the belt clip 558. The clip half 610A includes an arm 630A having a flange 634A and an arm 632A having a flange 636A.

FIG. 41 shows various views of the clip half 610A including a top view 290A, a front view 291A, a bottom view 292A, a left side view 293A, a right-side view 294A, and a back view 295A. The clip half 610A includes the pair of arms 628A (i.e., the arm 630A and the arm 632A) extending from the outer surface 638A.

FIG. 41 shows additional views of the slot 570A, the flange 624A of the arm 620A. FIG. 41 also shows a wall portion 617A that forms a portion of the slot wall 616A (shown in FIG. 39). FIG. 41 also shows the boss 680A, 682A, 684A, and the through-hole 691A, 693A, 695A. Further, FIG. 41 shows a shut-off 596A, 598A within the clip half 610A. The shut-off 596A, 598A can result from an injection molding tool (e.g., B plate) used to form the flange 634A, 636A in cooperation with another injection molding tool (e.g., an A plate).

As shown in the back view 295A, the clip half 610A includes a wall 890A, 894A, 898A having a wall edge 892A, 896A, 900A, respectively. The flange 624A (two of which are shown in FIG. 41) includes a width 886A (i.e., a width of the flange 624A), and a length 902A (i.e., a length of the flange 624A).

As shown in the top view 290A, the flange 624A extends away from the arm 620A and towards a plane 904A including the wall edge 892A. A distance 888A from the plane 904A to a distal end 906A of the flange 624A (i.e., an end of the flange 624) is part of the flange-to-flange gap 567A shown in FIG. 39. Keeping other dimensions of the clip half 610A fixed but increasing the width 886A of the flange 624A decreases the distance 888A, which can lead to a shorter flange-to-flange gap 567A.

The top view 290A and/or the front view 291A also show a width 882A of the flange 634A and a width 884A of the flange 636A, and a flange-to-flange gap 880A extending between a distal end 629A of the flange 634A and a distal end 631A of the flange 636A.

FIG. 42 shows various views of the clip half 612A including a top view 280A, a front view 281A, a bottom view 282A, a left side view 283A, a right-side view 284A, and a back view 285A. The clip half 612A includes the flange 580A and the inner surface 642A and the outer surface 644A of the flange 580A.

As shown in the bottom view 282A, the flange 626A extends away from the arm 622A and towards a plane 601A including the wall edge 611A. A distance 603A from the plane 601A to a distal end 615A of the flange 626A (i.e., an end of the flange 626A) is part of the flange-to-flange gap 567A shown in FIG. 39. Keeping other dimensions of the clip half 612A fixed but increasing the width 605A of the flange 626A decreases the distance 603A, which can lead to a shorter flange-to-flange gap 567A.

FIG. 42 shows additional views of the flange 626A of the arm 622A. Two instances of the flange 626A are shown. The flange 626A has a width 605A and a length 613A. FIG. 42 also shows a wall portion 619A that forms a portion of the slot wall 616A (shown in FIG. 39). FIG. 42 also shows the boss 686A, 688A, 690A, and the through-hole 692A, 694A, 696A.

The sensor component 562 (shown in at least FIG. 27) can be attached to the clip half 612A within an area formed by the flange 580A. The flange 580A includes a notch 825 (e.g., a slot or recess). The notch 825 can be used for orienting the sensor component 562 for embodiments in which the sensor component 562 includes an orientation tab (e.g., the orientation tab 345 shown in FIG. 37). The flange 580A can be referred to as a belt clip flange.

FIG. 43 shows various views of the wall receiver 560A including a top view 270A, a front view 271A, a side view 272A, a side view 273, a back view 275, a bottom view 277, and a section view AC. At least some of those views show the latch 574A and the through-hole 648A, 650A, 652A, 654A. Additionally, FIG. 43 shows a top surface 658A (i.e., a top), a side surface 660A, 662A (e.g., a left and right side), a bottom surface 664A (i.e., a bottom), a front surface 656A (i.e., a front), and a back surface 698A (i.e., a back). The wall receiver 560A can be made from a plastic material via a molding process such as injection molding, compression molding or blow molding. Other examples of the material or process used to make the wall receiver 560A are also possible.

The sensor component 564, 564A can be attached to the wall receiver 560A. Removal of the sensor component 564, 564A or a cover of the sensor component allows for replacing a battery within the sensor component. After the battery replacement, the sensor component can be slid back onto the wall receiver 560A in between the flange 723 and the flange 721, 722 or the cover can be reattached to a portion of the sensor component that remained attached to the wall receiver while the battery was replaced.

The flange 721, 722, 723 includes an inner surface 908, 909, 910, respectively. A portion of the sensor component 564, 564A can contact the inner surface 908, 909, 910 when attached to the wall receiver 560A. Enveloping of the sensor component can prevent the sensor component from being knocked or pulled off the wall receiver 560A. Additionally, the wall receiver 560A can include the through-hole 587A, 589A for positioning fasteners to attach a sensor component in between the flange 723 and the flange 721, 722.

The fastener 576 (shown in FIG. 34) can be used to attach (i.e., retain) the sensor component 564 or the sensor component 564A to the wall receiver 560A. The example fasteners described herein with respect to the fastener 578 are applicable to the fastener 576. Other examples of the fastener 576 are also possible.

The latch 574A includes a stem 380A, a latch tip 382A, a tip under-surface 384A, 385A, and a tip edge 386A, 388A. A width of the stem 380A can be selected based on various factors, such as the material used to make the wall receiver 560A, forces expected to be applied by and to the tip under-surface 384A, 385A, and/or a width of the slot 570A of the belt clip 558A. A length of the tip under-surface 384A (i.e., a distance from the stem 380A to the tip edge 388A), and length of the tip under-surface 385A (i.e., a distance from the stem 380A to the tip edge 386A) can be selected based on various factors, such as the factors listed above, as well as a flange-to-flange gap 880A (shown in FIG. 41) and a width 882A, 884A of the flange 632A, 634A, respectively (shown in FIG. 41).

A distal end of the latch 574A relative to the front surface 656A can be formed (e.g., molded) to be angled (i.e., have side angles 840A, 842A). Forming the wall receiver 560A with the side angles 840A, 842A can assist when separating the plates of an injection molding tool.

### IV. Example Operation

### A. First Flow Chart

FIG. 23 shows a flowchart depicting a set 800 of functions that can be performed in accordance with one or more of the example embodiments. The functions are shown in blocks 802 to 806. The description of the functions in the set 800 refer to a first computing system, a second computing system, a first sensor and a second sensor. The first computing system can include or be arranged like the server 400 (or any other server described in this description). The second computing system can include or be arranged like the remote client 106, 108, 110, 112 or the computing system 500 (or any other client computing system described in this description).

Block 802 includes receiving first and second sensor data at a first computing system. The first sensor data is from a first sensor positioned in proximity to a door of a restricted room. The first sensor is configured to output the first sensor data based on a status of the door being closed or open. The second sensor data is from a second sensor positioned in proximity to a caution barrier positioned in proximity to the door. The second sensor is configured to output the second sensor data based on a status of the caution barrier extending across at least a portion of a doorway corresponding to the door.

In accordance with at least some embodiments, the first sensor comprises a door contact sensor. The door contact sensor can comprise a single sensor component or multiple sensor components (e.g., first and second sensor components). As an example, the door contact sensor comprises a first sensor component including a switch and a second sensor component including a magnet. The switch can include a Hall Effect switch or a reed switch. The first sensor component can be attached to a door jamb or wall adjacent to the door and the second sensor component is attached to the door. Alternatively, the first sensor component is attached to the door, and the second sensor component is attached to a door jamb or wall adjacent to the door. The first sensor can include or be arranged like the sensor 68, 130, 132, 170, 232, or the sensor arrangement 300.

In accordance with at least some embodiments, the second sensor is attached to a door jamb or wall adjacent to the door. In that regard, the second sensor can be attached to a wall receiver (e.g., the wall receiver 560) attached to the door jamb or wall. The caution barrier includes a belt (e.g., the belt 556) extendible from within a housing and retractable into the housing. A magnet configured to interact with the second sensor is attached to the belt (e.g., attached to the belt clip 558). The magnet can be sewn into the belt. The housing can include and/or be referred to as a belt retractor. The housing can be arranged like the belt retractor 554. The second sensor can include or be arranged like the sensor 68, 130, 132, 170, 228, or the sensor arrangement 300. The caution barrier can include or be arranged like the caution barrier 224 or the barrier 550.

In accordance with at least some embodiments, the second sensor includes a first sensor component and a second sensor component. The caution barrier includes: a belt (e.g., the belt 556) including a first end and a second end opposite the first end. The caution barrier can include a belt retractor (e.g., the belt retractor 554) attached to the first end of the belt. The caution barrier can include a belt clip (e.g., the belt clip 558) attached to the second end of the belt. The caution barrier can include a receiver (e.g., the wall receiver 560). The caution barrier can also include the first sensor component and the second sensor component. The first sensor component is attached to the belt clip. The second sensor component is attached to the receiver. One of the first or second sensor components is configured to make a determination indicating whether the first and second sensor components are in proximity to each other and to output the second sensor data based on the determination. The second sensor data can be output (e.g., carried on) a sensor signal.

In accordance with at least some embodiments, the second sensor is attached to a door jamb or wall adjacent to the door, or a wall receiver attached to the door jamb or door. The caution barrier includes an automated gate having an arm configured to extend across the doorway. A magnet configured to interact with the second sensor is attached to the arm.

The second sensor component can be mounted within a cage (e.g., a snap-on cover) to restrain the second sensor component should the second sensor component become dislodged from its mounting location. The second sensor component can be tethered to a second mounting location in case the second sensor component becomes dislodged from a first mounting location. The second sensor component can include a housing with sufficient non-ferrous mass such that gravity overcomes any attractive forces of the magnet and an MRI scanner when the second sensor component becomes dislodged from its mounting location.

Next, block 804 includes determining, at the first computing system based on the first and second sensor data, a first condition existing at the door. The first condition comprises the door being open and non-use of the caution barrier for at least a threshold amount of time while the door is open. The first computing system can read the status data within the database 426 (e.g., status data within one of the restricted room data 430, 432, 434, 436) for an operating environment including the first and second sensors.

The first condition is one of several conditions the first computing system or another computing system can determine with respect to aspects monitored by the first and second sensors. Table C provides a summary of example conditions corresponding to those aspects and sensors. The first condition corresponds to condition B in Table C. Upon determining the door is open with the caution barrier not deployed, the first computing system can determine Condition A in Table C is present. After an applicable time, threshold is met without sensing deployment of the caution barrier, the first computing system can determine Condition B in Table C is present (i.e., exists).

TABLE C

| Condition | Door/Doorway | Caution Barrier | Time threshold(s) Met |
|---|---|---|---|
| A | Open | Not Deployed | No |
| B | Open | Not Deployed | Yes |
| C | Open | Deployed | N/A |
| D | Closed | Deployed | N/A |
| E | Closed | Not Deployed | N/A |
| F | Open | No Signal | N/A |
| G | Closed | No Signal | N/A |
| H | No Signal | Deployed | N/A |
| I | No Signal | Not Deployed | N/A |
| J | No Signal | No Signal | N/A |

Several conditions can include a status of “No Signal” for one or more of the sensors. A time threshold may not be used to determine any of those several conditions once the “No Signal” status is determined. Table C shows the time threshold aspect as non-applicable (i.e., N/A).

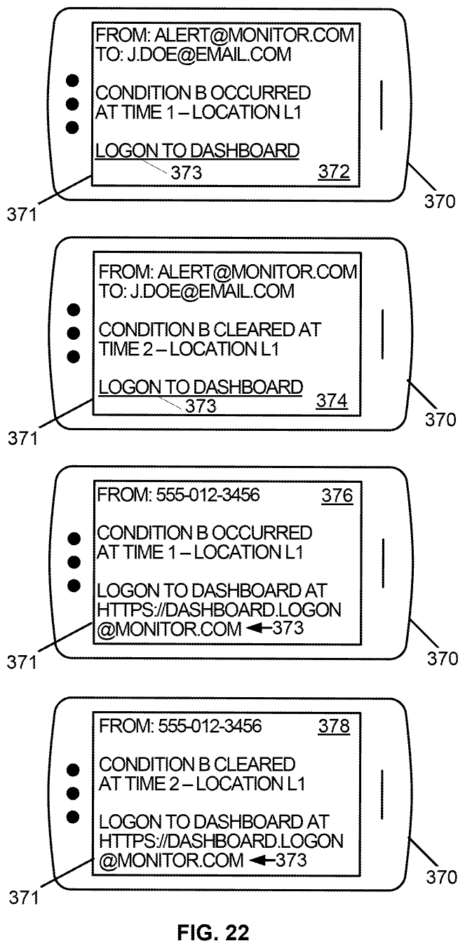

Next, block 806 includes outputting, from the first computing system, a notification regarding the first condition to a second computing system. In one respect, outputting the notification can include transmitting a communication including the notification regarding the first condition. As an example, the communication can include a text message sent using a short message service (SMS) or a multimedia message service (MMS) or an e-mail message. FIG. 22 shows examples of such communications. In another respect, outputting the notification can include transmitting a dashboard update indicative of the first condition. The dashboard update can include a push message transmitted to a computing system displaying the dashboard using a browser application. FIG. 15 to FIG. 17 show examples of such notifications.

In yet another respect, the first computing system can use other modes of outputting the notification to the second computing system, such as an application programming interface (API) or a WebSocket.

A method that includes performing any or all of the functions of the set 800 can include performing one or more other functions. At least some of those functions are described below in this sub-section regarding a first flowchart. Any one or more of the additional functions can be performed in a method without any function of the set 800.

An additional function can include receiving, at a gateway computing system, first and second signals transmitted by the first and second sensors, respectively. The first and second signals carry the first and second sensor data, respectively. The gateway computing system transmits third and fourth signals carrying the first and second sensor data, respectively, to the first computing system. Receiving the first sensor data at the first computing system includes receiving the third signal transmitted from the gateway computing system. Receiving the second sensor data at the first computing system includes receiving the fourth signal transmitted from the gateway computing system. The gateway computing system can be arranged like the gateway computing system 122, 124, 126, 128, 168, 252, 450. The gateway computing system can include a transceiver configured to repeat a signal received by the transceiver.

Transmission of the first and second signals can occur via a wireless personal area network or a low-power wireless mesh network. Transmitting the third and fourth signals can occur via a cellular telephone network. Other networks described herein can be used to transmit the first and second signals.

The first signal can be a broadcast or multicast message transmitted by the first sensor, and the second signal can be a broadcast or multicast message transmitted by the second sensor. The first and third signals can include a first time stamp corresponding to the first sensor data, and the second and fourth signals can include a second time stamp corresponding to the second sensor data.

An additional function can include receiving the first and second signals at a local computing system, determining, at the local computing system based on the first and second signals, the first condition existing at the door; and outputting, onto a display at the local computing system, a second notification regarding the first condition. The local computing system can be arranged like the local computing system 114, 116, 118, 120, 172, 222 and/or the computing system 500.

An additional function can include executing, at a processor of the gateway computing system, an application configured to perform application programming interface (API) calls to the first computing system. Transmitting the third and fourth signals can occur via one or more API calls to the first computing system. Transmitting the third and fourth signals can occur via a WebSocket established between the gateway computing system and the first computing system.

An additional function can include determining, at the processor of the gateway computing system, a first change of state or a second change of state. The first change of state corresponds to the door and is based on the first sensor data. The second change of state corresponds to the caution barrier and is based on the second sensor data. At least one of the one or more API calls to the first computing system occurs in response to determining the first change of state or the second change of state.

An additional function can include receiving additional sensor data from the first sensor and the second sensor at the first computing system; determining a statistic at the first computing system based, at least in part, on the additional sensor data; and outputting a notification regarding the statistic from the first computing system to the second computing system. The statistic can include at least one statistic selected from the group consisting of: an average door open time over a particular time period, and a total door open time over the particular time period. The particular time period can include a time period selected from among: a past day, a past twenty-four hours, an amount of time since a current day began, a past week, a past seven days, a past one hundred and sixty-eight hours, and a past month.

An additional function can include receiving, at the first computing system from one or more gateway computing systems, further data corresponding to: signals the one or more gateway computing systems receive from a respective door sensor positioned in proximity to a respective door of a respective restricted room. The respective door sensor is configured to output signals based on a status of the respective door being closed or open, and signals the one or more gateway computing systems receive from a respective barrier sensor positioned in proximity to a respective caution barrier positioned in proximity to the respective door. The respective barrier sensor is configured to output signals based on a status of the respective caution barrier extending across at least a portion of a respective doorway corresponding to the respective door. The first computing system can aggregate the further data and determine an additional statistic based, at least in part, on the aggregated further data. The first computing system can output a notification regarding the additional statistic to the second computing system.

An additional function includes a supplemental sensor, such as temperature sensor, a ferrous metal detector sensor, or a gas sensor transmitting a supplemental data within proximity to the gateway computing system and/or a local computing system. The gateway computing system and/or the local computing system can receive the supplemental data and determine a condition based on the received supplemental data by comparing whether the supplemental data exceeds a threshold value corresponding to the supplemental data. As an example, the threshold value can indicate a threshold temperature, presences of a ferrous metal, or a threshold gas level. The gateway computing system can transmit the supplemental data to the first computing system. The first computing can receive the supplemental data transmitted by the gateway and determine the condition based on the supplement data by comparing whether the supplemental data exceeds the threshold value corresponding to the supplemental data. The first computing system can output a notification regarding the condition based on the received supplemental data.

The first sensor data can correspond to a first signal, and the second sensor data can correspond to a second signal. For example, the first signal can carry the first sensor data, and the second signal can carry the second sensor data. The first and second sensor data can include a first time-stamp corresponding to the first signal and a second time stamp corresponding to the second signal. The first and second time-stamps can be time stamps included with the first and second signals received at the gateway computing system. Alternatively, the first and second time-stamps can be time stamps generated by the gateway computing system, such as times generated when the gateway computing system receives the first and second signals or when the gateway computing system transmits the data corresponding to the first and second signals.

The second computing system referenced in block 806 can include a remote client computing system. An additional function can include the second computing system displaying the first notification within a graphical user interface. Displaying the first notification within the graphical user interface can include displaying a text message, a short message service message, a multi-media service message, an e-mail message, or an alert within a visual dashboard.

The first sensor referenced in the set 800 of functions can include a door contact sensor. The door contact sensor can include a first sensor component including a switch and a second sensor component including a magnet. The switch can include a Hall Effect switch or a reed switch. The first sensor component can be attached to a door jamb or wall adjacent to the door and the second sensor component can be attached to the door. The first sensor component can be attached to the door, and the second sensor component can be attached to a door jamb or wall adjacent to the door.

The second sensor referenced in the set 800 of functions can include can be mounted within a cage to restrain the second sensor component in case the second sensor component becomes dislodged from its mounting location. The second sensor component can be tethered to a second mounting location in case the second sensor component becomes dislodged from a first mounting location. The second sensor component can include a housing with sufficient non-ferrous mass such that gravity overcomes any attractive forces of the magnet and an MRI scanner when the second sensor component becomes dislodged from its mounting location.

In one arrangement, the second sensor is attached to a door jamb or wall adjacent to the door. The caution barrier can include a belt extendible from within a housing and retractable into the housing, and a magnet configured to interact with the second sensor is attached to the belt.

In another arrangement, the second sensor is attached to a door jamb or wall adjacent to the door. The caution barrier includes an automated gate having an arm configured to extend across the doorway, and a magnet configured to interact with the second sensor is attached to the arm.

### B. Second Flow Chart

FIG. 24 shows a flowchart depicting a set 870 of functions that can be performed in accordance with one or more of the example embodiments. The functions are shown in blocks 872 to 876. The description of the functions in the set 870 refer to a computing system, a first sensor, a second sensor, and a caution barrier. The computing system can include or be arranged like the local computing system 70, 114, 116, 172, 222 or the computing system 500. The first sensor can include or be arranged like the sensor 68, 130, 132, 170, 232, or the sensor arrangement 300. The second sensor can include or be arranged like the sensor 68, 130, 132, 170, 228, or the sensor arrangement 300. The caution barrier can include or be arranged like the caution barrier 224 or the barrier 550.

Block 872 includes receiving first and second signals at a computing system. The first signal is from a first sensor positioned in proximity to a door of a restricted room. The first sensor is configured to output the first signal based on a status of the door being closed or open. The second signal is from a second sensor positioned in proximity to a caution barrier positioned in proximity to the door. The second sensor is configured to output the second signal based on a status of the caution barrier extending across at least a portion of a doorway corresponding to the door. Receiving the first signal can occur after receiving the second signal. Alternatively, receiving the first signal can occur before receiving the second signal, or at the same time as receiving the second signal.

The computing system can determine data carried by the first and second signals and store the data into the status data 534. Determining the data can include providing the first and second signals to an analog-to-digital converter. Determining the data can include parsing a digital signal to obtain the data carried by the first and second signals. The computing system can store time-stamps with the data carried by the first and second signals in the status data. The time-stamps can be included in the first and second signals or generated by the computing system.

Next, block 874 includes determining, at the computing system based on data carried by the first and second signals, a first condition existing at the door. The first condition comprises the door being open and non-use of the caution barrier (i.e., the caution barrier is not deployed) for at least a threshold amount of time while the door is open.

Next, block 876 includes outputting, from the server computing system, a notification regarding the first condition to a client computing system.

A method that includes performing any or all of the functions of the set 870 can include performing one or more other functions. At least some of those functions are described below in this sub-section regarding a second flowchart. Any one or more of the additional functions can be performed in a method without any function of the set 870.

An additional function can include receiving a third signal at the computing system while the first notification is output on the display. The third signal is from the first sensor and indicates the door is closed. The computing system determines a second condition existing at the door based on the data carried by the third signals. The second condition comprises the door being closed. The computing system outputs a second notification regarding the second condition on the display.

An additional function can include receiving a third signal at the computing system while the first notification is output on the display. The third signal is from the second sensor and indicates the caution barrier is deployed. The computing system can determine a second condition existing at the door based on the data carried by the first and third signals. The second condition comprises the door being open and the caution barrier being deployed. The computing system can output a second notification regarding the second condition on the display.

An additional function can include receiving a fourth signal at the computing system while the second notification is output on the display. The fourth signal is from the first sensor and indicates the door is closed. The computing system can determine a third condition existing at the door based on the data carried by the fourth signal. The third condition comprises the door being closed. The computing system can output a third notification regarding the third condition on the display.

An additional function can include determining, at the computing system, a particular condition existing at the door based on a first configuration parameter stored in a computer-readable memory at the computing system. The computing system can receive a second configuration parameter transmitted by the first sensor or the second sensor. The computing system can store the second configuration parameter into the computer-readable memory at the computing system for use thereafter in determining the particular condition existing at the door. The computing system can determine the particular condition existing at the door based on the second configuration parameter.

An additional function can include receiving the second configuration parameter at the first sensor or the second sensor from a gateway computing system; and transmitting the second configuration parameter from the first sensor or the second sensor to the computing system. In some cases, the first configuration parameter indicates the first threshold amount of time, the second configuration parameter indicates a second threshold amount of time for comparing to a condition in which the door is open and the caution barrier is not deployed, and the first and second threshold amounts of time are different. In some other cases, the second configuration parameter indicates the first threshold amount of time, the first configuration parameter indicates a second threshold amount of time for comparing to a condition in which the door is open and the caution barrier is not deployed, and the first and second threshold amounts of time are different.

An additional function can include receiving the first and second signals at the gateway computing system. The gateway computing system can transmit data corresponding to the first and second signals to a server computing system. The server computing system can determine the first condition existing at the door based on the data corresponding to the first and second signals. The server computing system can output a notification regarding the first condition to a client computing system. In some cases, the data corresponding to the first and second signals indicates data carried by the first and second signals, respectively. In other cases, the data corresponding to the first and second signals comprises repeated versions of the first and second signals, respectively.

An additional function can include the computing system incrementing a first counter tracking how many occurrences of the first condition have occurred at the door during a particular time period. The computing system can output a value indicated by the first counter on the display at the computing system. The particular time period can be a twenty-four-hour period of the current day or another time period. The computing system can reset the first counter at an end of the day.

An additional function can include the computing system determining a fourth condition indicating the door was opened while the caution barrier was not deployed and then closed within the first threshold amount of time. The computing system can output a fourth notification regarding the fourth condition on display at the computing system.

An additional function can include the computing system incrementing a second counter tracking how many occurrences of the fourth condition have occurred at the door during the particular time period. The computing system can output a value indicated by the fourth counter on the display at the computing system. In some cases, determining, at the computing system, a ratio based on the value indicated by the first counter and the value indicated by the second counter; and outputting the ratio on the display at the computing system.

An additional function can include the computing system determining a ratio based on the value indicated by the first counter and the value indicated by the second counter. The computing system can output the ratio on the display at the computing system. In at least some cases, determining the fourth condition includes determining that the door was open for at least a second threshold amount of time, and the second threshold amount of time is less than the first threshold amount of time. Additionally, in at least some cases, determining the fourth condition includes determining that someone or some object passed through the doorway while the door was open.

A method that includes performing any or all of the functions of the set 870 can include receiving the first signal after receiving the second signal, receiving the first signal before receiving the second signal, or receiving the first and second signals at the same time.

### V. Communication Flows

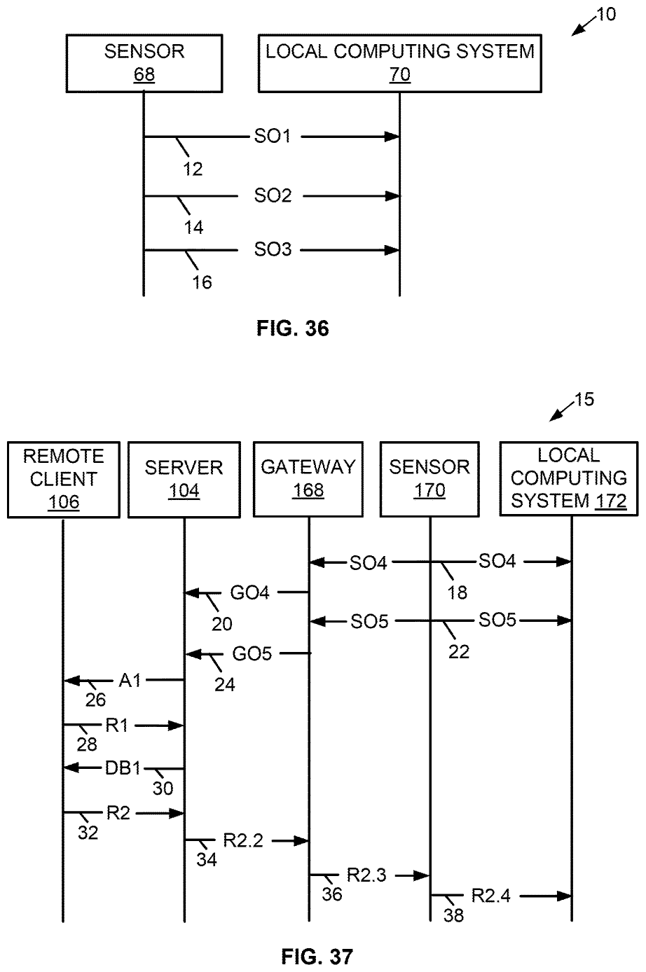

FIG. 36 shows a communication flow 10 between the sensor 68 and the local computing system 70 in accordance with the example embodiments, such as the operating environment 60 shown in FIG. 2. The communication flow 10 includes a sensor output (SO1) 12, a sensor output (SO2) 14, and a sensor output (SO3) 16. As an example, the sensor output 12 can include data indicating a state detected by the sensor 68. For a case in which the sensor 68 is a door sensor, a sensor output such as SO1, SO2, SO3 can indicate a state of the door, such as open or closed. For a case in which the sensor 68 is a sensor mounted on a caution barrier, a sensor output such as SO1, SO2, SO3 can indicate a state of the barrier being deployed, such as deployed or not deployed. The sensor 68 can represent multiple sensors such that the sensor output 12, 14, 16 can be transmitted by the multiple sensors (e.g., a first sensor transmits the sensor output 12 and the sensor output 16, and a second sensor transmits the sensor output 14).

The local computing system 70 can determine a condition based on a sensor output, such as the sensor output 12, 14, 16 and output a notification on a display at the local computing system.

As another example, a sensor output, such as one of the sensor output 12, 14, 16 can include a configuration parameter and an identifier of the configuration parameter for use by the local computing system 70 can reconfigure itself. The configuration parameter can represent a time threshold used by the local computing system 70 to determine when to output an alert on its display. Other examples of the configuration parameter are also possible.

FIG. 37 shows a communication flow 15 via the remote client 106, server 104, the gateway 168, the sensor 170, and the local computing system 172, such as the operating environment 100 shown in FIG. 1 and/or the operating environment 160 shown in FIG. 3. The communication flow 15 includes a sensor output (SO4) 18, a gateway output (GO4) 20, a sensor output (SO5) 22, and a gateway output (GO5) 24.

The sensor output 18, 22 can be broadcast or multicast communications transmitted by the sensor 170 and received by the gateway 168 and the local computing system 172. The local computing system 172 can receive the sensor output 18, 22 and update its display based on sensor data contained within the sensor output 18, 22. In an alternative embodiment, the sensor 170 can transmit separate unicast messages to the gateway 168 and the local computing system 172 containing the sensor data within the sensor output 18, 22.

The gateway 168 can receive the sensor output 18, 22 and transmit sensor data within the sensor output 18, 22 to the server 104 via the gateway output 20 and the gateway output 24. The server 104 can use the sensor data to determine whether to send out an alert notification and/or to update KPIs corresponding to a location at which the gateway 168, the sensor 170, and the local computing system 172 are located. For example, an alert notification can be transmitted as an alert output (A1) 26. The alert communication 26 can be pushed to the remote client 106. The remote client 106 can output the alert notification on its display.

The communication flow 15 includes a request output (R1) 28, a dashboard output (DB1) 30, a request output (R2) 32, a request output (R2.2) 34, a request output (R2.3) 36, and a request output (R2.4) 38. The remote client 106 can transmit the request output 28 to the server 104. The request output, for example, can include a log-on request that impliedly requests a dashboard GUI, or a separate request for a dashboard GUI. The server 104 can respond to the request output 28 by transmitting the dashboard output 30 to the remote client 106. The dashboard output 30 can include a GUI file or data for updating a GUI output on a display of the remote client 106.

The request output 32 can include a configuration parameter for configuring the gateway 168, the sensor 170, and/or the local computing system 172. The server 104 can receive the request output 32 and responsively transmit the request output 34 to the gateway 168. If the configuration parameter is for configuring the gateway 168, the gateway 168 can configure itself using the configuration parameter. If the configuration parameter is for configuring the sensor 170 or the local computing system 172, the gateway 168 transmits the request output 36 to the sensor 170. If the configuration parameter is for configuring the sensor 170, the sensor 170 can configure itself using the configuration parameter. If the configuration parameter is for configuring the local computing system 172, the sensor 170 transmits the request output 38 to the local computing system 172. If the configuration parameter is for configuring the local computing system 172, the local computing system 172 can configure itself using the configuration parameter.

Other example communications between any of the components shown in the operating environment 60, 100, 160 or elsewhere described in this description are also possible.

### VI. Example Graphical User Interfaces

As discussed above, computing systems of the example embodiments can display a graphical user interface (GUI) to show data corresponding to a restricted room and conditions based on signals transmitted by sensors within or in proximity to the restricted room and/or a doorway that allows access to the restricted room. FIG. 14 to FIG. 22 and FIG. 38 show examples of such a GUI and/or content that can be displayed via such a GUI.

FIG. 14 shows a GUI 700. In accordance with at least some embodiments, the GUI 700 includes a multi-panel (i.e., a multi-container) GUI. For embodiments in which a GUI comprises a multi-panel GUI, the multi-panel GUI can comprise two or more panels. As an example, the GUI 700 can include a panel 702, 704, 706. Content can be included within the GUI 700. The content within the GUI 700 can comprise static content and/or dynamic content. The server 104 can transmit one or more files to a remote client that the remote file uses to output the GUI and/or to update the GUI with dynamic content. The local computing system 70, 172, 222, 500 can store the GUI 700 within the memory 506 and output the GUI 700 via the display 518. The processor 502 can update the content within the GUI 700 based on signals transmitted from sensors in proximity to that local computing system.

The panel 702 includes a message 708, 710, 712, 714 (e.g., a warning). The message 708, 714 is a textual message (e.g., a clear, concise, bold, standardized message). The message 708 can be dynamic such that a processor can change the message based on current circumstances and/or status of the operating environment 100. The message 710 can be a standard message created by a standards organization, such as the American Society for Testing and Material (ASTM) organization. As an example, the message 710 can be a standard magnetic field warning. The message 712 is an animated message. For example, the message 712 can comprise an animation showing an MRI with typical warning objects being pulled into the magnet with illustrative magnetic field lines shown. The animations can be custom animations. In at least some cases, the animations can be universally understood.

The panel 704 can include content 716, such as a list of items banned from taking into a restricted room. The content 716 in the panel 704 can be static or dynamic. As an example, the dynamic content can include a rotating list of banned items. The rotation can include showing one or more particular items increased in size for a predetermined amount of time and then showing the particular items decreased in size for another predetermined amount of time while other banned items are shown increased in size relative to the other items shown decreased in size while the particular items were shown increased in size. A sequence can be defined to rotate show banned items at the increased or decreased sizes.

The panel 706 can include static and dynamic content. As an example, the panel 706 can be referred to as a “gamification panel.” The panel 706 can be configured to drive user engagement and interaction. The panel 706 can include graphical content, such as animated stopwatch 718. As an example, the animated stopwatch 718 can include moving pie wedge icons depicting time remaining before an alert is sent. The animated stopwatch 718 can be a visual reminder of a user's goal to minimize how many or prevent any alerts from being sent. The animated stopwatch 718 can appear to be three dimensional.

The panel 706 can include textual content 720 (e.g., a notification). For example, the textual content 720 can show a daily alerts count which can motivate a user to avoid alerts being added to the alerts count. As another example, the textual content 720 can include a timer indicating, for instance, a total unsecured time (i.e., an amount of time an MRI room door is open without a supplemental barrier being in place across the doorway). The timer can motivate a user to achieve a target time or a goal that is the least time possible. Yet another example, the textual content 720 can include a door ranking that shows how a user's use of the MRI door and supplemental barriers ranks relative to other users in the user's organization (e.g., a hospital network or a network of all users using a panel with respect to MRI doors and supplemental barriers).

Next, FIG. 15, FIG. 16, and FIG. 17 show a GUI 730 in accordance with the example embodiments. In accordance with at least some embodiments, the GUI 730 can be used as a dashboard and/or instrumentation regarding components of a system described in this description. As an example, the content within the GUI 730 can be referred to as a “sensor dashboard.” A sensor dashboard can include content regarding sensors and other system component.

The GUI 730 includes a user-selectable control (USC) 732, 734, 736. The USC 732 is selectable to trigger a computing system, such as the server 400, to output content within the GUI 730 regarding all restricted doors being monitored by the server, or all restricted doors being monitored by the server for a particular person, facility, or enterprise. The USC 734 is selectable to trigger a computing system, such as the server 400, to output content within the GUI 730 regarding average door times for a door or doors of a facility selected using a USC 738 and the USC 740 (both shown in FIG. 16 and FIG. 17). The USC 736 is selectable to trigger a computing system, such as the server 400, to output content within the GUI 730 regarding the status of a door or doors of a facility selected using the USC 738 and the USC 740.

The GUI 730, as shown in FIG. 15, can be output while the All Doors option is the currently selection option due to a selection of the USC 732. The GUI 730, as shown in FIG. 15, represents the USC 732 has been selected by underlined text, but that selection could be represented in other ways such as by highlighting.

The GUI 730, as shown in FIG. 15, includes door status data 748 for all doors (e.g., all doors for a particular enterprise). The door status data 748 includes door identifiers 750, facility identifiers 752, and status information 754. The status information 754 is represented graphically. In other embodiments, the status information 754 could be represented textually or graphically and textually. In accordance with at least some embodiments, the status information 754 could use different colors to represent particular status information, such as green to represent an approved status and red to represent a disapproved status. The GUI 730 can include a legend 755 defining representations in the status information 754.

Next, the GUI 730 shown in FIG. 16 represents the USC 734 has been selected by underlined text, but that selection could be represented in other ways such as by highlighting. As noted above, the GUI 730 can include the USC 738, 740. The USC 738 can comprise a drop-down menu from which one or more facilities can be selected, and the USC 740 can comprise a drop-down menu from which one or more doors can be selected. Other examples of implementing the USC 738, 740 to make such selections are also possible.

The GUI 730 shown in FIG. 16 shows statistics 742, 744. The statistics 742 show average open times for a selected door (i.e., Door N at Facility N) over a particular time period (e.g., day, week or month). The statistic 744 shows total open times for the selected door (i.e., Door N at Facility N) over a particular time period (e.g., day, week or month). The statistics 742, 744 can be referred to as Key Performance Indicators (KPIs) for one location (e.g., one restricted room) or multiple locations (e.g., multiple locations for a single enterprise, or one or more locations for multiple enterprises). Each of those locations can include a gateway and sensors at a restricted room.

Next, the GUI 730 shown in FIG. 17 represents the USC 736 has been selected by underlined text, but that selection could be represented in other ways such as by highlighting. The GUI 730 shown in FIG. 17 shows status data 746. The status data 746 includes a status of the door for restricted room RR1 at facility F1 and a status of a caution barrier at that door. As an example, the status data 746 can include time information, such as a clock time since the status of the door and caution barrier changed to its current state. As another example, the time information can include an amount of time counted by a timer since the status of the door and caution barrier changed to its current state.

Next, FIG. 18 shows a GUI 770 in accordance with the example embodiments. The GUI 770 includes an operational checklist 772. The operational checklist 772 can include one or more drop-down menus, one or more data fields, one or more check boxes, one or more user-selectable controls, and/or guidance. The operational checklist 772 can reinforce operational/protocol behaviors, and can be used to capture compliance data and provide greater detail to data set provided by a gateway.

As an example, the operational checklist 772 can include a drop-down menu 774 for selection of a purpose of entry into a restricted room (e.g., patient entry, patient removal, maintenance, or cleaning). As an example, the operational checklist 772 can include a drop-down menu 776 for selection of a type of scan (e.g., anesthesia, contrast, intensive care, child/neonates).

As an example, the operational checklist 772 can include a field 778 for entry of a patent identifier (i.e., patient id), such as a patient name and birthdate. The GUI 770 can include a user-selectable control 782 to trigger reading of an RFID tag or to take an image of a two-dimensional matrix code, either or both including data representing the patient ID.

As an example, the operational checklist 772 can include a check list 780 including check boxes with respect to questions posed on the operational checklist 772. The guidance on the operational checklist 772 can include guidance 786 comprising, for example, daily bulletins regarding a restricted room. The guidance 786 can be dynamically alterable to ensure important safety considerations are uniformly distributed throughout user groups (e.g., users of a single or multiple enterprises), and to reinforce operational and/or behavioral standards for proper safety and risk mitigation.

The GUI 770 can also include a user-selectable control 784 selectable to trigger transmission of data entered via the operational checklist 772 to a server, such as the server 400.

The server 400 can store data entered via the operational checklist 772 within the database 426 for the restricted room corresponding to the data. Execution of an application and/or module within the application 423 at the server 400 can analyzing data entered via the operation checklist for one or more restricted rooms to determine breakdowns in operational efficiencies and opportunities for process improvement and/or determine granular details to measure specific activity time durations.

The operational checklist 772 is customizable to measure specific activities conducted at a specific restricted room (e.g., a room with an MRI scanner) at a specific time.

In accordance with at least some embodiments, the server 104, 400 can receive sensor data received at the gateway 450 and forwarded to the server 104, 400 via the communication network 102. The server 104, 400 can determine conditions and statistics based on the sensor data and output a GUI and/or notification based on the determined conditions and statistics to a computing system operatively connected to the server 104, 400 such as the remote client 106, 108, 110, 112, the gateway 122, 124, 126, 128, 168, or the local computing system 118, 120, 172.

Next, FIG. 19 shows a GUI 787 in accordance with the example embodiments. The GUI 787 can be transmitted to a client and output on a display of the client, such as a local computing system. The GUI 787 includes a textual warning 788, 789, 791 regarding a restricted room (e.g., an MRI room), and a graphical warning 790. One or more of the textual warning 788, 789, 791 and the graphical warning 790 can be static or dynamic. In the case of the dynamic warning, the client can switch one warning to another warning in a sequence of warnings.

The GUI 787 includes a container 792 including a dynamic warning 793, 794, 795. A server can transmit data to the client for updating content within the container 792. For example, the server can transmit data to update the dynamic warning 793, 794, 795 as statistics represented by the dynamic warning 793, 794, 795 change. As an example, the dynamic warning 793 indicates an amount of time (e.g., a total time) a door to the restricted room has been unsecured for a given time period (e.g., the amount of time since a beginning of the day). As another example, the dynamic warning 794 indicates a star rating (e.g., 1, 2, 3, 4, or 5 stars) regarding a door performance rating for the door in a restricted room. The star rating can be based on a ratio determined by a computing system, such as the server 104, 400, the local computing system 114, 116, 118, 120, or the computing system 500.

The star rating indicated by the dynamic warning 794 can be relative to performances with respect to doors of other restricted rooms. As another example, the dynamic warning 795 indicates a quantity of times the door remained open or unsecured for more than a threshold amount of time. In accordance with at least some embodiments, the content shown within container 792 when a monitored restricted room door is currently closed, or open, but secured with a caution barrier.

The GUI 787 includes a user-selectable control 771 selectable to cause the processor to display a different GUI, such as the GUI 260 shown in FIG. 38. The user-selectable control 771 can include an icon, such as an icon representing a gear. The GUI displayed in response to selection of the user-selectable control 771 can provide a user with capabilities to select one or more operational settings (or more simply, settings) of the computing system displaying the GUI 787.

Next, FIG. 20 shows another view of the GUI 787 in accordance with the example embodiments. As an example, the GUI 787 as shown in FIG. 20 can be displayed in response to the server determining the monitored restricted room door is open and unsecured. In FIG. 20, the container 792 includes different content as compared to the content shown in FIG. 19. For example, in FIG. 20, the container 792 includes a dynamic warning 796 including a countdown timer 797 to indicate how much time remains before a threshold amount of time permitted for a restricted room door to be open or unsecured expires and an overtime limit event occurs. The dynamic warning 796 can include a timer bar 798 that increasingly covers more space within the container 792 as the countdown timer 797 counts down.

Next, FIG. 21 shows another view of the GUI 787 in accordance with the example embodiments. As an example, the GUI 787 as shown in FIG. 21 can be displayed when the countdown timer 797 expires. In FIG. 21, the container 792 includes different content as compared to the content shown in FIG. 19 and FIG. 20. For example, in FIG. 21, the container 792 includes a dynamic warning 799 indicating the monitored restricted room door should be secured immediately (e.g., secured by closing the door or activating a caution barrier at the door. Once the gateway or server determines the door is secure, the client can begin displaying the GUI 787 as shown in FIG. 19, although the dynamic content therein can be updated based on current statistics determined by the server.

FIG. 22 shows notifications in accordance with the example embodiments. In particular, FIG. 22 shows a computing system 370 including a display 371. The computing system 370 can operate as client computing system, such as a remote client 106, 108, 110, 112 shown in FIG. 1. The computing system 370 can include a smart phone or a tablet computing device and/or can be arranged like the computing system 500. The computing system 370 can include an executable application (e.g., the application 523) for receiving and displaying messages, such as e-mail and text messages.

At the top of FIG. 22, the computing system 370 is displaying an e-mail message 372 regarding a detected condition. As shown in FIG. 22, an e-mail message can identify the condition, a time at which the condition was detected, and a location at which the condition exists or occurred. The e-mail message 372 includes a link 373 (e.g., a hyperlink) selectable to open a website in a browser to allow a user to display a dashboard regarding systems being monitored for the user. The dashboard can display a GUI, such as a GUI shown in FIG. 14 to FIG. 21.

Moving down in FIG. 22, the computing system 370 is displaying an e-mail message 374 regarding a detected condition (e.g., an update to the condition represented in the e-mail message 372). The e-mail message 374 includes the link 373.

Continuing down in FIG. 22, the computing system 370 is displaying a text message 376 regarding a detected condition. As shown in FIG. 22, a text message can identify the condition, a time at which the condition was detected, and a location at which the condition exists or occurred. The text message 376 includes the link 373.

At the bottom of FIG. 22, the computing system 370 is displaying a text message 378 regarding a detected condition (e.g., an update to the condition represented in the text message 376). The text message 378 includes the link 373. FIG. 22 shows the link 373 can be arranged in different ways. Other examples of e-mail and text messages that can be sent to a client, such as a remote client or client computing system, are also possible.

FIG. 38 shows a GUI 260 in accordance with the example embodiments. As an example, the GUI 260 can be displayed on a display (e.g., the display 518) in response to a selection of the user-selectable control 771 shown in FIG. 19 to FIG. 21. Other examples of actions that cause the GUI 260 to be display are also possible.

The GUI 260 includes a language selection section 262. The language selection section 262 includes user-selectable controls 268, 274 corresponding to respective languages for sound alerts (i.e., audible alerts). In some embodiments, the language selection section 262 includes a user-selectable control 268, 274 for each language in a list of selectable languages 266 displayed in the GUI 260. FIG. 38 shows the list of selectable languages 266 comprises at least the following languages: English, French, Spanish, German, and Portuguese. Other example languages or quantities of languages in the list of selectable languages 266 are possible.

FIG. 38 shows the user-selectable control 274 for English, French, and Spanish to be in an on state, and the user-selectable control 274 for German and Portuguese to be in an off state. A processor (e.g., the processor 502) can be configured to output sound alerts in each language for which the user-selectable control 274 corresponding to that language is in the on state. Furthermore, the processor can be configured to output the sound alerts in those languages in an order from top to bottom as shown in FIG. 38. If only one user-selectable control 274 is in the on state, then the processor outputs sound alerts only in the language corresponding to that one user-selectable control 274.

The user-selectable control 268 corresponding to each language can be used to re-order that language within the list of selectable languages 266. For example, the processor can be configured to determine the user-selectable control for a first language (e.g., French) is dragged upwards above the user-selectable control 268 corresponding to English such that the list of selectable languages 266 shows the following order of languages: French, English, Spanish, German, and Portuguese. As another example, the processor can be configured to determine the user-selectable control for a first language (e.g., French) is dragged downward between the user-selectable control 268 corresponding to Spanish and the user-selectable control 268 corresponding to German, such that the list of selectable languages 266 shows the following order of languages: English, Spanish, French, German, and Portuguese.

The GUI 260 includes a sound alert selection section 264. The sound alert selection section 264 includes a separate user-selectable control 278 corresponding to a respective sound alert. As an example, the sound alert selection section 264 can include a user-selectable control 278 for each sound alert in a list of sound alerts 276 output in the GUI 260. FIG. 38 shows the user-selectable control 278 for each sound alert to be in an on state, such that the corresponding sound alert is played out by the user interface 508 when the processor 502 determines a condition corresponding to the sound alert is present.

### VII. Conclusions

The arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether. Furthermore, various functions described and/or shown in the drawings as being performed by one or more aspects or components can be carried out by a processor executing computer-readable program instructions or by a combination of hardware, firmware, and/or software. For purposes of this description, execution of program instructions contained in a computer-readable memory to perform some function can include executing all or a portion of the program instructions.

While various aspects and embodiments are described herein, other aspects and embodiments will be apparent to those skilled in the art. The various aspects and embodiments disclosed herein are for purposes of illustration and are not intended to be limiting.

Finally, one or more embodiments described above can relate to one or more of the following enumerated example embodiment(s) (EEEs).

EEE A1 is a method comprising: receiving first and second sensor data at a first computing system, wherein: the first sensor data is from a first sensor positioned in proximity to a door of a restricted room, the first sensor is configured to output the first sensor data based on a status of the door being closed or open, the second sensor data is from a second sensor positioned in proximity to a caution barrier positioned in proximity to the door, and the second sensor is configured to output the second sensor data based on a status of the caution barrier extending across at least a portion of a doorway corresponding to the door; determining, at the first computing system based on the first and second sensor data, a first condition existing at the door, wherein the first condition comprises the door being open and non-use of the caution barrier for at least a threshold amount of time while the door is open; and outputting, from the first computing system, a first notification regarding the first condition to a second computing system.

EEE A2 is the method according to EEE A1, further comprising: receiving, at a gateway computing system, first and second signals transmitted by the first and second sensors, respectively, wherein the first and second signals carry the first and second sensor data, respectively; transmitting, from the gateway computing system to the first computing system, third and fourth signals carrying the first and second sensor data, respectively, wherein: receiving the first sensor data at the first computing system includes receiving the third signal transmitted from the gateway computing system, and receiving the second sensor data at the first computing system includes receiving the fourth signal transmitted from the gateway computing system.

EEE A3 is the method according to EEE2 A2, wherein: transmission of the first and second signals occurs via a wireless personal area network or a low-power wireless mesh network, and transmitting the third and fourth signals occurs via a cellular telephone network.

EEE A4 is the method according to EEE A3, further comprising: receiving the first and second signals at a local computing system, determining, at the local computing system based on the first and second signals, the first condition existing at the door; and outputting, onto a display at the local computing system, a second notification regarding the first condition.

EEE A5 is the method according to EEE A4, wherein: the first signal is a broadcast or multicast message transmitted by the first sensor, and the second signal is a broadcast or multicast message transmitted by the second sensor.

EEE A6 is the method according to EEE A3, further comprising: receiving the first and second signals at a local computing system, determining, at the local computing system based on the first and second signals, the first condition existing at the door; and outputting, via the local computing system, an audible alert regarding the first condition.

EEE A7 is the method according to EEE A6, wherein: the first signal is a broadcast or multicast message transmitted by the first sensor, and the second signal is a broadcast or multicast message transmitted by the second sensor.

EEE A8 is the method according EEE A6, wherein outputting the audible alert comprises outputting the audible alert in a single language.

EEE A9 is the method according EEE A6, wherein outputting the audible alert comprises outputting the audible alert in multiple languages according to an order defined in a settings menu.

EEE A10 is the method according to EEE A9, further comprising displaying the settings menu on a display at the local computing system, wherein the settings menu includes a user-selectable control for each language in a list of languages to select whether the language is used when outputting audible alerts, and a user selectable control for each language in the list of languages to adjust the language within the defined order.

EEE A11 is the method according to any one of EEE A2 to A10, wherein: the first and third signals include a first time stamp corresponding to the first sensor data, and the second and fourth signals include a second time stamp corresponding to the second sensor data.

EEE A12 is the method according to any one of EEE A2 to A11, further comprising: executing, at a processor of the gateway computing system, an application configured to perform application programming interface (API) calls to the first computing system, wherein transmitting the third and fourth signals occurs via one or more API calls to the first computing system.

EEE A13 is the method according to EEE A12, further comprising: determining, at the processor of the gateway computing system, a first change of state or a second change of state, wherein: the first change of state corresponds to the door and is based on the first sensor data, the second change of state corresponds to the caution barrier and is based on the second sensor data, and at least one of the one or more API calls to the first computing system occurs in response to determining the first change of state or the second change of state.

EEE A14 is the method according to EEE A13, wherein transmitting the third and fourth signals occurs via a WebSocket established between the gateway computing system and the first computing system.

EEE A15 is the method according to any one of EEE A2 to A14, wherein the gateway computing system includes a transceiver configured to repeat a signal received by the transceiver.

EEE A16 is the method according to any one of EEE A1 to A15, wherein: the second computing system includes a remote client computing system, and the method further includes the second computing system displaying the first notification within a graphical user interface.

EEE A17 is the method according to EEE A16, wherein displaying the first notification within the graphical user interface includes displaying a text message, a short message service message, a multi-media service message, an e-mail message, or an alert within a visual dashboard.

EEE A18 is the method according to any one of EEE A1 to A17, wherein the first sensor includes a door contact sensor.

EEE A19 is the method according to EEE A18, wherein: the door contact sensor includes a first sensor component including a switch and a second sensor component including a magnet.

EEE A20 is the method according to EEE A19, wherein the switch includes a Hall Effect switch or a reed switch.

EEE A21 is the method according to any one of EEEs A19 to A20, wherein the second sensor component is mounted within a cage to restrain the second sensor component in case the second sensor component becomes dislodged from its mounting location.

EEE A22 is the method according to any one of EEEs A19 to A20, wherein the second sensor component is tethered to a second mounting location in case the second sensor component becomes dislodged from a first mounting location.

EEE A23 is the method according to any one of EEEs A19 to A20, wherein the second sensor component includes a housing with sufficient non-ferrous mass such that gravity overcomes any attractive forces of the magnet and an MRI scanner when the second sensor component becomes dislodged from its mounting location.

EEE A24 is the method according to any one of EEEs A19 to A23, wherein the first sensor component is attached to a door jamb or wall adjacent to the door and the second sensor component is attached to the door.

EEE A25 is the method according to any one of EEEs A19 to A23, wherein the first sensor component is attached to the door and the second sensor component is attached to a door jamb or wall adjacent to the door.

EEE A26 is the method according to any one of EEEs A1 to A25, wherein: the second sensor is attached to a door jamb or wall adjacent to the door, the caution barrier includes a belt extendible from within a housing and retractable into the housing; and a magnet configured to interact with the second sensor is attached to the belt.

EEE A27 is the method according to any one of EEEs A1 to A25, wherein: the second sensor is attached to a door jamb or wall adjacent to the door, the caution barrier includes an automated gate having an arm configured to extend across the doorway; and a magnet configured to interact with the second sensor is attached to the arm.

EEE A28 is the method according to any one of EEE A1 to A25, wherein: the second sensor is attached to a door jamb or wall adjacent to the door, and the caution barrier includes: a belt extendible from within a housing and retractable into the housing, and a magnet configured to interact with the second sensor is attached to the belt, or an automated gate having an arm configured to extend across the doorway, and a magnet configured to interact with the second sensor is attached to the arm.

EEE A29 is the method according to EEE A1, wherein: the second sensor includes a first sensor component and a second sensor component, the caution barrier includes: a belt including a first end and a second end opposite the first end, a belt retractor attached to the first end of the belt, a belt clip attached to the second end of the belt, a receiver, the first sensor component, and the second sensor component; the first sensor component is attached to the belt clip, the second sensor component is attached to the receiver, and one of the first or second sensor components is configured to make a determination indicating whether the first and second sensor components are in proximity to each other and to output the second sensor data based on the determination.

EEE A30 is the method according to EEE A29, wherein the receiver comprises a latch including one or more flanges to keep one or more flanges of the belt clip from moving past the one or more flanges of the latch while the belt clip is attached to the receiver.

EEE A31 is the method according to any one of EEE A1 to A30, further comprising: receiving, at the first computing system, additional sensor data from the first sensor and the second sensor; determining, at the first computing system, a statistic based, at least in part, on the additional sensor data; and outputting, from the first computing system, a notification regarding the statistic to the second computing system.

EEE A32 is the method according to EEE A31, wherein the statistic includes at least one statistic selected from the group consisting of: an average door open time over a particular time period, and a total door open time over the particular time period.

EEE A33 is the method according to EEE A32, wherein the particular time period includes a time period selected from the group consisting of: a past day, a past twenty-four hours, an amount of time since a current day began, a past week, a past seven days, a past one hundred and sixty-eight hours, and a past month.

EEE A34 is the method according to one or more of EEE A32 and A33, further comprising: receiving, at the first computing system from one or more gateway computing systems, further data corresponding to: signals the one or more gateway computing systems receive from a respective door sensor positioned in proximity to a respective door of a respective restricted room, the respective door sensor being configured to output signals based on a status of the respective door being closed or open, and signals the one or more gateway computing systems receive from a respective barrier sensor positioned in proximity to a respective caution barrier positioned in proximity to the respective door, the respective barrier sensor being configured to output signals based on a status of the respective caution barrier extending across at least a portion of a respective doorway corresponding to the respective door; aggregating the further data; determining, at the first computing system, an additional statistic based, at least in part, on the aggregated further data; and outputting, from the first computing system, a notification regarding the additional statistic to the second computing system.

EEE A35 is the method according to EEE A1, wherein the first data corresponds to a first signal and the second data corresponds to a second signal.

EEE A36 is a computing system comprising: a processor; and a non-transitory computer-readable memory including program instructions executable by the processor to perform functions including: receiving first and second sensor data, wherein: the first sensor data is from a first sensor positioned in proximity to a door of a restricted room, the first sensor is configured to output the first sensor data based on a status of the door being closed or open, the second sensor data is from a second sensor positioned in proximity to a caution barrier positioned in proximity to the door, and the second sensor is configured to output the second sensor data based on a status of the caution barrier extending across at least a portion of a doorway corresponding to the door; determining, based on the first and second sensor data, a first condition existing at the door, wherein the first condition comprises the door being open and non-use of the caution barrier for at least a threshold amount of time while the door is open; and outputting a first notification regarding the first condition to a second computing system.

EEE A37 is a computing system comprising: a processor; and a computer-readable memory comprising program instructions executable by the processor to perform the method of any one of EEEs A1 to A35.

EEE A38 is a non-transitory computer-readable memory having stored therein instructions executable by one or more processors to cause a computing system to perform functions, the functions including: receiving first and second sensor data, wherein: the first sensor data is from a first sensor positioned in proximity to a door of a restricted room, the first sensor is configured to output the first sensor data based on a status of the door being closed or open, the second sensor data is from a second sensor positioned in proximity to a caution barrier positioned in proximity to the door, and the second sensor is configured to output the second sensor data based on a status of the caution barrier extending across at least a portion of a doorway corresponding to the door; determining, based on the first and second sensor data, a first condition existing at the door, wherein the first condition comprises the door being open and non-use of the caution barrier for at least a threshold amount of time while the door is open; and outputting a first notification regarding the first condition to a second computing system.

EEE A39 is a non-transitory computer-readable memory having stored therein instructions executable by one or more processors to cause a computing system to perform the method of any one of EEEs A1 to A35.

EEE B1 is an apparatus configured for use as a barrier, the apparatus comprising: a belt including a first end and a second end opposite the first end; a belt retractor attached to the first end of the belt; a belt clip attached to the second end of the belt; a receiver; a first sensor component attached to the belt clip; and a second sensor component attached to the receiver, wherein: one of the first or second sensor components is configured to make a determination indicating whether the first and second sensor components are in proximity to each other and to output a signal indicating the determination.

EEE B2 is the apparatus of EEE B1, wherein: the belt clip includes a first pair of arms separated by a first slot, the receiver includes a latch configured to fit within the first slot, and the first slot and the latch are sized to allow the latch to be positioned within the first slot and to be retained within the first slot by opposing contact forces exerted by the first pair of arms and the latch.

EEE B3 is the apparatus of EEE B2, wherein: the belt clip includes a second pair of arms separated by a second slot, the latch is configured to fit within the second slot, and the second slot and the latch are sized to allow the latch to be positioned within the second slot and to be retained within the second slot by opposing contact forces exerted by the second pair of arms and the latch.

EEE B4 is the apparatus of EEE B3, wherein: the belt clip includes a first side and a second side opposite the first side, the belt clip includes a flange extending outward from and transverse to the first side, the first slot is located between the first side and the second side, the second pair of arms extend outward from and transverse to the second side, and the flange surrounds at least a portion of the first sensor component.

EEE B5 is the apparatus of EEE B4, wherein the first sensor component includes an orientation tab, and the flange includes a notch to receive the orientation tab during attachment of the first sensor component to the belt clip.

EEE B6 is the apparatus of any of EEEs B2 to B5, wherein the latch comprises one or more flanges to keep one or more flanges of the first or second pair of arms from moving past the one or more flanges of the latch while the belt clip is attached to the receiver.

EEE B7 is the apparatus according to any one of EEEs B2 to B6, wherein: the receiver comprises a wall receiver, the wall receiver includes a first side of the wall receiver and a second side of the wall receiver opposite the first side of the wall receiver, the wall receiver includes a second flange extending outward from and transverse to the first side of the wall receiver, the latch extends outward from and transverse to the first side of the wall receiver, and the second flange surrounds at least a portion of the second sensor component.

EEE B8 is the apparatus according to EEE B7, wherein the second side of the wall receiver is flat.

EEE B9 is the apparatus of EEE B7, wherein the second flange comprises at least a first receiver flange and a second receiver flange, and a notch is positioned between the first receiver flange and the second receiver flange.

B10 is the apparatus of EEE B7, wherein the second flange comprises first and second receiver flanges positioned on a first side of an area for attaching the second sensor component and a third receiver flange positioned on a second side of the area.

EEE B11 is the apparatus according to any one of EEEs B1 to B10, wherein the apparatus includes a first fastener for attaching the first sensor component to the belt clip.

EEE B12 is the apparatus according to EEE B11, wherein the first fastener includes a piece of double-sided adhesive tape including a base and first and second adhesive layers on opposing sides of the base.

EEE B13 is the apparatus according to EEE B11, wherein the first fastener includes a glue, a putty, an epoxy, a cement, or a hook and loop fastener.

EEE B14 is the apparatus according to any one of EEEs B1 to B13, wherein the apparatus includes a second fastener for attaching the second sensor component to the receiver.

EEE B15 is the apparatus according to EEE B14, wherein the second fastener includes a piece of double-sided adhesive tape including a base and first and second adhesive layers on opposing sides of the base.

EEE B16 is the apparatus according to EEE B14, wherein the second fastener includes a glue, a putty, an epoxy, a cement, or a hook and loop fastener.

EEE B17 is the apparatus according to EEE B7, wherein the receiver comprises one or more through-holes for placement of a respective fastener to the second sensor component to the receiver, and the respective fastener comprises a screw.

EEE B18 is the apparatus according to EEE B17, wherein the second sensor component comprises a back and a cover, the back has a respective hole to receive the respective fastener, and the cover is removable to allow for battery replacement and is reattachable after battery replacement.

EEE B19 is the apparatus according to any one of EEEs B1 to B18, wherein: the belt clip includes a first clip half and a second clip half, and a portion of the belt is positioned between the first clip half and the second clip half.

EEE B20 is the apparatus according to EEE B19, further comprising: one or more fasteners to removably attach the first clip half to the second clip half.

EEE B21 is the apparatus according to EEE B20, wherein the belt includes a respective through-hole for each of the one or more fasteners.

EEE B22 is the apparatus according to EEE B21, further comprising a respective metallic or composite ring attached to the belt at each of the one or more fasteners.

EEE B23 is the apparatus according to any one of EEEs B19 to B22, wherein a portion of the belt is formed as loop to prevent removal of the belt from the belt clip without separation of the first clip half from the second clip half.

EEE B24 is the apparatus according to any one of EEEs B1 to B16, wherein the belt clip is a unitary one-piece belt clip.

EEE B25 is the apparatus according to any one of EEEs B1 to B24, further comprising: a removably attachable strap to restrain the first sensor component to the belt clip.

EEE B26 is the apparatus according to any one of EEEs B1 to B25, further comprising: a removably attachable strap to restrain the second sensor component to the receiver.

EEE B27 is the apparatus according to any one of EEEs B1 to B26, further comprising: a cover configured to snap onto the belt clip to cover the first sensor component.

EEE B28 is the apparatus according to any one of EEEs B1 to B27, further comprising: a cover configured to snap onto the receiver to cover the second sensor component.

EEE B29 is the apparatus according to any one of EEEs B1 to B28, further comprising: a gateway computing system; a server computing system; and a client computing system, wherein the one of the first or second sensor components is configured to transmit the signal wirelessly.

EEE B30 is the apparatus according to any one of EEEs B1 to B29, wherein: the gateway computing system is configured to receive the signal and to transmit data corresponding to the determination to the server computing system, and the server computing system is configured to determine, based on the data corresponding to the determination, a condition existing at the barrier, and to transmit a notification regarding the condition to the client computing system, and the client computing system is configured to display the notification.

EEE B31 is the apparatus according to EEE B30, wherein the condition comprises a door being open and non-use of the barrier for at least a threshold amount of time while the door is open.

EEE C1 is a method comprising: receiving first and second signals at a computing system, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; determining, at the computing system based on data carried by the first and second signals, a first condition existing at the door, wherein the first condition comprises the door being open and non-use of the caution barrier for at least a first threshold amount of time while the door is open; and outputting, on a display at the computing system, a first notification regarding the first condition.

EEE C2 is the method according to EEE C1, wherein receiving the first signal occurs after receiving the second signal.

EEE C3 is the method according to EEE C1, wherein receiving the first signal occurs before receiving the second signal.

EEE C4 is the method according to any one of EEEs C1 to C3, further comprising: receiving a third signal at the computing system while the first notification is output on the display, wherein the third signal is from the first sensor and indicates the door is closed; determining, at the computing system based on the data carried by the third signals, a second condition existing at the door, wherein the second condition comprises the door being closed; and outputting, on the display at the computing system, a second notification regarding the second condition.

EEE C5 is the method according to any one of EEEs C1 to C3, further comprising: receiving a third signal at the computing system while the first notification is output on the display, wherein the third signal is from the second sensor and indicates the caution barrier is deployed; determining, at the computing system based on the data carried by the first and third signals, a second condition existing at the door, wherein the second condition comprises the door being open and the caution barrier being deployed; and outputting, on the display at the computing system, a second notification regarding the second condition.

EEE C6 is the method according to EEE C5, further comprising: receiving a fourth signal at the computing system while the second notification is output on the display, wherein the fourth signal is from the first sensor and indicates the door is closed; determining, at the computing system based on the data carried by the fourth signal, a third condition existing at the door, wherein the third condition comprises the door being closed; and outputting, on the display at the computing system, a third notification regarding the third condition.

EEE C7 is the method according to any one of EEEs C1 to C6, further comprising: determining, at the computing system, a particular condition existing at the door based on a first configuration parameter stored in a computer-readable memory at the computing system; receiving, at the computing system, a second configuration parameter transmitted by the first sensor or the second sensor; storing the second configuration parameter into the computer-readable memory at the computing system for use thereafter in determining the particular condition existing at the door; and determining, at the computing system, the particular condition existing at the door based on the second configuration parameter.

EEE C8 is the method according to EEE C7, further comprising: receiving the second configuration parameter at the first sensor or the second sensor from a gateway computing system; and transmitting the second configuration parameter from the first sensor or the second sensor to the computing system.

EEE C9 is the method according to any one of EEEs C7 and C8, wherein: the first configuration parameter indicates the first threshold amount of time, the second configuration parameter indicates a second threshold amount of time for comparing to a condition in which the door is open and the caution barrier is not deployed, and the first and second threshold amounts of time are different.

EEE C10 is the method according to any one of EEEs C7 and C8, wherein: the second configuration parameter indicates the first threshold amount of time, the first configuration parameter indicates a second threshold amount of time for comparing to a condition in which the door is open and the caution barrier is not deployed, and the first and second threshold amounts of time are different.

EEE C11 is the method according to any one of EEEs C1 to C10, further comprising: receiving the first and second signals at the gateway computing system; transmitting, from the gateway computing system to a server computing system, data corresponding to the first and second signals; determining, at the server computing system based on the data corresponding to the first and second signals, the first condition existing at the door; and outputting, from the server computing system, a notification regarding the first condition to a client computing system.

EEE C12 is the method according to EEE C11, wherein the data corresponding to the first and second signals indicates data carried by the first and second signals, respectively.

EEE C13 is the method according to EEE C11, wherein the data corresponding to the first and second signals comprises repeated versions of the first and second signals, respectively.

EEE C14 is the method according to any one of EEEs C1 to C13, further comprising: incrementing, at the computing system, a first counter tracking how many occurrences of the first condition have occurred at the door during a particular time period; and outputting a value indicated by the first counter on the display at the computing system.

EEE C15 is the method according to EEE C14, wherein the particular time period is a twenty-four-hour period of the current day.

EEE C16 is the method according to any one of EEEs C14 and C15, further comprising: resetting the first counter at an end of the day.

EEE C17 is the method according to any one of EEEs C14 to C16, further comprising: determining, at the computing system, a fourth condition indicating the door was opened while the caution barrier was not deployed and then closed within the first threshold amount of time; and outputting, on the display at the computing system, a fourth notification regarding the fourth condition.

EEE C18 is the method according to EEE C17, further comprising: incrementing, at the computing system, a second counter tracking how many occurrences of the fourth condition have occurred at the door during the particular time period; and outputting a value indicated by the fourth counter on the display at the computing system.

EEE C19 is the method according to EEE C18, further comprising: determining, at the computing system, a ratio based on the value indicated by the first counter and the value indicated by the second counter; and outputting the ratio on the display at the computing system.

EEE C20 is the method according to any one of EEE C17 to C19, wherein: determining the fourth condition includes determining that the door was open for at least a second threshold amount of time, and the second threshold amount of time is less than the first threshold amount of time.

EEE C21 is the method according to EEE C20, wherein: determining the fourth condition includes determining that someone or some object passed through the doorway while the door was open.

EEE C22 is a computing system comprising: a processor; and a computer-readable memory comprising program instructions executable by the processor to perform functions including: receiving first and second signals at the computing system, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; determining, at the computing system based on data carried by the first and second signals, a first condition existing at the door, wherein the first condition comprises the door being open and non-use of the caution barrier for at least a first threshold amount of time while the door is open; and outputting, on a display at the computing system, a first notification regarding the first condition.

EEE C23 is a computing system comprising: a processor; and a computer-readable memory comprising program instructions executable by the processor to perform the method of any one of EEEs C1 to C21.

EEE C24 is the computing system according to EEE C23, wherein the caution barrier is arranged according to the apparatus of any one of EEEs B1 to B25.

EEE C25 is a non-transitory computer-readable memory having stored therein instructions executable by one or more processors to cause a computing system to perform functions, the functions including: receiving first and second signals at the computing system, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; determining, at the computing system based on data carried by the first and second signals, a first condition existing at the door, wherein the first condition comprises the door being open and non-use of the caution barrier for at least a first threshold amount of time while the door is open; and outputting, on a display at the computing system, a first notification regarding the first condition.

EEE C26 is a non-transitory computer-readable memory having stored therein instructions executable by one or more processors to cause a computing system to perform the method of any one of EEEs C1 to C21.

EEE C27 is a non-transitory computer-readable memory according to EEE C26, wherein the caution barrier is arranged according to the apparatus of any one of EEEs B1 to B31.

EEE D1 is the method according to any one of EEEs A1 to A34, wherein the caution barrier is arranged according to the apparatus of any one of EEEs B1 to B31.

EEE D2 is the computing system according to EEE A35, wherein the caution barrier is arranged according to the apparatus of any one of EEEs B1 to B31.

EEE D3 is a non-transitory computer-readable memory according to EEE A37, wherein the caution barrier is arranged according to the apparatus of any one of EEEs B1 to B31.

EEE D4 is a computing system comprising a gateway computing system and a server computing system comprising a set of processors and memory having stored thereon program instructions that, when executed by the set of processors, cause the computing system to perform the method of any one of EEE A1 to A34 or D1

EEE D5 is non-transitory computer-readable memory having stored therein instructions executable by a set of processors to cause a computing system including a gateway computing system and a server computing system to perform the method of any one of EEE A1 to A34 or D1.

EEE E1 is a method comprising: receiving first and second signals at a gateway computing system, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; transmitting, from the gateway computing system to a server computing system, data corresponding to the first and second signals; determining, at the server computing system based on the data corresponding to the first and second signals, a first condition existing at the door, wherein the first condition comprises the door being open and non-use of the caution barrier for at least a threshold amount of time while the door is open; and outputting, from the server computing system, a notification regarding the first condition to a client computing system.

EEE E2 is a gateway computing system comprising: a processor; and a computer-readable memory comprising program instructions executable by the processor to perform functions including: receiving first and second signals at a gateway computing system, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; and transmitting, from the gateway computing system to a server computing system, data corresponding to the first and second signals.

EEE E3 is the gateway computing system according to EEE E2, further comprising: a transceiver to receive the first and second signals and to transmit the data corresponding to the first and second signals.

EEE E4 is the gateway computing system according to EEE E2, further comprising: a first sensor input configured to receive the first input signal and to provide the first input signal to the processor; a second sensor input configured to receive the second input signal and to provide the second input signal to the processor; and a transceiver to transmit the data corresponding to the first and second signals.

EEE E5 is a server computing system comprising: a processor; and a computer-readable memory comprising program instructions executable by the processor to perform functions including: receiving data corresponding to first and second signals, wherein: the first signal is from a first sensor positioned in proximity to a door of a restricted room, the first sensor is configured to output the first signal based on a status of the door being closed or open, the second signal is from a second sensor positioned in proximity to a caution barrier positioned in proximity to the door, and the second sensor is configured to output the second signal based on a status of the caution barrier extending across at least a portion of a doorway corresponding to the door; determining, based on the data corresponding to the first and second signals, a first condition existing at the door, wherein the first condition comprises the door being open and non-use of the caution barrier for at least a threshold amount of time while the door is open; and outputting, from the server computing system, a notification regarding the first condition to a client computing system.

1. An apparatus configured for use as a barrier, the apparatus comprising:
a belt including a first end and a second end opposite the first end;
a belt retractor attached to the first end of the belt;
a belt clip attached to the second end of the belt;
a receiver;
a first sensor component attached to the belt clip; and
a second sensor component attached to the receiver,
wherein one of the first or second sensor components is configured to make a determination indicating whether the first and second sensor components are in proximity to each other and to output a signal indicating the determination.

2. The apparatus according to claim 1, wherein:
the belt clip includes a first pair of arms separated by a first slot, the receiver includes a latch configured to fit within the first slot, and
the first slot and the latch are sized to allow the latch to be positioned within the first slot and to be retained within the first slot by opposing contact forces exerted by the first pair of arms and the latch.

3. The apparatus according to claim 2, wherein:
the belt clip includes a second pair of arms separated by a second slot, the latch is configured to fit within the second slot, and
the second slot and the latch are sized to allow the latch to be positioned within the second slot and to be retained within the second slot by opposing contact forces exerted by the second pair of arms and the latch.

4. The apparatus according to claim 3, wherein:
the belt clip includes a first side and a second side opposite the first side, the belt clip includes a flange extending outward from and transverse to the first side, the first slot is located between the first side and the second side, the second pair of arms extend outward from and transverse to the second side, and
the flange surrounds at least a portion of the first sensor component.

5. The apparatus according to claim 4, wherein the first sensor component includes an orientation tab, and the flange includes a notch to receive the orientation tab during attachment of the first sensor component to the belt clip.

6. The apparatus according to claim 2, wherein the latch comprises one or more flanges to keep one or more flanges of the first or second pair of arms from moving past the one or more flanges of the latch while the belt clip is attached to the receiver.

7. The apparatus according to claim 2, wherein:
the receiver comprises a wall receiver,
the wall receiver includes a first side of the wall receiver and a second side of the wall receiver opposite the first side of the wall receiver,
the wall receiver includes a second flange extending outward from and transverse to the first side of the wall receiver, the latch extends outward from and transverse to the first side of the wall receiver, and
the second flange surrounds at least a portion of the second sensor component.

8. The apparatus according to claim 7, wherein the second flange comprises at least a first receiver flange and a second receiver flange, and a notch is positioned between the first receiver flange and the second receiver flange.

9. The apparatus according to claim 7, wherein the second flange comprises first and second receiver flanges positioned on a first side of an area for attaching the second sensor component and a third receiver flange positioned on a second side of the area.

10. The apparatus according to claim 1, wherein the apparatus includes a first fastener for attaching the first sensor component to the belt clip.

11. The apparatus according to claim 1, the apparatus includes a second fastener for attaching the second sensor component to the receiver.

12. The apparatus according to claim 7, wherein:
the receiver comprises one or more through-holes for placement of a respective fastener to the second sensor component to the receiver, and
the respective fastener comprises a screw.

13. The apparatus according to claim 12, wherein:
the second sensor component comprises a back and a cover,
the back has a respective hole to receive the respective fastener, and
the cover is removable to allow for battery replacement and is reattachable after battery replacement.

14. The apparatus according to claim 1, wherein the belt clip includes a first clip half and a second clip half, and a portion of the belt is positioned between the first clip half and the second clip half.

15. The apparatus according to claim 14, wherein a portion of the belt is formed as loop to prevent removal of the belt from the belt clip without separation of the first clip half from the second clip half.

16. The apparatus according to claim 1, wherein the belt clip is a unitary one-piece belt clip.

17. The apparatus according to claim 1, further comprising at least one of the following straps or covers:
a removably attachable strap to restrain the first sensor component to the belt clip,
a removably attachable strap to restrain the second sensor component to the receiver,
a cover configured to snap onto the belt clip to cover the first sensor component, or
a cover configured to snap onto the receiver to cover the second sensor component.

18. The apparatus according to claim 1, further comprising:
a gateway computing system;
a server computing system; and
a client computing system, wherein the one of the first or second sensor components is configured to transmit the signal wirelessly.

19. The apparatus according to claim 18, wherein:
the gateway computing system is configured to receive the signal and to transmit data corresponding to the determination to the server computing system,
the server computing system is configured to determine, based on the data corresponding to the determination, a condition existing at the barrier, and to transmit a notification regarding the condition to the client computing system, and
the client computing system is configured to display the notification.

20. The apparatus according to claim 19, wherein the condition comprises a door being open and non-use of the barrier for at least a threshold amount of time while the door is open.
